(19) United States
(12) Patent Application Publication
(10) Pub. No.: US 2012/0206587 A1
(43) Pub. Date: Aug. 16, 2012

(54) SYSTEM AND METHOD FOR SCANNING A HUMAN BODY

(75) Inventors: Yariv Oz, Petah Tikva (IL); Einat Kidron, Tel-Mond (IL)

(73) Assignee: ORSCAN TECHNOLOGIES LTD, Ra'anana (IL)

(21) Appl. No.: 13/503,575

(22) PCT Filed: Dec. 4, 2009
(86) PCT No.: PCT/IL2010/001021

§ 371 Date: May 2, 2012

Related U.S. Application Data
(60) Provisional application No. 61/266,715, filed on Dec. 4, 2009.

(51) Int. Cl. H04N 7/18

(52) U.S. Cl. 348/77; 348/E07.085

(57) ABSTRACT

The present invention provides a skin surface imaging system for capturing at least one image of the skin of a patient's body, comprising: a. a base; b. a plurality of image sensors, connectable to said base, arranged in a predetermined arrangement; each of said image sensors adapted to capture an image of a predetermined area of said body, so that as a set of images is provided; and, c. a processing unit communicatable with said image sensors, comprising a program of machine-readable instructions embodied on a computer readable memory and executable by a digital data processor adapted to: (i) collect said set of images from said image sensors; (ii) analyze said set of images; (iii) construct a record of personal data associated with the skin of said body of said patient; and (iv) output a dermatological data associated with said skin of said body.

### FIELD OF THE INVENTION

The present invention generally relates to the field of human body scan systems, and more specifically, to a system and method for scanning the skin of a human body.

### BACKGROUND OF THE INVENTION

Melanoma (one type of skin cancer) is a malignant tumor of melanocytes, cells that are underneath the epidermis and derived from the neural crest. A risk factor is anything that affects your chance of getting a disease. Some risk factors for melanoma are: UV light, fair skin, family history of melanoma, past history of melanoma, immune suppression, age, gender. Very significant risk factor is moles, or even more accurate multiplicity of moles. Early signs of malignant melanoma in a mole are often include change in the size, shape, or color of an existing mole or the appearance of a new mole. Early detection of melanoma is very important since when melanoma is found and treated early, the chances for long-term survival are high. Since the vast majority of primary melanomas are visible on the skin, there is a good chance of detecting the disease in its early stages.

Skin cancer is the most common of all cancers. Melanoma accounts for less than 5% of skin cancer cases. But it causes most skin cancer deaths. The number of new cases of melanoma in the United States has not changed much in the last 8 years. However, it increased significantly during the last 30 years. In 1980 the lifetime risk of getting melanoma was about 1 in 250 for whites. Today, overall, the lifetime risk of getting melanoma is about 1 in 50 for whites, 1 in 1,000 for blacks, 1 in 200 for Hispanics [American Cancer Society]. The incidence rate is stable for the last 30 years and stands of 3% per year.

Early detection of melanoma can be done by routine self-examination and regular skin examination at the dermatology. The basic and commonly used procedure includes visual body scan and suspicious mole examination with special instrument (Dermoscop). This procedure is referred to as Total Body Dermoscopy (TBD). The comprehensive procedure includes additional 2 known procedures which related to each other: Total Body Photography (TBP) and Total Body Screening & Evolution (TBSE). The basic procedure takes about 10 minutes of dermatology time while the later one is about an hour.

Most of prior art technologies for TBP and TBSE relates to complex and expensive systems that require professional operators, require long time and are typically intended for clinic use. Due to the above mentioned reasons, high risk patients don't go through TBP and TBSE.

It is well accepted among dermatologists, that moles in high risk individuals should be fully inspected and monitored on a regular basis (once in a period). Unfortunately, this requirement is not practical and the compromise may cause belated detection of cancer and risk the patient.

PCT patent application WO 2010/086694 discloses a mole monitoring system which comprises an imaging station adapted to record at least two temporally-distinct images of a mole. The imaging station comprises an interface module adapted to transmit said images to a remote storage device; and control logic adapted to retrieve said images from said remote storage device and to compare a parameter across said at least two images of said mole, wherein a difference in the parameter is indicative of the mole being potentially associated with melanoma.

US patent application 2009/0185727 discloses methods, apparatus, devices and systems of full body imaging of a patient to diagnose and examine all front, sides, and rear surfaces of the patient. A single vertical stack tower of digital cameras located in an enclosed booth/kiosk can selectively take pictures of the front, left side, rear, and right sides of the patient. Another version has two vertical stacks of digital cameras facing the first vertical stack. Software and computers can automatically gather patient information, take pictures, compile and process the pictures, and allow for customized viewing of the pictures. The methods and systems have application for examining skin features for medical applications and law enforcement.

US patent application 2005/0033142 discloses a system and method for managing imaging data related to a biological trait, including generating a three-dimensional representation of the external surface of the body a patient; obtaining the imaging data; associating the imaging data with a coordinate location of the three-dimensional representation, to generate an associated imaging data; and managing the associated imaging data using the surface representation. The association includes uniquely associating numerical values (e.g., Cartesian coordinates) to particular surface features. The three-dimensional model includes the ability to adjust the pose of the 3D models made from data taken at different times so that the coordinate systems closely correspond.

It is therefore a long felt need to provide a method and a system for early detection and screening of melanoma. These method and system has to be fast, simple, efficient and cost effective. Potentially, such a tool can also alert the patient for mole deforming so he can accelerate his visit to the physician.

### SUMMARY OF THE INVENTION

It is one object of the present invention to provide a skin surface imaging system for capturing at least one image of the skin of a patient's body, comprising:
a. at least one base;
b. a plurality of image sensors, connectable to said base, arranged in a predetermined arrangement; each of said image sensors adapted to capture at least one image of a predetermined area of said body, so that as a set of images is provided; and,
c. a processing unit communicatable with said image sensors, said processing unit comprising a program of machine-readable instructions embodied on a computer readable memory and executable by a digital data processor adapted to: (i) collect said set of images from said image sensors; (ii) analyze said set of images; (iii) construct a record of personal data associated with the skin of said body of said patient; and (iv) output a dermatological data associated with said skin of said body;
wherein at least one of said image sensors is jointly connectable to said base by means of at least one joint, such that the orientation of said at least one of said image sensors with respect to said base is controllable and reconfigurable.

It is another object of the present invention to provide the skin surface imaging system as defined above, wherein said at least one of said image sensors is jointly connectable to said base via a restricting sensor and controlling mechanism, such that said at least one image sensor is movable in at least one selected from group consisting of the sagittal plane, the coronal plane or the transverse plane, upwards, downwards, left, right or any combination thereof.

It is another object of the present invention to provide the skin surface imaging system as defined above, wherein said restricting sensor is adapted to regulate the movement of said at least one image sensor.

It is another object of the present invention to provide the skin surface imaging system as defined above, wherein said controlling mechanism is either electronically operatable by said processing unit or manually operatable by an operator.

It is another object of the present invention to provide the skin surface imaging system as defined above, wherein said controlling mechanism is adapted to control the distance between at least one of said image sensors and said body.

It is another object of the present invention to provide the skin surface imaging system as defined above, wherein said controlling mechanism is adapted to control the distance in said orientation between at least one of said image sensors and said body.

It is another object of the present invention to provide the skin surface imaging system as defined above, wherein said controlling mechanism is adapted to control the location of at least one of said image sensors in said base.

It is another object of the present invention to provide the skin surface imaging system as defined above, wherein said base is characterized by a main longitudinal axis; further wherein said controlling mechanism is adapted to control the location of at least one of said image sensors along said main longitudinal axis in said base.

It is another object of the present invention to provide the skin surface imaging system as defined above, wherein said control of said distance is performed according to the dimensions of said body.

It is another object of the present invention to provide the skin surface imaging system as defined above, additionally comprising a sensor adapted to provide information as for the dimensions of said body, such that said control of said distance is performed according to the dimensions of said body.

It is another object of the present invention to provide the skin surface imaging system as defined above, wherein said image sensors are selected from the group consisting of: visible light sensors, ultraviolet (UV) light sensors, infrared (IR) sensors, and any combination thereof.

It is another object of the present invention to provide the skin surface imaging system as defined above, wherein said predetermined arrangement characterized by n arrays locatable at angle of (360/n)° between each other with respect to said body or said base, each of said n arrays comprises m image sensors; n is an integer greater than or equals to 1; m is an integer greater than or equals to 1.

It is another object of the present invention to provide the skin surface imaging system as defined above, wherein each of said n arrays comprises o parallel columns of said image sensors; o is an integer greater than or equals to 1.

It is another object of the present invention to provide the skin surface imaging system as defined above, wherein n is at least 4 and o is at least 2.

It is another object of the present invention to provide the skin surface imaging system as defined above, wherein said predetermined arrangement characterized by n arrays, each of said n arrays comprises m image sensors; n is an integer greater than or equals to 1; m is an integer greater than or equals to 1.

It is another object of the present invention to provide the skin surface imaging system as defined above, wherein each of said n arrays comprises o parallel columns of said image sensors; o is an integer greater than or equals to 1.

It is another object of the present invention to provide the skin surface imaging system as defined above, wherein each of said n arrays comprises o image sensors; wherein said o image sensors are positioned within each of said n arrays in a predetermined manner; o is an integer greater than or equals to 1.

It is another object of the present invention to provide the skin surface imaging system as defined above, wherein said predetermined manner is selected from a group consisting of homogeneous, non-homogeneous, aligned, non-aligned, spherical, triangular, cylindrical, cubic, spiral, randomly spaced, arbitrary, polygon having p ribs; p is greater than 1; and any combination thereof.

It is another object of the present invention to provide the skin surface imaging system as defined above, additionally comprising means adapted to relocate said base from a first position to a second position.

It is another object of the present invention to provide the skin surface imaging system as defined above, wherein said processing unit is adapted to control the on/off mode of at least one of said image sensors.

It is another object of the present invention to provide the skin surface imaging system as defined above, wherein said set of images of comprises at least 2 images of overlapping predetermined areas of said body.

It is another object of the present invention to provide the skin surface imaging system as defined above, wherein said predetermined arrangement is selected from the group consisting of: homogeneous, non-homogeneous, aligned, non-aligned, spherical, cylindrical, cubic, spiral, randomly spaced, arbitrary, and any combination thereof.

It is another object of the present invention to provide the skin surface imaging system as defined above, wherein said orientation is an angle between at least one of said image sensors and said body or said base, said angle is in the range of about 1° to about 179°.

It is another object of the present invention to provide the skin surface imaging system as defined above, wherein said dermatological data is selected from a group consisting of: suspected moles, the boundaries of suspected moles, tissue encircling said suspected moles nevus, tattoos, scars, moles, spots, wounds, and any combination thereof.

It is another object of the present invention to provide the skin surface imaging system as defined above, wherein said processing unit comprises an image processing algorithm adapted to detect the existence of said suspected moles and to characterize each mole according to predetermined characteristics.

It is another object of the present invention to provide the skin surface imaging system as defined above, wherein said image processing algorithm is further adapted to perform operation selected from the group consisting of: locate the borders of said suspected moles, distinguish between a suspected mole and a wound according to a pattern recognition algorithm, and any combination thereof.

It is another object of the present invention to provide the skin surface imaging system as defined above, wherein said processing unit is adapted to store said predetermined characteristics of each of said suspected moles.

It is another object of the present invention to provide the skin surface imaging system as defined above, wherein said predetermined characteristics are selected from the group consisting of: location, coordinates of border, asymmetry measurement, planar measurements, 2D structure, 3D structure, topography, height, radius, color, and any combination thereof.

It is another object of the present invention to provide the skin surface imaging system as defined above, wherein said processing unit is adapted to provide the history of each suspected mole and to provide comparison and changes between the current predetermined characteristics of said suspected moles and at least one previous predetermined characteristics of said suspected moles.

It is another object of the present invention to provide the skin surface imaging system as defined above, wherein said processing unit is adapted to detect said suspected moles by analyzing 2D and 3D images of said suspected moles.

It is another object of the present invention to provide the skin surface imaging system as defined above, wherein said base is part of a structure selected from the group consisting of: a booth, a kiosk, a cabin, a private enclosure, and any combination thereof.

It is another object of the present invention to provide the skin surface imaging system as defined above, wherein said processing unit is adapted to control the operation of said image sensors; said operation is selected from the orientation of at least one of said image sensors; the distance between at least one of said image sensors and said body, on/off mode of at least one of said image sensors.

It is another object of the present invention to provide the skin surface imaging system as defined above, wherein said processing unit is adapted to operate said image sensors in a synchronized manner, such that a synchronized image of the skin of said body is provided.

It is another object of the present invention to provide the skin surface imaging system as defined above, wherein said synchronized manner is operation of a portion of at least one of said image sensors.

It is another object of the present invention to provide the skin surface imaging system as defined above, wherein in said synchronized manner, said at least two of said image sensors are operated simultaneously.

It is another object of the present invention to provide the skin surface imaging system as defined above, further comprising a hair removal mechanism adapted to eliminate the influence of human hair on the data of said personal data.

It is another object of the present invention to provide the skin surface imaging system as defined above, wherein said processing unit further comprises a feedback mechanism, said feedback mechanism comprises: (i) an analyzing unit adapted to score said dermatological data according to a predetermined scale, so that abnormal dermatological data is detected; and (ii) a regulating unit adapted to operate said processing unit in a repeated manner when said score is higher than a predetermined value.

It is another object of the present invention to provide the skin surface imaging system as defined above, wherein said predetermined scale is adapted to rank parameters selected from the group consisting of: said predetermined characteristics, quality of said images; said quality is selected from a group consisting of color, contrast, blurred, out of focus, lightness, and any combination thereof.

It is another object of the present invention to provide the skin surface imaging system as defined above, wherein said feedback mechanism further adapted to control the orientation or the 3D position of at least one of said image sensors, the position of said patient, the distance between at least one of said image sensors and said patient.

It is another object of the present invention to provide the skin surface imaging system as defined above, further comprising a data storage unit adapted to store said personal data on a portable safe memory card.

It is another object of the present invention to provide the skin surface imaging system as defined above, wherein said personal data selected from the group consisting of: a dermatological data, scan results, set of images, a skin map, the full body photography, a 2D body model, a 3D body model, a 2D analysis, a 3D analysis, dates, patient personal information selected from a group consisting of name, height, weight, size, gender, id, password, family, family history, and any combination thereof, or any combination thereof.

It is another object of the present invention to provide the skin surface imaging system as defined above, wherein said processing unit is adapted to analyze said set of images based upon previous analyzes.

It is another object of the present invention to provide the skin surface imaging system as defined above, wherein said processing unit further comprises an operation unit adapted to allow an operator to perform operation selected from the group consisting of: analyze said personal data; analyze said set of images; analyze said dermatological data; determine said dermatological data, edit said dermatological data, and any combination thereof.

It is another object of the present invention to provide the skin surface imaging system as defined above, wherein said operation unit is further adapted to perform operations selected from the group consisting of: provide zoom-in to a predetermined area of a skin map, operate said feedback mechanism, maipulate said personal data, provide a 2D plot of a predetermined area of a skin map according to at least one image of said set of images, provide a 3D plot of a predetermined area of a skin map, provide a 2D plot of a predetermined area of a skin map by performing a 2D projection on said 3D plot, mark a predetermined area of a skin map, and any combination thereof.

It is another object of the present invention to provide the skin surface imaging system as defined above, wherein said dermatological data is associated with the evolution and the severity of melanoma of a predetermined area on said body.

It is another object of the present invention to provide the skin surface imaging system as defined above, wherein said processing unit is further adapted to identify said patient according to parameters selected from the group consisting of: name, height, weight, size, gender, id, password, family, family history, and any combination thereof.

It is another object of the present invention to provide the skin surface imaging system as defined above, further comprising a rotatable pod stand adapted to rotate said body with respect to said image sensor.

It is another object of the present invention to provide the skin surface imaging system as defined above, further comprising a body positioning sub-unit adapted to: provide instructions regarding the position of a patient with respect to said image sensors; and to stabilize the position of said patient with respect to said image sensors.

It is another object of the present invention to provide the skin surface imaging system as defined above, wherein said image sensors are positioned in a homogeneous grid of sensors.

It is another object of the present invention to provide the skin surface imaging system as defined above, wherein said image sensors is selected from a group consisting of stills camera, video camera or any combination thereof.

It is another object of the present invention to provide the skin surface imaging system as defined above, additionally comprising a moving mechanism couple to at least one of said image sensors, adapted to move said image sensors from one portion to another within said base.

It is another object of the present invention to provide the skin surface imaging system as defined above, additionally comprising lightning means selected from a group consisting of LEDs, lamps, bulb filament or any combination thereof.

It is another object of the present invention to provide the skin surface imaging system as defined above, adapted to synchronies the operation of at least one of said image sensor and said lightning means.

It is another object of the present invention to provide the skin surface imaging system as defined above, wherein said dermatological data is used from detecting melanoma, for esthetics use, cosmetics use or any combination thereof.

It is another object of the present invention to provide the skin surface imaging system as defined above, wherein at least one of said image sensor comprises at least one marker.

It is another object of the present invention to provide the skin surface imaging as defined above, wherein at least one of said image sensor is adapted to rotate around said image sensor's main axis.

It is another object of the present invention to an imaging system for capturing at least one image of the skin of a patient's body, comprising:
a. at least one base;
b. a plurality of image sensors, connectable to said base, arranged in a predetermined arrangement; each of said image sensors adapted to capture at least one image of a predetermined area of said body, so that as a set of images is provided; and,
c. a processing unit communicatable with said image sensors, said processing unit comprising a program of machine-readable instructions embodied on a computer readable memory and executable by a digital data processor adapted to: (i) collect said set of images from said image sensors; (ii) analyze said set of images; (iii) construct a skin map associated with the skin geometry of said body; and (iv) output a dermatological data associated with said skin of said body;
wherein at least one of said image sensors is connectable to said base such that the distance between at least one of said image sensors and said base or said body is controllable and alterable.

It is another object of the present invention to provide the skin surface imaging system as defined above, wherein said at least one of said image sensors is jointly connectable to said base via a restricting sensor and controlling mechanism, such that said at least one image sensor is movable in at least one selected from group consisting of the sagittal plane, the coronal plane or the transverse plane, upwards, downwards, left, right or any combination thereof.

It is another object of the present invention to provide the skin surface imaging system as defined above, wherein said restricting sensor is adapted to regulate the movement of said at least one image sensor.

It is another object of the present invention to provide the skin surface imaging system as defined above, wherein said controlling mechanism is either electronically operatable by said processing unit or manually operatable by an operator.

It is another object of the present invention to provide the skin surface imaging system as defined above, wherein at least one of said image sensors is jointly connectable to said base by means of at least one joint, such that the orientation of said at least one of said image sensors with respect to said base is controllable and reconfigurable

It is another object of the present invention to provide the skin surface imaging system as defined above, wherein said controlling mechanism is adapted to control the distance in said orientation between at least one of said image sensors and said body.

It is another object of the present invention to provide the skin surface imaging system as defined above, wherein said controlling mechanism is adapted to control the location of at least one of said image sensors in said base.

It is another object of the present invention to provide the skin surface imaging system as defined above, wherein said base is characterized by a main longitudinal axis; further wherein said controlling mechanism is adapted to control the location of at least one of said image sensors along said main longitudinal axis in said base.

It is another object of the present invention to provide the skin surface imaging system as defined above, wherein said control of said distance is performed according to the dimensions of said body.

It is another object of the present invention to provide the skin surface imaging system as defined above, additionally comprising a sensor adapted to provide information as for the dimensions of said body, such that said control of said distance is performed according to the dimensions of said body.

It is another object of the present invention to provide the skin surface imaging system as defined above, wherein said image sensors are selected from the group consisting of: visible light sensors, ultraviolet (UV) light sensors, infrared (IR) sensors, and any combination thereof.

It is another object of the present invention to provide the skin surface imaging system as defined above, wherein said predetermined arrangement characterized by n arrays locatable at angle of (360/n)° between each other with respect to said body or said base, each of said n arrays comprises m image sensors; n is an integer greater than or equals to 1; m is an integer greater than or equals to 1.

It is another object of the present invention to provide the skin surface imaging system as defined above, wherein each of said n arrays comprises o parallel columns of said image sensors; o is an integer greater than or equals to 1.

It is another object of the present invention to provide the skin surface imaging system as defined above, wherein n is at least 4 and o is at least 2.

It is another object of the present invention to provide the skin surface imaging system as defined above, wherein said predetermined arrangement characterized by n arrays, each of said n arrays comprises m image sensors; n is an integer greater than or equals to 1; m is an integer greater than or equals to 1.

It is another object of the present invention to provide the skin surface imaging system as defined above, wherein each of said n arrays comprises o parallel columns of said image sensors; o is an integer greater than or equals to 1.

It is another object of the present invention to provide the skin surface imaging system as defined above, wherein each of said n arrays comprises o image sensors; wherein said o image sensors are positioned within each of said n arrays in a predetermined manner; o is an integer greater than or equals to 1.

It is another object of the present invention to provide the skin surface imaging system as defined above, wherein said predetermined manner is selected from a group consisting of homogeneous, non-homogeneous, aligned, non-aligned, spherical, triangular, cylindrical, cubic, spiral, randomly spaced, arbitrary, polygon having p ribs; p is greater than 1; and any combination thereof.

It is another object of the present invention to provide the skin surface imaging system as defined above, additionally comprising means adapted to relocate said base from a first position to a second position.

It is another object of the present invention to provide the skin surface imaging system as defined above, wherein said processing unit is adapted to control the on/off mode of at least one of said image sensors.

It is another object of the present invention to provide the skin surface imaging system as defined above, wherein said set of images of comprises at least 2 images of overlapping predetermined areas of said body.

It is another object of the present invention to provide the skin surface imaging system as defined above, wherein said predetermined arrangement is selected from the group consisting of: homogeneous, non-homogeneous, aligned, non-aligned, spherical, cylindrical, cubic, spiral, randomly spaced, arbitrary, and any combination thereof.

It is another object of the present invention to provide the skin surface imaging system as defined above, wherein said orientation is an angle between at least one of said image sensors and said body or said base, said angle is in the range of about 1° to about 179°.

It is another object of the present invention to provide the skin surface imaging system as defined above, wherein said dermatological data is selected from a group consisting of: suspected moles, the boundaries of suspected moles, tissue encircling said suspected moles nevus, tattoos, scars, moles, spots, wounds, and any combination thereof.

It is another object of the present invention to provide the skin surface imaging system as defined above, wherein said processing unit comprises an image processing algorithm adapted to detect the existence of said suspected moles and to characterize each mole according to predetermined characteristics.

It is another object of the present invention to provide the skin surface imaging system as defined above, wherein said image processing algorithm is further adapted to perform operation selected from the group consisting of: locate the borders of said suspected moles, distinguish between a suspected mole and a wound according to a pattern recognition algorithm, and any combination thereof.

It is another object of the present invention to provide the skin surface imaging system as defined above, wherein said processing unit is adapted to store said predetermined characteristics of each of said suspected moles.

It is another object of the present invention to provide the skin surface imaging system as defined above, wherein said predetermined characteristics are selected from the group consisting of: location, coordinates of border, asymmetry measurement, planar measurements, 2D structure, 3D structure, topography, height, radius, color, and any combination thereof.

It is another object of the present invention to provide the skin surface imaging system as defined above, wherein said processing unit is adapted to provide the history of each suspected mole and to provide comparison and changes between the current predetermined characteristics of said suspected moles and at least one previous predetermined characteristics of said suspected moles.

It is another object of the present invention to provide the skin surface imaging system as defined above, wherein said processing unit is adapted to detect said suspected moles by analyzing 2D and 3D images of said suspected moles.

It is another object of the present invention to provide the skin surface imaging system as defined above, wherein said base is part of a structure selected from the group consisting of: a booth, a kiosk, a cabin, a private enclosure, and any combination thereof.

It is another object of the present invention to provide the skin surface imaging system as defined above, wherein said processing unit is adapted to control the operation of said image sensors; said operation is selected from the orientation of at least one of said image sensors; the distance between at least one of said image sensors and said body, on/off mode of at least one of said image sensors.

It is another object of the present invention to provide the skin surface imaging system as defined above, wherein said processing unit is adapted to operate said image sensors in a synchronized manner, such that a synchronized image of the skin of said body is provided.

It is another object of the present invention to provide the skin surface imaging system as defined above, wherein said synchronized manner is operation of a portion of at least one of said image sensors.

It is another object of the present invention to provide the skin surface imaging system as defined above, wherein in said synchronized manner, said at least two of said image sensors are operated simultaneously.

It is another object of the present invention to provide the skin surface imaging system as defined above, further comprising a hair removal mechanism adapted to eliminate the influence of human hair on the data of said personal data.

It is another object of the present invention to provide the skin surface imaging system as defined above, wherein said processing unit further comprises a feedback mechanism, said feedback mechanism comprises: (i) an analyzing unit adapted to score said dermatological data according to a predetermined scale, so that abnormal dermatological data is detected; and (ii) a regulating unit adapted to operate said processing unit in a repeated manner when said score is higher than a predetermined value.

It is another object of the present invention to provide the skin surface imaging system as defined above, wherein said predetermined scale is adapted to rank parameters selected from the group consisting of: said predetermined characteristics, quality of said images; said quality is selected from a group consisting of color, contrast, blurred, out of focus, lightness, and any combination thereof.

It is another object of the present invention to provide the skin surface imaging system as defined above, wherein said feedback mechanism further adapted to control the orientation or the 3D position of at least one of said image sensors, the position of said patient, the distance between at least one of said image sensors and said patient.

It is another object of the present invention to provide the skin surface imaging system as defined above, further comprising a data storage unit adapted to store said personal data on a portable safe memory card.

It is another object of the present invention to provide the skin surface imaging system as defined above, wherein said personal data selected from the group consisting of: a dermatological data, scan results, set of images, a skin map, the full body photography, a 2D body model, a 3D body model, a 2D analysis, a 3D analysis, dates, patient personal information selected from a group consisting of name, height, weight, size, gender, id, password, family, family history, and any combination thereof, or any combination thereof.

It is another object of the present invention to provide the skin surface imaging system as defined above, wherein said processing unit is adapted to analyze said set of images based upon previous analyzes.

It is another object of the present invention to provide the skin surface imaging system as defined above, wherein said processing unit further comprises an operation unit adapted to allow an operator to perform operation selected from the group consisting of: analyze said personal data; analyze said set of images; analyze said dermatological data; determine said dermatological data, edit said dermatological data, and any combination thereof.

It is another object of the present invention to provide the skin surface imaging system as defined above, wherein said operation unit is further adapted to perform operations selected from the group consisting of: provide zoom-in to a predetermined area of a skin map, operate said feedback mechanism, maipulate said personal data, provide a 2D plot of a predetermined area of a skin map according to at least one image of said set of images, provide a 3D plot of a predetermined area of a skin map, provide a 2D plot of a predetermined area of a skin map by performing a 2D projection on said 3D plot, mark a predetermined area of a skin map, and any combination thereof.

It is another object of the present invention to provide the skin surface imaging system as defined above, wherein said dermatological data is associated with the evolution and the severity of melanoma of a predetermined area on said body.

It is another object of the present invention to provide the skin surface imaging system as defined above, wherein said processing unit is further adapted to identify said patient according to parameters selected from the group consisting of: name, height, weight, size, gender, id, password, family, family history, and any combination thereof.

It is another object of the present invention to provide the skin surface imaging system as defined above, further comprising a rotatable pod stand adapted to rotate said body with respect to said image sensor.

It is another object of the present invention to provide the skin surface imaging system as defined above, further comprising a body positioning sub-unit adapted to: provide instructions regarding the position of a patient with respect to said image sensors; and to stabilize the position of said patient with respect to said image sensors.

It is another object of the present invention to provide the skin surface imaging system as defined above, wherein said image sensors are positioned in a homogeneous grid of sensors.

It is another object of the present invention to provide the skin surface imaging system as defined above, wherein said image sensors is selected from a group consisting of stills camera, video camera or any combination thereof.

It is another object of the present invention to provide the skin surface imaging system as defined above, additionally comprising a moving mechanism couple to at least one of said image sensors, adapted to move said image sensors from one potion to another within said base.

It is another object of the present invention to provide the skin surface imaging system as defined above, additionally comprising lightning means selected from a group consisting of LEDs, lamps, bulb filament or any combination thereof.

It is another object of the present invention to provide the skin surface imaging system as defined above, adapted to synchronies the operation of at least one of said image sensor and said lightning means.

It is another object of the present invention to provide the skin surface imaging system as defined above, wherein said dermatological data is used from detecting melanoma, for esthetics use, cosmetics use or any combination thereof.

It is another object of the present invention to provide the skin surface imaging system as defined above, wherein at least one of said image sensor comprises at least one marker.

It is another object of the present invention to provide the skin surface imaging system as defined above, wherein at least one of said image sensor is adapted to rotate around said image sensor's main axis.

It is another object of the present invention to a booth for capturing at least one image of the skin of a patient's human body, comprising:
a. a pod stand upon which said patient is adapted to stand;
b. an envelope adapted to surround said patient;
c. a plurality of image sensors, arranged in a predetermined arrangement between said envelope and said patient; each of said image sensors adapted to capture at least one image of a predetermined area of said human body, so that as a set of images is provided;
d. a processing unit communicatable with said image sensors, said processing unit comprising a program of machine-readable instructions embodied on a computer readable memory and executable by a digital data processor adapted to: (i) collect said set of images from said image sensors; (ii) analyze said set of images; (iii) construct a skin map associated with the skin geometry of said human body; and (iv) output a dermatological data associated with said skin of said human body;
wherein at least one of said image sensors is jointly connectable to said base by means of at least one joint, such that the orientation of said at least one of said image sensors with respect to said base is controllable and reconfigurable.

It is another object of the present invention to provide the booth as defined above, wherein said at least one of said image sensors is jointly connectable to said base via a restricting sensor and controlling mechanism, such that said at least one image sensor is movable in at least one selected from group consisting of the sagittal plane, the coronal plane or the transverse plane, upwards, downwards, left, right or any combination thereof.

It is another object of the present invention to provide the booth as defined above, wherein said restricting sensor is adapted to regulate the movement of said at least one image sensor.

It is another object of the present invention to provide the booth as defined above, wherein said controlling mechanism is either electronically operatable by said processing unit or manually operatable by an operator.

It is another object of the present invention to provide the booth as defined above, wherein said controlling mechanism is adapted to control the distance between at least one of said image sensors and said body.

It is another object of the present invention to provide the booth as defined above, wherein said controlling mechanism is adapted to control the distance in said orientation between at least one of said image sensors and said body.

It is another object of the present invention to provide the booth as defined above, wherein said controlling mechanism is adapted to control the location of at least one of said image sensors in said base.

It is another object of the present invention to provide the booth as defined above, wherein said base is characterized by a main longitudinal axis; further wherein said controlling mechanism is adapted to control the location of at least one of said image sensors along said main longitudinal axis in said base.

It is another object of the present invention to provide the booth as defined above, wherein said control of said distance is performed according to the dimensions of said body.

It is another object of the present invention to provide the booth as defined above, additionally comprising a sensor adapted to provide information as for the dimensions of said body, such that said control of said distance is performed according to the dimensions of said body.

It is another object of the present invention to provide the booth as defined above, wherein said image sensors are selected from the group consisting of: visible light sensors, ultraviolet (UV) light sensors, infrared (IR) sensors, and any combination thereof.

It is another object of the present invention to provide the booth as defined above, wherein said predetermined arrangement characterized by n arrays locatable at angle of (360/n)° between each other with respect to said body or said base, each of said n arrays comprises m image sensors; n is an integer greater than or equals to 1; m is an integer greater than or equals to 1.

It is another object of the present invention to provide the booth as defined above, wherein each of said n arrays comprises o parallel columns of said image sensors; o is an integer greater than or equals to 1.

It is another object of the present invention to provide the booth as defined above, wherein n is at least 4 and o is at least 2.

It is another object of the present invention to provide the booth as defined above, wherein said predetermined arrangement characterized by n arrays, each of said n arrays comprises m image sensors; n is an integer greater than or equals to 1; m is an integer greater than or equals to 1.

It is another object of the present invention to provide the booth as defined above, wherein each of said n arrays comprises o parallel columns of said image sensors; o is an integer greater than or equals to 1.

It is another object of the present invention to provide the booth as defined above, wherein each of said n arrays comprises o image sensors; wherein said o image sensors are positioned within each of said n arrays in a predetermined manner; o is an integer greater than or equals to 1.

It is another object of the present invention to provide the booth as defined above, wherein said predetermined manner is selected from a group consisting of homogeneous, non-homogeneous, aligned, non-aligned, spherical, triangular, cylindrical, cubic, spiral, randomly spaced, arbitrary, polygon having p ribs; p is greater than 1; and any combination thereof.

It is another object of the present invention to provide the booth as defined above, additionally comprising means adapted to relocate said base from a first position to a second position.

It is another object of the present invention to provide the booth as defined above, wherein said processing unit is adapted to control the on/off mode of at least one of said image sensors.

It is another object of the present invention to provide the booth as defined above, wherein said set of images of comprises at least 2 images of overlapping predetermined areas of said body.

It is another object of the present invention to provide the booth as defined above, wherein said predetermined arrangement is selected from the group consisting of: homogeneous, non-homogeneous, aligned, non-aligned, spherical, cylindrical, cubic, spiral, randomly spaced, arbitrary, and any combination thereof.

It is another object of the present invention to provide the booth as defined above, wherein said orientation is an angle between at least one of said image sensors and said body or said base, said angle is in the range of about 1° to about 179°.

It is another object of the present invention to provide the booth as defined above, wherein said dermatological data is selected from a group consisting of: suspected moles, the boundaries of suspected moles, tissue encircling said suspected moles nevus, tattoos, scars, moles, spots, wounds, and any combination thereof.

It is another object of the present invention to provide the booth as defined above, wherein said processing unit comprises an image processing algorithm adapted to detect the existence of said suspected moles and to characterize each mole according to predetermined characteristics.

It is another object of the present invention to provide the booth as defined above, wherein said image processing algorithm is further adapted to perform operation selected from the group consisting of: locate the borders of said suspected moles, distinguish between a suspected mole and a wound according to a pattern recognition algorithm, and any combination thereof.

It is another object of the present invention to provide the booth as defined above, wherein said processing unit is adapted to store said predetermined characteristics of each of said suspected moles.

It is another object of the present invention to provide the booth as defined above, wherein said predetermined characteristics are selected from the group consisting of: location, coordinates of border, asymmetry measurement, planar measurements, 2D structure, 3D structure, topography, height, radius, color, and any combination thereof.

It is another object of the present invention to provide the booth as defined above, wherein said processing unit is adapted to provide the history of each suspected mole and to provide comparison and changes between the current predetermined characteristics of said suspected moles and at least one previous predetermined characteristics of said suspected moles.

It is another object of the present invention to provide the booth as defined above, wherein said processing unit is adapted to detect said suspected moles by analyzing 2D and 3D images of said suspected moles.

It is another object of the present invention to provide the booth as defined above, wherein said base is part of a structure selected from the group consisting of: a booth, a kiosk, a cabin, a private enclosure, and any combination thereof.

It is another object of the present invention to provide the booth as defined above, wherein said processing unit is adapted to control the operation of said image sensors; said operation is selected from the orientation of at least one of said image sensors; the distance between at least one of said image sensors and said body, on/off mode of at least one of said image sensors.

It is another object of the present invention to provide the booth as defined above, wherein said processing unit is adapted to operate said image sensors in a synchronized manner, such that a synchronized image of the skin of said body is provided.

It is another object of the present invention to provide the booth as defined above, wherein said synchronized manner is operation of a portion of at least one of said image sensors.

It is another object of the present invention to provide the booth as defined above, wherein in said synchronized manner, said at least two of said image sensors are operated simultaneously.

It is another object of the present invention to provide the booth as defined above, further comprising a hair removal mechanism adapted to eliminate the influence of human hair on the data of said personal data.

It is another object of the present invention to provide the booth as defined above, wherein said processing unit further comprises a feedback mechanism, said feedback mechanism comprises: (i) an analyzing unit adapted to score said dermatological data according to a predetermined scale, so that abnormal dermatological data is detected; and (ii) a regulating unit adapted to operate said processing unit in a repeated manner when said score is higher than a predetermined value.

It is another object of the present invention to provide the booth as defined above, wherein said predetermined scale is adapted to rank parameters selected from the group consisting of: said predetermined characteristics, quality of said images; said quality is selected from a group consisting of color, contrast, blurred, out of focus, lightness, and any combination thereof.

It is another object of the present invention to provide the booth as defined above, wherein said feedback mechanism further adapted to control the orientation or the 3D position of at least one of said image sensors, the position of said patient, the distance between at least one of said image sensors and said patient.

It is another object of the present invention to provide the booth as defined above, further comprising a data storage unit adapted to store said personal data on a portable safe memory card.

It is another object of the present invention to provide the booth as defined above, wherein said personal data selected from the group consisting of: a dermatological data, scan results, set of images, a skin map, the full body photography, a 2D body model, a 3D body model, a 2D analysis, a 3D analysis, dates, patient personal information selected from a group consisting of name, height, weight, size, gender, id, password, family, family history, and any combination thereof, or any combination thereof.

It is another object of the present invention to provide the booth as defined above, wherein said processing unit is adapted to analyze said set of images based upon previous analyzes.

It is another object of the present invention to provide the booth as defined above, wherein said processing unit further comprises an operation unit adapted to allow an operator to perform operation selected from the group consisting of: analyze said personal data; analyze said set of images; analyze said dermatological data; determine said dermatological data, edit said dermatological data, and any combination thereof.

It is another object of the present invention to provide the booth as defined above, wherein said operation unit is further adapted to perform operations selected from the group consisting of: provide zoom-in to a predetermined area of a skin map, operate said feedback mechanism, maipulate said personal data, provide a 2D plot of a predetermined area of a skin map according to at least one image of said set of images, provide a 3D plot of a predetermined area of a skin map, provide a 2D plot of a predetermined area of a skin map by performing a 2D projection on said 3D plot, mark a predetermined area of a skin map, and any combination thereof.

It is another object of the present invention to provide the booth as defined above, wherein said dermatological data is associated with the evolution and the severity of melanoma of a predetermined area on said body.

It is another object of the present invention to provide the booth as defined above, wherein said processing unit is further adapted to identify said patient according to parameters selected from the group consisting of: name, height, weight, size, gender, id, password, family, family history, and any combination thereof.

It is another object of the present invention to provide the booth as defined above, further comprising a rotatable pod stand adapted to rotate said body with respect to said image sensor.

It is another object of the present invention to provide the booth as defined above, further comprising a body positioning sub-unit adapted to: provide instructions regarding the position of a patient with respect to said image sensors; and to stabilize the position of said patient with respect to said image sensors.

It is another object of the present invention to provide the booth as defined above, wherein said image sensors are positioned in a homogeneous grid of sensors.

It is another object of the present invention to provide the booth as defined above, wherein said image sensors is selected from a group consisting of stills camera, video camera or any combination thereof.

It is another object of the present invention to provide the booth as defined above, additionally comprising a moving mechanism couple to at least one of said image sensors, adapted to move said image sensors from one potion to another within said base.

It is another object of the present invention to provide the booth as defined above, additionally comprising lightning means selected from a group consisting of LEDs, lamps, bulb filament or any combination thereof.

It is another object of the present invention to provide the booth as defined above, adapted to synchronies the operation of at least one of said image sensor and said lightning means.

It is another object of the present invention to provide the booth as defined above, wherein said dermatological data is used from detecting melanoma, for esthetics use, cosmetics use or any combination thereof.

It is another object of the present invention to provide the booth as defined above, wherein at least one of said image sensor comprises at least one marker.

It is another object of the present invention to provide the booth as defined above, wherein at least one of said image sensor is adapted to rotate around said image sensor's main axis.

It is another object of the present invention to provide a method for capturing at least one image of the skin of a patient's human body, comprising steps of:
a. providing a skin surface imaging system, comprising: (i) at least one base; a plurality of image sensors, connectable to said base, arranged in a predetermined arrangement; and, (iii) a processing unit communicatable with said image sensors;
b. capturing at least one image of a predetermined area of said body via said image sensors, thereby providing a set of images;
c. collecting said set of images from said image sensors via said processing unit;
d. analyzing said set of images via said processing unit;
e. constructing via said processing unit a record of a personal data associated with the skin geometry of said human body; and,
f. outputting a dermatological data associated with said skin of said human body;
wherein said method further comprises a step of providing said at least one of said image sensors with a joint connection to said base, thereby controlling the orientation of at least one of said image sensors with respect to said base.

It is another object of the present invention to provide the method as defined above, further comprising step of providing a sensor holding and controlling mechanism, wherein said at least one of said image sensors is jointly connectable to said base via said sensor holding and controlling mechanism.

It is another object of the present invention to provide the method as defined above, further comprising step of electrically operating said controlling mechanism by said processing unit.

It is another object of the present invention to provide the method as defined above, further comprising step of manually operating said controlling mechanism by an operator.

It is another object of the present invention to provide the method as defined above, further comprising a step of controlling the distance between at least one of said image sensors and said body via said holding and controlling mechanism.

It is another object of the present invention to provide the method as defined above, wherein said control of said distance is performed via said controlling mechanism according to the dimensions of said human body.

It is another object of the present invention to provide the method as defined above, further comprising a step of selecting said image sensors from the group consisting of: visible light sensors, ultraviolet (UV) light sensors, infrared (IR) sensors, and any combination thereof.

It is another object of the present invention to provide the method as defined above, wherein said predetermined arrangement characterized by n arrays locatable at angle of (360/n)° between each other with respect to said body or said base, each of said n arrays comprises m image sensors; n is an integer greater than or equals to 1; m is an integer greater than or equals to 1.

It is another object of the present invention to provide the method as defined above, wherein each of said n arrays comprises o parallel columns of said image sensors; o is an integer greater than or equals to 1.

It is another object of the present invention to provide the method as defined above, wherein n is 4 and o is 2.

It is another object of the present invention to provide the method as defined above, wherein said set of images of comprises images of overlapping predetermined areas of said human body.

It is another object of the present invention to provide the method as defined above, further comprising a step of providing said predetermined arrangement selected from the group consisting of: homogeneous, non-homogeneous, aligned, non-aligned, spherical, cylindrical, cubic, spiral, randomly spaced, arbitrary, and any combination thereof.

It is another object of the present invention to provide the method as defined above, wherein said orientation is an angle between at least one of said image sensors and said body or said base, said angle is in the range of about 1° to about 179°.

It is another object of the present invention to provide the method as defined above, further comprising a step of selecting said dermatological data from a group consisting of: suspected moles, nevus, tattoos, scars, moles, spots, wounds, and any combination thereof.

It is another object of the present invention to provide the method as defined above, wherein said dermatological data comprises predetermined characteristics of suspected moles; said processing unit comprises an image processing algorithm adapted to detect the existence of said suspected moles and to characterize each mole according to said predetermined characteristics.

It is another object of the present invention to provide the method as defined above, further comprising a step of performing via said image processing algorithm an operation selected from the group consisting of: locate the borders of said suspected moles, distinguish between a suspected mole and a wound according to a pattern recognition algorithm, and any combination thereof.

It is another object of the present invention to provide the method as defined above, further comprising a step of storing said predetermined characteristics of each of said suspected moles via said processing unit.

It is another object of the present invention to provide the method as defined above, further comprising a step of selecting said predetermined characteristics are selected from the group consisting of: location, coordinates of border, asymmetry measurement, planar measurements, 3D structure, topography, height, radius, color, and any combination thereof.

It is another object of the present invention to provide the method as defined above, further comprising steps of providing the history of each suspected mole via said processing unit; and providing comparison and changes between the current and the previous predetermined characteristics of said suspected moles via said processing unit.

It is another object of the present invention to provide the method as defined above, further comprising a step of detecting said suspected moles by analyzing 2D and 3D images of said suspected moles via said processing unit.

It is another object of the present invention to provide the method as defined above, further comprising step of providing said base as part of a structure selected from the group consisting of: a booth, a kiosk, a cabin, a private enclosure, and any combination thereof.

It is another object of the present invention to provide the method as defined above, further comprising a step of controlling the operation of said image sensors via said processing unit.

It is another object of the present invention to provide the method as defined above, further comprising a step of operating said image sensors via said processing unit in a synchronized manner, such that a synchronized image of the skin of said body is provided.

It is another object of the present invention to provide the method as defined above, wherein in said synchronized manner, said image sensors are operated simultaneously.

It is another object of the present invention to provide the method as defined above, further comprising a step of eliminating the influence of human hair on the data of said skin map via a hair removal mechanism.

It is another object of the present invention to provide the method as defined above, further comprising a step of performing feedback via a feedback mechanism locatable within said processing unit, said feedback mechanism comprises: (i) an analyzing unit adapted to score said dermatological data according to a predetermined scale, so that abnormal dermatological data is detected; and (ii) a regulating unit adapted to operate said processing unit in a repeated manner when said score is higher than a predetermined value.

It is another object of the present invention to provide the method as defined above, wherein said predetermined scale is adapted to rank parameters selected from the group consisting of: said predetermined characteristics, quality of said images, and any combination thereof.

It is another object of the present invention to provide the method as defined above, further comprising a step of controlling the orientation of at least one of said image sensors via said feedback mechanism.

It is another object of the present invention to provide the method as defined above, further comprising a step of storing said personal data on a safe memory card connectable to a data storage unit.

It is another object of the present invention to provide the method as defined above, further comprising a step of selecting said personal data from the group consisting of: a dermatological data, scan results, set of images, a skin map, the full body photography, a 2D body model, a 3D body model, a 2D analysis, a 3D analysis, dates, patient personal information selected from a group consisting of name, height, weight, size, gender, id, password, family, family history, and any combination thereof, or any combination thereof.

It is another object of the present invention to provide the method as defined above, further comprising a step of allowing an operator to perform via an operating unit operations selected from the group consisting of: analyzing said personal data; analyzing said set of images; analyzing said dermatological data; determining said dermatological data, editing said dermatological data, and any combination thereof.

It is another object of the present invention to provide the method as defined above, further comprising a step of performing via said operating unit operations selected from the group consisting of: providing zoom-in to a predetermined area of a skin map, operating said feedback mechanism, manipulating said personal data, providing a 2D plot of a predetermined area of a skin map according to at least one image of said set of images, providing a 3D plot of a predetermined area of a skin map, providing a 2D plot of a predetermined area of a skin map by performing a 2D projection on said 3D plot, marking a predetermined area of a skin map, and any combination thereof.

It is another object of the present invention to provide the method as defined above, wherein said dermatological data is associated with the evolution and the severity of melanoma of a predetermined area on said human body.

It is another object of the present invention to provide the method as defined above, further comprising a step of identifying via said processing unit said patient according to parameters selected from the group consisting of: name, height, weight, size, gender, id, password, and any combination thereof.

It is another object of the present invention to provide the method as defined above, further comprising a step of further rotating said human body with respect to said image sensor on a rotatable pod stand.

It is another object of the present invention to provide the method as defined above, further comprising steps of: providing a body positioning sub-unit; providing instructions regarding the position of a patient with respect to said image sensors; and stabilizing the position of said patient with respect to said image sensors.

It is another object of the present invention to provide the method as defined above, further comprising a step of providing said image sensors in a homogeneous grid of sensors.

It is another object of the present invention to provide a method for capturing at least one image of the skin of a patient's human body, comprising steps of:
a. providing a skin surface imaging system, comprising: (i) at least one base; a plurality of image sensors, connectable to said base, arranged in a predetermined arrangement; and, (iii) a processing unit communicatable with said image sensors;
b. capturing at least one image of a predetermined area of said human body via said image sensors, thereby providing a set of images;
c. collecting said set of images from said image sensors via said processing unit;
d. analyzing said set of images via said processing unit;
e. constructing via said processing unit a record of a personal data associated with the skin geometry of said human body; and,
f. outputting a dermatological data associated with said skin of said human body;
wherein said method further comprises a step of providing said at least one of said image sensors connected to said base, thereby controlling the distance between at least one of said image sensors and said base or said human body.

It is another object of the present invention to provide the method as defined above, further comprising step of providing a sensor holding and controlling mechanism, wherein said at least one of said image sensors is jointly connectable to said base via said sensor holding and controlling mechanism.

It is another object of the present invention to provide the method as defined above, further comprising step of electrically operating said controlling mechanism by said processing unit.

It is another object of the present invention to provide the method as defined above, further comprising step of manually operating said controlling mechanism by an operator.

It is another object of the present invention to provide the method as defined above, further comprising a step of controlling the orientation between at least one of said image sensors and said human body via said holding and controlling mechanism.

It is another object of the present invention to provide the method as defined above, wherein said control of said distance is performed according to the dimensions of said human body.

It is another object of the present invention to provide the method as defined above, further comprising a step of selecting said image sensors from the group consisting of: visible light sensors, ultraviolet (UV) light sensors, infrared (IR) sensors, and any combination thereof.

It is another object of the present invention to provide the method as defined above, wherein said predetermined arrangement characterized by n arrays locatable at angle of (360/n)° between each other with respect to said human body or said base, each of said n arrays comprises m image sensors; n is an integer greater than or equals to 1; m is an integer greater than or equals to 1.

It is another object of the present invention to provide the method as defined above, wherein each of said n arrays comprises o parallel columns of said image sensors; o is an integer greater than or equals to 1.

It is another object of the present invention to provide the method as defined above, wherein n is 4 and o is 2.

It is another object of the present invention to provide the method as defined above, wherein said set of images of comprises images of overlapping predetermined areas of said human body.

It is another object of the present invention to provide the method as defined above, further comprising a step of providing said predetermined arrangement selected from the group consisting of: homogeneous, non-homogeneous, aligned, non-aligned, spherical, cylindrical, cubic, spiral, randomly spaced, arbitrary, and any combination thereof.

It is another object of the present invention to provide the method as defined above, wherein said orientation is an angle between at least one of said image sensors and said human body or said base, said angle is in the range of about 1° to about 179°.

It is another object of the present invention to provide the method as defined above, further comprising a step of selecting said dermatological data from a group consisting of: suspected moles, nevus, tattoos, scars, moles, spots, wounds, and any combination thereof.

It is another object of the present invention to provide the method as defined above, wherein said dermatological data comprises predetermined characteristics of suspected moles; said processing unit comprises an image processing algorithm adapted to detect the existence of said suspected moles and to characterize each mole according to said predetermined characteristics.

It is another object of the present invention to provide the method as defined above, further comprising a step of performing via said image processing algorithm an operation selected from the group consisting of: locate the borders of said suspected moles, distinguish between a suspected mole and a wound according to a pattern recognition algorithm, and any combination thereof.

It is another object of the present invention to provide the method as defined above, further comprising a step of storing said predetermined characteristics of each of said suspected moles via said processing unit.

It is another object of the present invention to provide the method as defined above, further comprising a step of selecting said predetermined characteristics are selected from the group consisting of: location, coordinates of border, asymmetry measurement, planar measurements, 3D structure, topography, height, radius, color, and any combination thereof.

It is another object of the present invention to provide the method as defined above, further comprising steps of providing the history of each suspected mole via said processing unit; and providing comparison and changes between the current and the previous predetermined characteristics of said suspected moles via said processing unit.

It is another object of the present invention to provide the method as defined above, further comprising a step of detecting said suspected moles by analyzing 2D and 3D images of said suspected moles via said processing unit.

It is another object of the present invention to provide the method as defined above, further comprising step of providing said base as part of a structure selected from the group consisting of: a booth, a kiosk, a cabin, a private enclosure, and any combination thereof.

It is another object of the present invention to provide the method as defined above, further comprising a step of controlling the operation of said image sensors via said processing unit.

It is another object of the present invention to provide the method as defined above, further comprising a step of operating said image sensors via said processing unit in a synchronized manner, such that a synchronized image of the skin of said human body is provided.

It is another object of the present invention to provide the method as defined above, wherein in said synchronized manner, said image sensors are operated simultaneously.

It is another object of the present invention to provide the method as defined above, further comprising a step of eliminating the influence of human hair on the data of said skin map via a hair removal mechanism.

It is another object of the present invention to provide the method as defined above, further comprising a step of performing feedback via a feedback mechanism locatable within said processing unit, said feedback mechanism comprises: (i) an analyzing unit adapted to score said dermatological data according to a predetermined scale, so that abnormal dermatological data is detected; and (ii) a regulating unit adapted to operate said processing unit in a repeated manner when said score is higher than a predetermined value.

It is another object of the present invention to provide the method as defined above, wherein said predetermined scale is adapted to rank parameters selected from the group consisting of: said predetermined characteristics, quality of said images, and any combination thereof.

It is another object of the present invention to provide the method as defined above, further comprising a step of controlling the orientation of at least one of said image sensors via said feedback mechanism.

It is another object of the present invention to provide the method as defined above, further comprising a step of storing said personal data on a safe memory card connectable to a data storage unit.

It is another object of the present invention to provide the method as defined above, further comprising a step of selecting said personal data from the group consisting of: a dermatological data, scan results, set of images, a skin map, the full body photography, a 2D body model, a 3D body model, a 2D analysis, a 3D analysis, dates, patient personal information selected from a group consisting of name, height, weight, size, gender, id, password, family, family history, and any combination thereof or any combination thereof.

It is another object of the present invention to provide the method as defined above, further comprising a step of allowing an operator to perform via an operating unit operations selected from the group consisting of: analyzing said personal data; analyzing said set of images; analyzing said dermatological data; determining said dermatological data, editing said dermatological data, and any

It is another object of the present invention to provide the method as defined above, further comprising a step of performing via said operating unit operations selected from the group consisting of: providing zoom-in to a predetermined area of a skin map, operating said feedback mechanism, manipulating said personal data, providing a 2D plot of a predetermined area of a skin map according to at least one image of said set of images, providing a 3D plot of a predetermined area of a skin map, providing a 2D plot of a predetermined area of a skin map by performing a 2D projection on said 3D plot, marking a predetermined area of a skin map, and any combination thereof.

It is another object of the present invention to provide the method as defined above, wherein said dermatological data is associated with the evolution and the severity of melanoma of a predetermined area on said human body.

It is another object of the present invention to provide the method as defined above, further comprising a step of identifying via said processing unit said patient according to parameters selected from the group consisting of: name, height, weight, size, gender, id, password, and any combination thereof.

It is another object of the present invention to provide the method as defined above, further comprising a step of further rotating said human body with respect to said image sensor on a rotatable pod stand.

It is another object of the present invention to provide the method as defined above, further comprising steps of: providing a body positioning sub-unit; providing instructions regarding the position of a patient with respect to said image sensors; and stabilizing the position of said patient with respect to said image sensors.

It is another object of the present invention to provide the method as defined above, further comprising a step of providing said image sensors in a homogeneous grid of sensors.

It is another object of the present invention to provide a method for capturing at least one image of the skin of a patient's human body, comprising steps of:
a. providing a booth, comprising: (i) a pod stand upon which said patient is adapted to stand; an envelope adapted to surround said patient; a plurality of image sensors, arranged in a predetermined arrangement between said envelope and said patient; and, (iii) a processing unit communicatable with said image sensors;
b. capturing at least one image of a predetermined area of said human body via said image sensors, thereby providing a set of images;
c. collecting said set of images from said image sensors via said processing unit;
d. analyzing said set of images via said processing unit;
e. constructing via said processing unit a record of a personal data associated with the skin geometry of said human body; and,
f. outputting a dermatological data associated with said skin of said human body;
wherein said method further comprises a step of providing said at least one of said image sensors with a joint connection to said envelope, thereby controlling the orientation of at least one of said image sensors with respect to said envelope.

It is another object of the present invention to provide the method as defined above, further comprising step of providing a sensor holding and controlling mechanism, wherein said at least one of said image sensors is jointly connectable to said envelope via said sensor holding and controlling mechanism.

It is another object of the present invention to provide the method as defined above, further comprising step of electrically operating said controlling mechanism by said processing unit.

It is another object of the present invention to provide the method as defined above, further comprising step of manually operating said controlling mechanism by an operator.

It is another object of the present invention to provide the method as defined above, further comprising a step of controlling the orientation between at least one of said image sensors and said human body via said holding and controlling mechanism.

It is another object of the present invention to provide the method as defined above, wherein said control of said distance is performed according to the dimensions of said human body.

It is another object of the present invention to provide the method as defined above, further comprising a step of selecting said image sensors from the group consisting of: visible light sensors, ultraviolet (UV) light sensors, infrared (IR) sensors, and any combination thereof.

It is another object of the present invention to provide the method as defined above, wherein said predetermined arrangement characterized by n arrays locatable at angle of (360/n)° between each other with respect to said human body or said envelope, each of said n arrays comprises m image sensors; n is an integer greater than or equals to 1; m is an integer greater than or equals to 1.

It is another object of the present invention to provide the method as defined above, wherein each of said n arrays comprises o parallel columns of said image sensors; o is an integer greater than or equals to 1.

It is another object of the present invention to provide the method as defined above, wherein n is 4 and o is 2.

It is another object of the present invention to provide the method as defined above, wherein said set of images of comprises images of overlapping predetermined areas of said human body.

It is another object of the present invention to provide the method as defined above, further comprising a step of providing said predetermined arrangement selected from the group consisting of: homogeneous, non-homogeneous, aligned, non-aligned, spherical, cylindrical, cubic, spiral, randomly spaced, arbitrary, and any combination thereof.

It is another object of the present invention to provide the method as defined above, wherein said orientation is an angle between at least one of said image sensors and said human body or said envelope, said angle is in the range of about 1° to about 179°.

It is another object of the present invention to provide the method as defined above, further comprising a step of selecting said dermatological data from a group consisting of: suspected moles, nevus, tattoos, scars, moles, spots, wounds, and any combination thereof.

It is another object of the present invention to provide the method as defined above, wherein said dermatological data comprises predetermined characteristics of suspected moles; said processing unit comprises an image processing algorithm adapted to detect the existence of said suspected moles and to characterize each mole according to said predetermined characteristics.

It is another object of the present invention to provide the method as defined above, further comprising a step of performing via said image processing algorithm an operation selected from the group consisting of: locate the borders of said suspected moles, distinguish between a suspected mole and a wound according to a pattern recognition algorithm, and any combination thereof.

It is another object of the present invention to provide the method as defined above, further comprising a step of storing said predetermined characteristics of each of said suspected moles via said processing unit.

It is another object of the present invention to provide the method as defined above, further comprising a step of selecting said predetermined characteristics are selected from the group consisting of: location, coordinates of border, asymmetry measurement, planar measurements, 3D structure, topography, height, radius, color, and any combination thereof.

It is another object of the present invention to provide the method as defined above, further comprising steps of providing the history of each suspected mole via said processing unit; and providing comparison and changes between the current and the previous predetermined characteristics of said suspected moles via said processing unit.

It is another object of the present invention to provide the method as defined above, further comprising a step of detecting said suspected moles by analyzing 2D and 3D images of said suspected moles via said processing unit.

It is another object of the present invention to provide the method as defined above, further comprising step of providing said envelope as part of a structure selected from the group consisting of: a booth, a kiosk, a cabin, a private enclosure, and any combination thereof.

It is another object of the present invention to provide the method as defined above, further comprising a step of controlling the operation of said image sensors via said processing unit.

It is another object of the present invention to provide the method as defined above, further comprising a step of operating said image sensors via said processing unit in a synchronized manner, such that a synchronized image of the skin of said human body is provided.

It is another object of the present invention to provide the method as defined above, wherein in said synchronized manner, said image sensors are operated simultaneously.

It is another object of the present invention to provide the method as defined above, further comprising a step of eliminating the influence of human hair on the data of said skin map via a hair removal mechanism.

It is another object of the present invention to provide the method as defined above, further comprising a step of performing feedback via a feedback mechanism locatable within said processing unit, said feedback mechanism comprises: (i) an analyzing unit adapted to score said dermatological data according to a predetermined scale, so that abnormal dermatological data is detected; and (ii) a regulating unit adapted to operate said processing unit in a repeated manner when said score is higher than a predetermined value.

It is another object of the present invention to provide the method as defined above, wherein said predetermined scale is adapted to rank parameters selected from the group consisting of: said predetermined characteristics, quality of said images, and any combination thereof.

It is another object of the present invention to provide the method as defined above, further comprising a step of controlling the orientation of at least one of said image sensors via said feedback mechanism.

It is another object of the present invention to provide the method as defined above, further comprising a step of storing said personal data on a safe memory card connectable to a data storage unit.

It is another object of the present invention to provide the method as defined above, further comprising a step of selecting said personal data from the group consisting of: a dermatological data, scan results, set of images, a skin map, the full body photography, a 2D body model, a 3D body model, a 2D analysis, a 3D analysis, dates, patient personal information selected from a group consisting of name, height, weight, size, gender, id, password, family, family history, and any combination thereof or any combination thereof.

It is another object of the present invention to provide the method as defined above, further comprising a step of allowing an operator to perform via an operating unit operations selected from the group consisting of: analyzing said personal data; analyzing said set of images; analyzing said dermatological data; determining said dermatological data, editing said dermatological data, and any combination thereof.

It is another object of the present invention to provide the method as defined above, further comprising a step of performing via said operating unit operations selected from the group consisting of: providing zoom-in to a predetermined area of a skin map, operating said feedback mechanism, manipulating said personal data, providing a 2D plot of a predetermined area of a skin map according to at least one image of said set of images, providing a 3D plot of a predetermined area of a skin map, providing a 2D plot of a predetermined area of a skin map by performing a 2D projection on said 3D plot, marking a predetermined area of a skin map, and any combination thereof.

It is another object of the present invention to provide the method as defined above, wherein said dermatological data is associated with the evolution and the severity of melanoma of a predetermined area on said human body.

It is another object of the present invention to provide the method as defined above, further comprising a step of identifying via said processing unit said patient according to parameters selected from the group consisting of: name, height, weight, size, gender, id, password, and any combination thereof.

It is another object of the present invention to provide the method as defined above, further comprising a step of further rotating said human body with respect to said image sensor on a rotatable pod stand.

It is another object of the present invention to provide the method as defined above, further comprising steps of: providing a body positioning sub-unit; providing instructions regarding the position of a patient with respect to said image sensors; and stabilizing the position of said patient with respect to said image sensors.

It is another object of the present invention to provide the method as defined above, further comprising a step of providing said image sensors in a homogeneous grid of sensors.

It is another object of the present invention to provide an imaging system for capturing at least one image of the skin of a patient's body, comprising:
a. at least one base;
b. a plurality of first image sensors, connectable to said base, arranged in a predetermined arrangement; each of said image sensors adapted to capture at least one image of a predetermined area of said body, so that as a set of images is provided; and,
c. a processing unit communicatable with said image sensors, said processing unit comprising a program of machine-readable instructions embodied on a computer readable memory and executable by a digital data processor adapted to: (i) collect said set of images from said image sensors; (ii) analyze said set of images; (iii) construct a record of personal data associated with the skin of said body of said patient; and (iv) output a dermatological data associated with said skin of said body;
d. at least q second image sensors; at least one of said q second image sensors adapted to capture at least one image of a predetermined area of said body; each of said q image sensors is connected to said base by means of (i) k consecutive arm sections; (ii) at least k−1 joints coupling each two of said k consecutive arm sections together; such that the position of said at least q second image sensors is alterable; q is greater than or equals to 1; k is greater than or equals to 1.

It is another object of the present invention to provide the system as defined above, additionally comprising a second processing unit communicatable with at least one of said q second image sensors; said second processing unit comprising a program of machine-readable instructions embodied on a computer readable memory and executable by a digital data processor adapted to: (i) collect said at least one image from said second image sensors; (ii) analyze said at least one image; (iii) output a data associated with said skin of said body or said image.

It is another object of the present invention to provide the system as defined above, adapted for performing both Total Body Photography and Total Body Dermoscopy

It is another object of the present invention to provide the system as defined above, wherein said position of said q second image sensors is alterable in at least one orientation selected from a group consisting of the sagittal plane, the coronal plane or the transverse plane, upwards, downwards, left, right, the distance between at least one of said second image sensors and said body, or any combination thereof.

It is another object of the present invention to provide the system as defined above, wherein at least one of first or second image sensors is jointly connectable to said base by means of at least one joint, such that the orientation of said at least one of said first or second image sensors with respect to said base is controllable and reconfigurable

It is another object of the present invention to provide the system as defined above, wherein said at least one of said first or second image sensors is jointly connectable to said base via a restricting sensor and controlling mechanism, such that said at least one image sensor is movable in at least one selected from a group consisting of the sagittal plane, the coronal plane or the transverse plane, upwards, downwards, left, right or any combination thereof.

It is another object of the present invention to provide the system as defined above, wherein said restricting sensor is adapted to regulate the movement of said at least one first or second image sensor.

It is another object of the present invention to provide the system as defined above, wherein said controlling mechanism is either electronically operatable by said processing unit or manually operatable by an operator.

It is another object of the present invention to provide the system as defined above, wherein said controlling mechanism is adapted to control the distance between at least one of said first or second image sensors and said body.

It is another object of the present invention to provide the system as defined above, wherein said controlling mechanism is adapted to control the distance in said orientation between at least one of said first or second image sensors and said body.

It is another object of the present invention to provide the system as defined above, wherein said controlling mechanism is adapted to control the location of at least one of said first or second image sensors in said base.

It is another object of the present invention to provide the system as defined above, wherein said base is characterized by a main longitudinal axis; further wherein said controlling mechanism is adapted to control the location of at least one of said first or second image sensors along said main longitudinal axis in said base.

It is another object of the present invention to provide the system as defined above, wherein said control of said distance is performed according to the dimensions of said body.

It is another object of the present invention to provide the system as defined above, additionally comprising a sensor adapted to provide information as for the dimensions of said body, such that said control of said distance is performed according to the dimensions of said body.

It is another object of the present invention to provide the system as defined above, wherein said first or second image sensors are selected from the group consisting of: visible light sensors, ultraviolet (UV) light sensors, infrared (IR) sensors, and any combination thereof.

It is another object of the present invention to provide the system as defined above, wherein said predetermined arrangement characterized by n arrays locatable at angle of (360/n)° between each other with respect to said body or said base, each of said n arrays comprises m first image sensors; n is an integer greater than or equals to 1; m is an integer greater than or equals to 1.

It is another object of the present invention to provide the system as defined above, wherein each of said n arrays comprises o parallel columns of said first image sensors; o is an integer greater than or equals to 1.

It is another object of the present invention to provide the system as defined above, wherein n is at least 4 and o is at least 2.

It is another object of the present invention to provide the system as defined above, wherein said predetermined arrangement characterized by n arrays, each of said n arrays comprises m first image sensors; n is an integer greater than or equals to 1; m is an integer greater than or equals to 1.

It is another object of the present invention to provide the system as defined above, wherein each of said n arrays comprises o parallel columns of said first image sensors; o is an integer greater than or equals to 1.

It is another object of the present invention to provide the system as defined above, wherein each of said n arrays comprises o first image sensors; wherein said o first image sensors are positioned within each of said n arrays in a predetermined manner; o is an integer greater than or equals to 1.

It is another object of the present invention to provide the system as defined above, wherein said predetermined manner is selected from a group consisting of homogeneous, non-homogeneous, aligned, non-aligned, spherical, triangular, cylindrical, cubic, spiral, randomly spaced, arbitrary, polygon having p ribs; p is greater than 1; and any combination thereof.

It is another object of the present invention to provide the system as defined above, additionally comprising means adapted to relocate said base from a first position to a second position.

It is another object of the present invention to provide the system as defined above, wherein said processing unit or said second processing unit is adapted to control the on/off mode of at least one of said first or second image sensors.

It is another object of the present invention to provide the system as defined above, wherein said set of images of comprises at least 2 images of overlapping predetermined areas of said body.

It is another object of the present invention to provide the system as defined above, wherein said predetermined arrangement is selected from the group consisting of: homogeneous, non-homogeneous, aligned, non-aligned, spherical, cylindrical, cubic, spiral, randomly spaced, arbitrary, and any combination thereof.

It is another object of the present invention to provide the system as defined above, wherein said orientation is an angle between at least one of said first image sensors and said body or said base, said angle is in the range of about 1° to about 179°.

It is another object of the present invention to provide the system as defined above, wherein said dermatological data is selected from a group consisting of: suspected moles, the boundaries of suspected moles, tissue encircling said suspected moles nevus, tattoos, scars, moles, spots, wounds, and any combination thereof.

It is another object of the present invention to provide the system as defined above, wherein said processing unit or said second processing unit comprises an image processing algorithm adapted to detect the existence of said suspected moles and to characterize each mole according to predetermined characteristics.

It is another object of the present invention to provide the system as defined above, wherein said image processing algorithm is further adapted to perform operation selected from the group consisting of: locate the borders of said suspected moles, distinguish between a suspected mole and a wound according to a pattern recognition algorithm, and any combination thereof.

It is another object of the present invention to provide the system as defined above, wherein said processing unit or said second processing unit is adapted to store said predetermined characteristics of each of said suspected moles.

It is another object of the present invention to provide the system as defined above, wherein said predetermined characteristics are selected from the group consisting of: location, coordinates of border, asymmetry measurement, planar measurements, 2D structure, 3D structure, topography, height, radius, color, and any combination thereof.

It is another object of the present invention to provide the system as defined above, wherein said processing unit or second processing unit is adapted to provide the history of each suspected mole and to provide comparison and changes between the current predetermined characteristics of said suspected moles and at least one previous predetermined characteristics of said suspected moles.

It is another object of the present invention to provide the system as defined above, wherein said processing unit or said second processing unit is adapted to detect said suspected moles by analyzing 2D and 3D images of said suspected moles.

It is another object of the present invention to provide the system as defined above, wherein said base is part of a structure selected from the group consisting of: a booth, a kiosk, a cabin, a private enclosure, and any combination thereof.

It is another object of the present invention to provide the system as defined above, wherein said processing unit or said second processing unit is adapted to control the operation of said first or second image sensors; said operation is selected from the orientation of at least one of said first or second image sensors; the distance between at least one of said first or second image sensors and said body, on/off mode of at least one of said first or second image sensors.

It is another object of the present invention to provide the system as defined above, wherein said processing unit or said second processing unit is adapted to operate said first or second image sensors in a synchronized manner, such that a synchronized image of the skin of said body is provided.

It is another object of the present invention to provide the system as defined above, wherein said synchronized manner is operation of a portion of at least one of said image sensors.

It is another object of the present invention to provide the system as defined above, wherein in said synchronized manner, said at least two of said first or second image sensors are operated simultaneously.

It is another object of the present invention to provide the system as defined above, further comprising a hair removal mechanism adapted to eliminate the influence of human hair on the data of said personal data.

It is another object of the present invention to provide the system as defined above, wherein said processing unit or said second processing unit further comprises a feedback mechanism, said feedback mechanism comprises: (i) an analyzing unit adapted to score said dermatological data according to a predetermined scale, so that abnormal dermatological data is detected; and (ii) a regulating unit adapted to operate said processing unit or said second processing unit in a repeated manner when said score is higher than a predetermined value.

It is another object of the present invention to provide the system as defined above, wherein said predetermined scale is adapted to rank parameters selected from the group consisting of: said predetermined characteristics, quality of said images; said quality is selected from a group consisting of color, contrast, blurred, out of focus, lightness, and any combination thereof.

It is another object of the present invention to provide the system as defined above, wherein said feedback mechanism further adapted to control the orientation or the 3D position of at least one of said first or second image sensors, the position of said patient, the distance between at least one of said first or second image sensors and said patient.

It is another object of the present invention to provide the system as defined above, further comprising a data storage unit adapted to store said personal data on a portable safe memory card.

It is another object of the present invention to provide the system as defined above, wherein said personal data selected from the group consisting of: a dermatological data, scan results, set of images, a skin map, the full body photography, a 2D body model, a 3D body model, a 2D analysis, a 3D analysis, dates, patient personal information selected from a group consisting of name, height, weight, size, gender, id, password, family, family history, and any combination thereof, or any combination thereof.

It is another object of the present invention to provide the system as defined above, wherein said processing unit or said second processing unit is adapted to analyze said set of images based upon previous analyzes.

It is another object of the present invention to provide the system as defined above, wherein said processing unit or said second processing unit further comprises an operation unit adapted to allow an operator to perform operation selected from the group consisting of: analyze said personal data; analyze said set of images; analyze said dermatological data; determine said dermatological data, edit said dermatological data, and any combination thereof.

It is another object of the present invention to provide the system as defined above, wherein said operation unit is further adapted to perform operations selected from the group consisting of: provide zoom-in to a predetermined area of a skin map, operate said feedback mechanism, maipulate said personal data, provide a 2D plot of a predetermined area of a skin map according to at least one image of said set of images, provide a 3D plot of a predetermined area of a skin map, provide a 2D plot of a predetermined area of a skin map by performing a 2D projection on said 3D plot, mark a predetermined area of a skin map, and any combination thereof.

It is another object of the present invention to provide the system as defined above, wherein said dermatological data is associated with the evolution and the severity of melanoma of a predetermined area on said body.

It is another object of the present invention to provide the system as defined above, wherein said processing unit or said second processing unit is further adapted to identify a patient according to parameters selected from the group consisting of: name, height, weight, size, gender, id, password, family, family history, and any combination thereof.

It is another object of the present invention to provide the system as defined above, further comprising a rotatable pod stand adapted to rotate said body with respect to said first or second image sensor.

It is another object of the present invention to provide the system as defined above, additionally comprising a moving mechanism couple to at least one of said image sensors, adapted to move said image sensors from one potion to another within said base.

It is another object of the present invention to provide the system as defined above, additionally comprising lightning means selected from a group consisting of LEDs, lamps, bulb filament or any combination thereof.

It is another object of the present invention to provide the system as defined above, adapted to synchronies the operation of at least one of said image sensor and said lightning means.

It is another object of the present invention to provide the system as defined above, wherein said dermatological data is used from detecting melanoma, for esthetics use, cosmetics use or any combination thereof.

It is another object of the present invention to provide the system as defined above, wherein at least one of said image sensor comprises at least one marker.

It is another object of the present invention to provide the system as defined above, wherein at least one of said image sensor is adapted to rotate around said image sensor's main axis.

It is still an object of the present invention to provide the system as defined above, further comprising a body positioning sub-unit adapted to: provide instructions regarding the position of a patient with respect to said first or second image sensors; and to stabilize the position of said patient with respect to said first or second image sensors.

It is lastly an object of the present invention to provide the system as defined above, wherein said first image sensors are positioned in a homogeneous grid of sensors.

### BRIEF DESCRIPTION OF THE FIGURES

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIGS. 1a-b are schematic illustration of one embodiment of the system of the present invention;

FIGS. 2a-b are schematic illustration of the two main components block diagrams: a hardware component and a software component of the present invention;

FIGS. 3a-b are two schematic illustrations of the system concept: a detailed block diagram and a top level design block diagram

FIG. 4 is a schematic illustration of a safe memory card on which the personal data may be stored;

FIGS. 5a-g are schematic illustrations of different configuration according to which the image sensors of the present invention may be arranged;

FIGS. 6a-b are schematic illustrations of a set of images which comprises images of overlapping predetermined areas of the human body (FIG. 6a) and 3D human body reconstruction (FIG. 6b);

FIGS. 7a-d are schematic illustrations of way in which an ultra-resolution image is generated for the analysis of moles based on the collected set of images;

FIGS. 8a-b are a schematic illustrations of a 2D and a 3D ultra-resolution image;

FIGS. 9a-c are schematic illustrations of different embodiments of the software component of the present invention;

FIG. 10 is a schematic illustration of one embodiment of the method according to which the system of the present invention is operated;

FIG. 11 is a schematic illustration of screen shots which may be presented to the operator of the system of the present invention; and,

FIG. 12 are schematic illustration of screen shots which may be presented to the operator of the system of the present invention;

FIGS. 13-17 illustrates different embodiment of the present invention;

FIG. 18 illustrates the sagittal plane, the coronal plane, the transverse plane

FIG. 19 illustrates another embodiment of the present invention;

FIGS. 20-22 illustrate another embodiment of the present invention;

The drawings together with the description make apparent to those skilled in the art how the invention may be embodied in practice.

### DETAILED DESCRIPTION OF THE PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The present invention discloses a system and method for total body photography, screening and evolution of moles for early detection of typical symptoms of melanoma.

The device and system of the present invention provides both a total body photography and dermoscopy integrated together.

The system of the present invention includes automatic recognition determination and comparison of a variety of parameters of associated with the detected mole in its 2D and 3D space. The procedure of the present invention is noninvasive and it is designated to support a dermatological decision which may be performed by the system and/or by an operator (e.g., a doctor).

The term ‘image’ refers hereinafter to an electronic or any other representation of a figure, form, reflection, or picture of a predetermined area of the human body which may be acquired by any known in the art sensor (e.g., the image sensors of the present invention).

The term ‘evolution’ refers hereinafter to physiological changes of an object of interest (e.g., a mole) during a predetermined period of time (e.g., long-term, short-term).

The term “about” refers hereinafter to a range of 25% below or above the referred value.

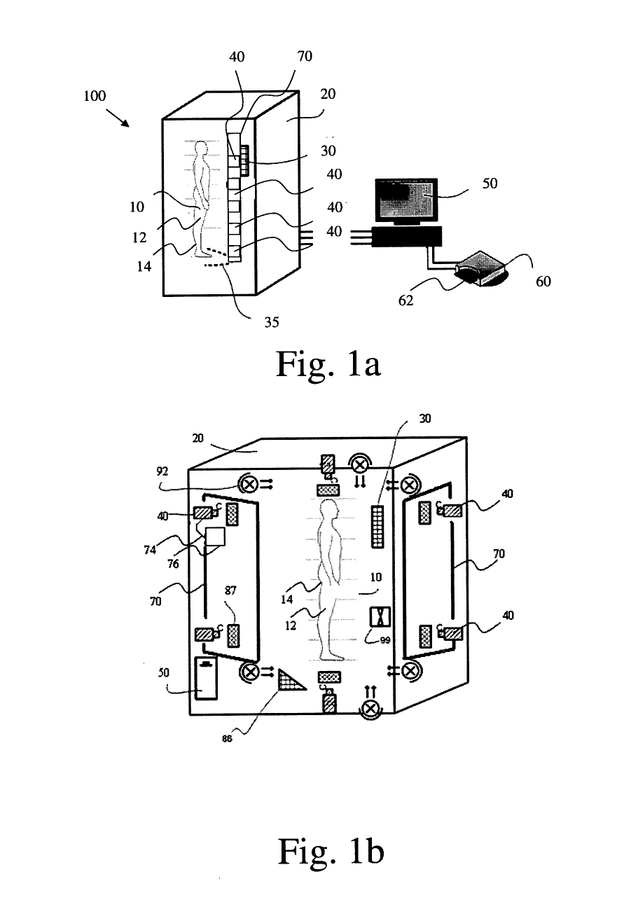

Reference is now made to FIG. 1a which schematically illustrates a specific embodiment of the general principal of the present invention.

According to this figure, in which an imaging system 100 for scanning the skin 14 of a patient's human body 12 is illustrated. In this embodiment, a patient 10 may enter into a dedicated booth 20.

System 100 may include light markers 35 which may indicate where to stand and a monitor 30 may demonstrate the standing position and additional instructions to patient 10. When patient 10 is ready, starting sign may be provided to patient 10, and the imaging process may begin.

Following a predetermined period of time, a set of images of the patient's body are acquired by image sensors 40 (e.g., camera/s), and patient 10 may be requested to leave booth 20.

At the next stage, the set of images may be processed and analyzed in processing unit 50. According to some embodiments, processing unit 50 may be connected to a data storage unit 60 to store the personal data of patient 10.

Data storage unit 60 may be connected to a safe memory card 62 on which the personal data may be stored. The operator of system 100 may provide safe memory card 62 to patient 10.

According to other embodiments of the present invention, system 100 may be used for other applications such as: vein treatment tracking, esthetic operations, etc.

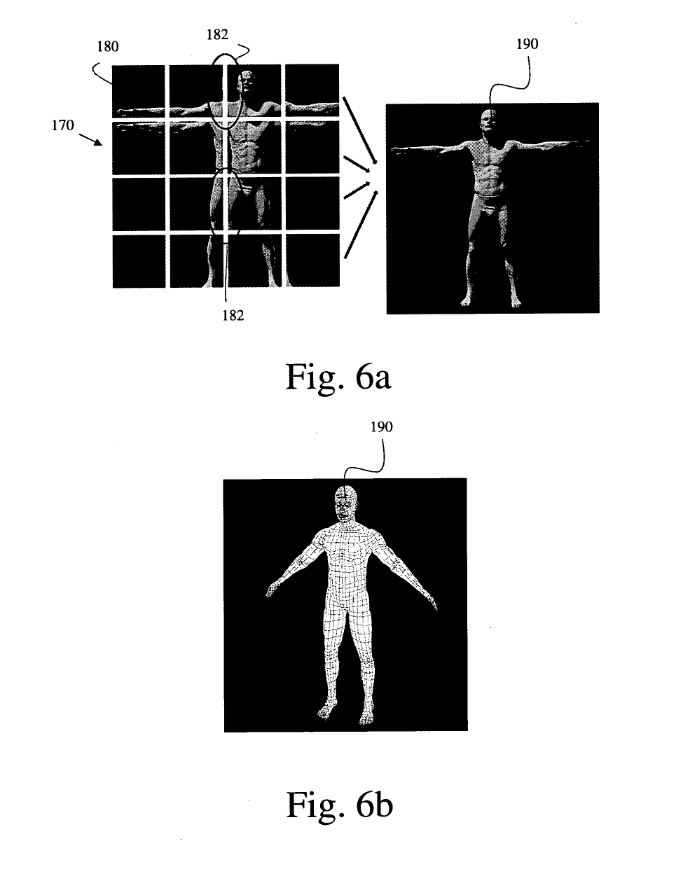

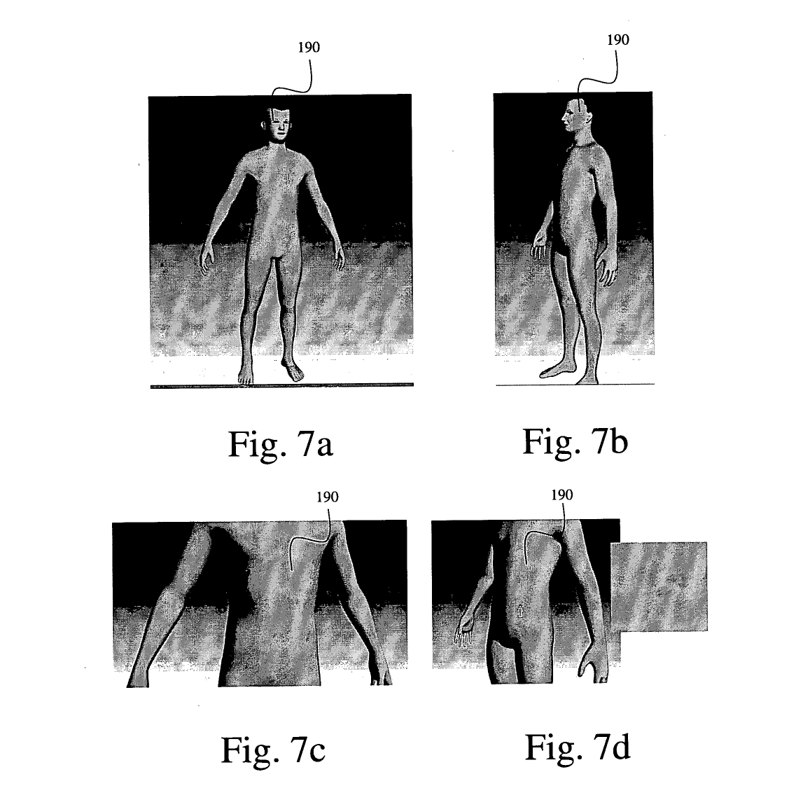

According to different embodiment, the present invention discloses an imaging system for scanning the skin of a patient's human body. The system may comprise the following components:
a. at least one base 70 (in FIG. 1b).
b. a plurality of image sensors 40, connectable to base 70, arranged in a predetermined arrangement so as to achieve the best body coverage; each of image sensors 40 is adapted to capture at least one image 180 (in FIG. 6a) of a predetermined area of human body 12 of patient 10, so that as a set of images 170 is provided.
c. a processing unit 50 communicatable with image sensors 40.

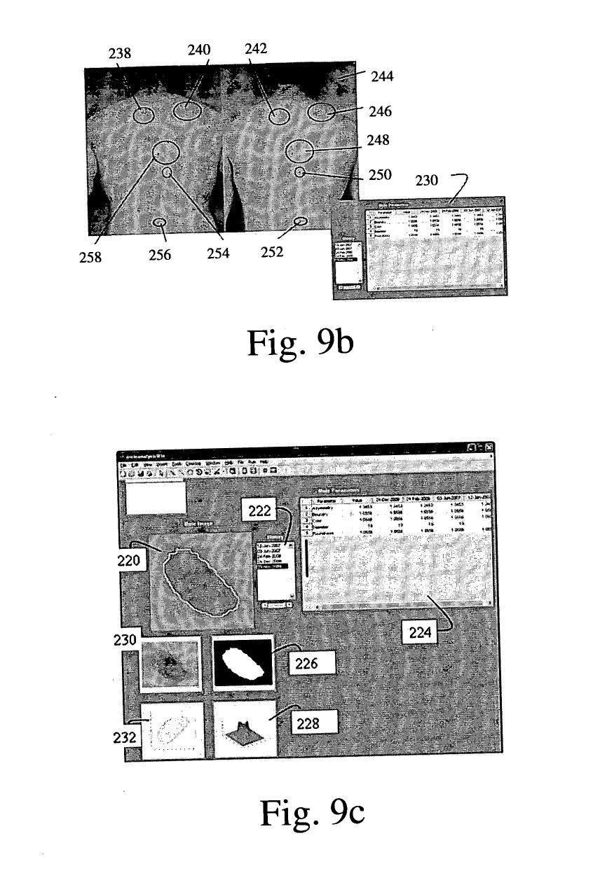

It is within the scope of the present invention that processing unit 50 comprises a program of machine-readable instructions embodied on a computer readable memory and executable by a digital data processor adapted to:
(i) collect set of images 170 from image sensors 50;
(ii) analyze set of images 170; and,
(iii) construct a record of a personal data 220 (exemplary illustrated in FIG. 9a) associated with the skin of the human body; and (iv) output a dermatological data 230 (exemplary illustrated in FIG. 9b) associated with skin 14 of human body 12.

According to one embodiment of the present invention, at least one of image sensors 40 may be jointly connected to base 70 via a joint 74 such that the orientation of the at least one of the image sensors 40 with respect to base 70 is controllable. The orientation of the at least one of the image sensors 40 with respect to base 70 may be an angle between at least one of the image sensors 40 and the human body or the base, the angle may be in the range of about 1° to about 179°.

According to another embodiment of the present invention, at least one of said image sensors 50 may be connected to base 70 such that the distance between at least one of the image sensors 50 and base 70 or human body 14 is controllable.

According to some embodiments of the present invention, the connection of at least one of the image sensors 40 by base 70 may be provided via a sensor controlling mechanism 76 (instead or additionally to joint 74).

The controlling mechanism 76 may be used for one of the following functions: hold at least one image sensor, control the orientation of at least one image sensor, control the distance between at least one image sensor and the human body (or alternatively the base), rotate at least one of the mage sensors (so as to re-orient the same either in the sagittal plane, the coronal plane the transverse plane, upwards, downwards, left, right, or any combination thereof.

It should be pointed that by changing the distance between the image sensor 40 and the body (or the base 70), a zoon-in\zoom-out operation is performed.

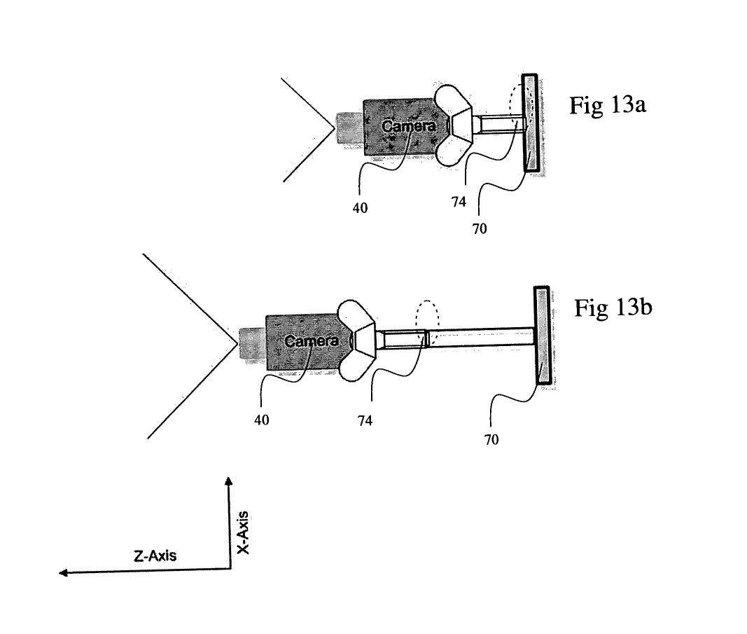

Reference is now made to FIGS. 13a-13b illustrating said enablement in which the distance between the image sensors 40 and the base 70 is altered. As can be seen in the figures, the image sensor is positioned in a first position (see FIG. 13a) and in FIG. 13b the distance is altered.

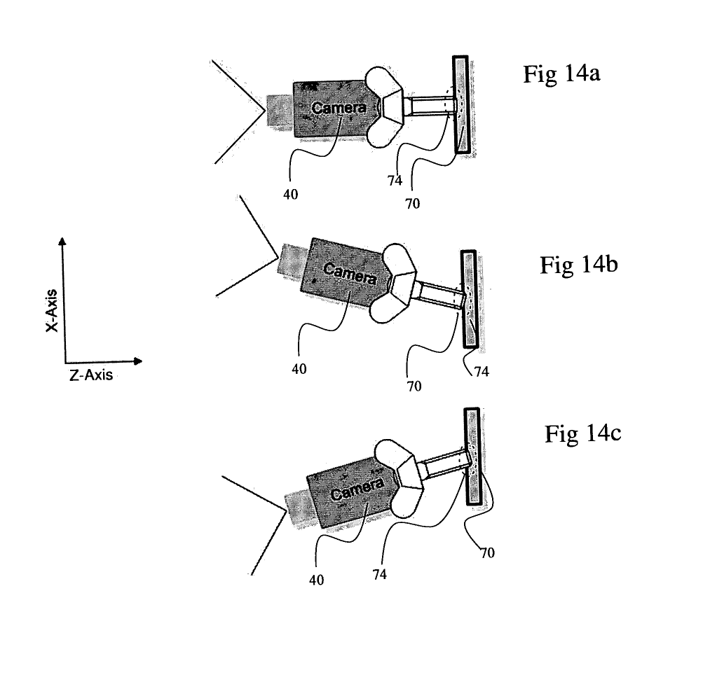

Reference is now made to FIGS. 14a-14c illustrating enablement in which the orientation of said image sensor is altered (namely upwards and downwards movements). As can be seen in the figures, the image sensor 40 is oriented at a first orientation along the X axis (see FIG. 14a) and in FIG. 14b, 14c the orientation is altered.

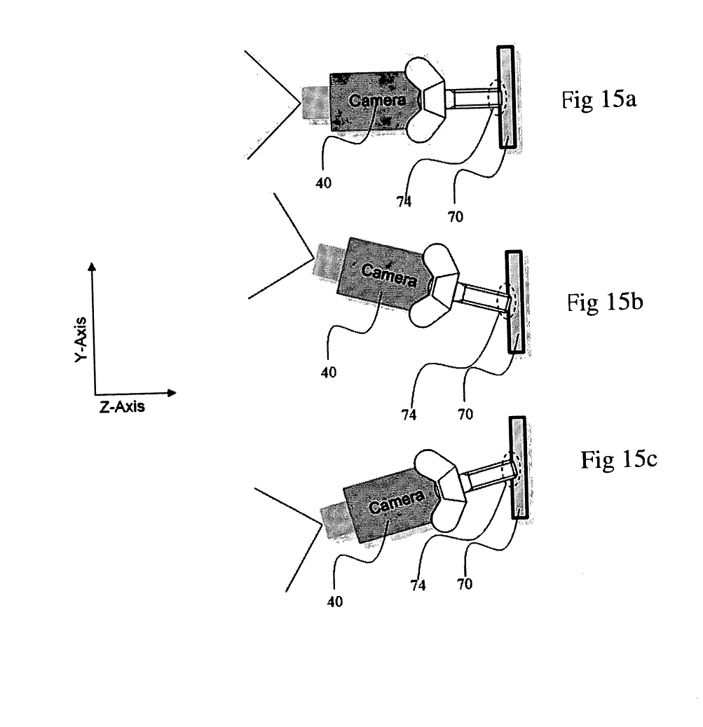

Reference is now made to FIGS. 15a-15c illustrating enablement in which the orientation of said image sensor is altered (namely left-right movements). As can be seen in the figures, the image sensor 40 is oriented at a first orientation along the Y axis (see FIG. 15a) and in FIG. 15b, 15c the orientation is altered.

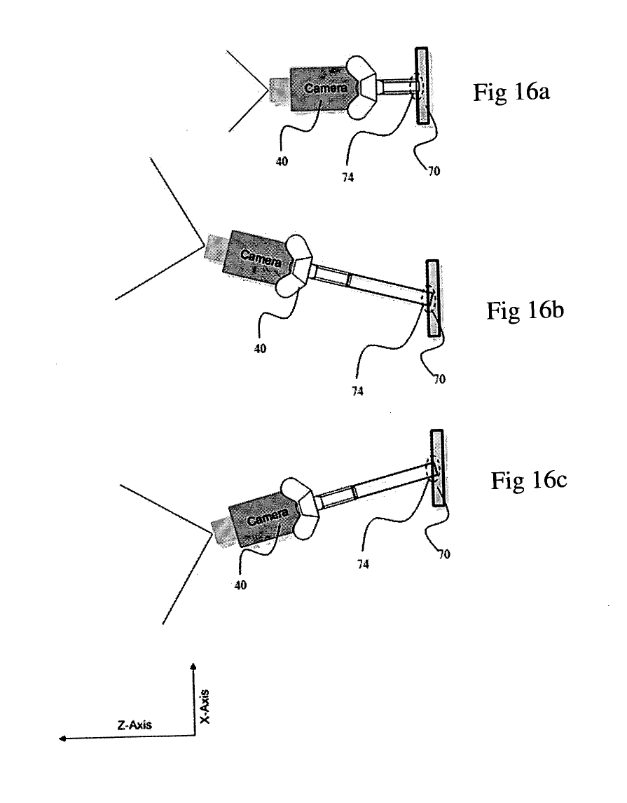

Reference is now made to FIGS. 16a-16c illustrating enablement in which the orientation of said image sensor is altered. As can be seen in the figures, the image sensor 40 is oriented at a first orientation along the XY plane (see FIG. 16a) and in FIG. 16b, 16c the orientation is altered.

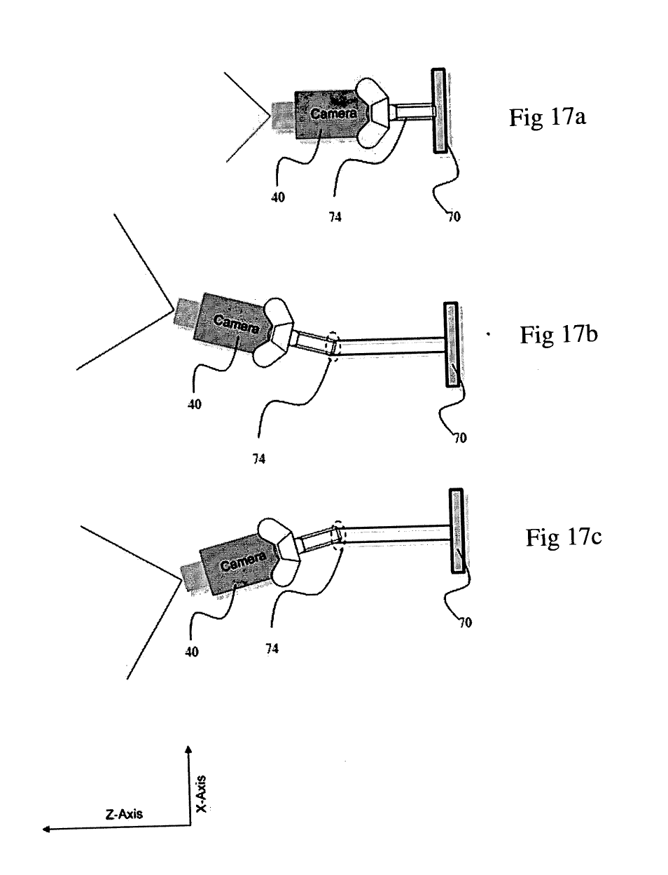

Reference is now made to FIGS. 17a-17c illustrating enablement in which both the orientation and the distance of said image sensor is changed. As can be seen in the figures, the image sensor 40 is coupled to the base 70 via at least one joint 74. In FIG. 17a, the image sensor is in a first position. FIGS. 17b and 17c illustrates movement of said image sensor both in the Z direction (distance alteration between the image sensors and the base) and in the X axis.

In such embodiment, the system functions to perform Total Body Photography as well as Total Body Dermoscopy.

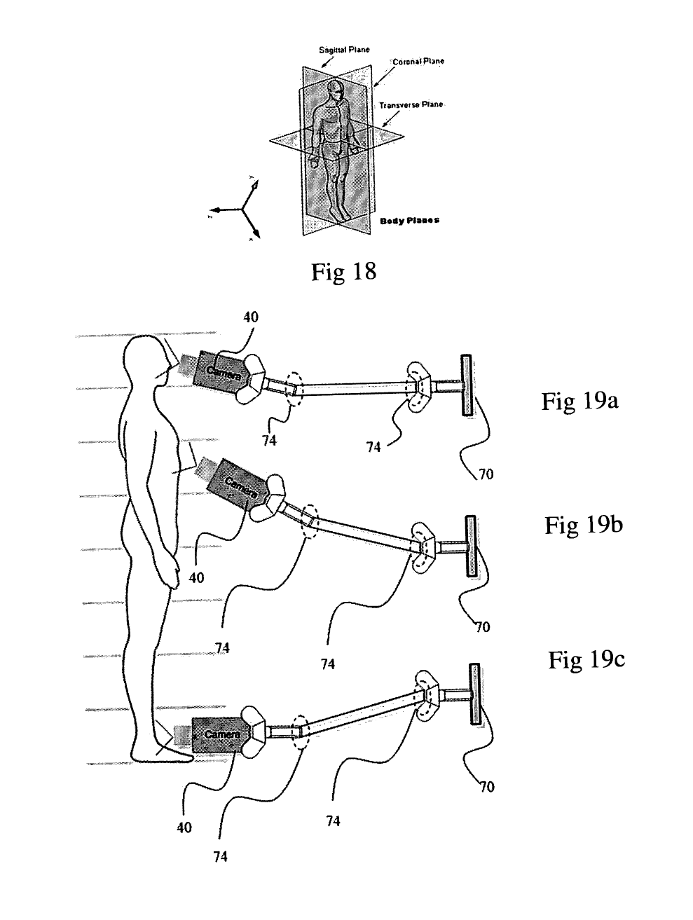

Reference is now made to FIG. 18, which illustrates the sagittal plane, the coronal plane and the transverse plane. As can be seen from the figure, enabling movements in the sagittal plane, the coronal plane, the transverse plane or any combination thereof, any movement of the image sensors in the upwards, downwards, left, right direction is enabled.

According to some embodiment the system enables both changing the orientation of at least one image sensor, altering the distance between the image sensor and the human body (or base) and once the distance has been change the orientation of the image sensor may be fine-tuned once more (re-orientation of the image sensor), see FIGS. 17a-17c.

According to another embodiment the controlling mechanism may comprise several joints 74 so as to enable a more delicate movement of the image sensors 40. According to this embodiment the image sensor comprises a “robotic arm” such that the distance between the image sensor and the base can be altered, the orientation of the same, both the distance and the orientation.

Reference is now made to FIGS. 19a-19c illustrating an embodiment comprising 2 joints 74.

In another embodiment the controlling mechanism 76 controls the distance between at least one image sensor and the human body (or alternatively the base). In said embodiment it may be performed according to the dimensions of the human body. In other words, the controlling mechanism will take into consideration the dimensions of the patient; e.g., thin, thick (heavy weighed).

According to some embodiments, the controlling mechanism 76 may be electronically operated by processing unit 50 or external hardware.

According to other embodiments, controlling mechanism 76 may be manually operated by an operator (e.g., a technician, or physician).

FIG. 1b also illustrates booth 20 in which the system of the present invention is located. The booth may also be a structure selected from the group consisting of: a booth, a kiosk, a cabin, a private enclosure, and any combination thereof.

According to this figure, the system of the present invention may additionally comprise a monitor 30 which may provide to patient 10 standing instructions.

Processing unit 50 is adapted to control the operation of image sensors 40. This operation may be provided in a synchronized manner, e.g. all the image sensors 40 operated simultaneously or an a sequential manner. In the sequential manner, for example, at least one segment of the image sensors 40 are operated simultaneously and only than another segment is operated.

According to another embodiment of the present invention the system is configured to have overall system synchronization. For example the image sensors 40 will be synchronized with a lightning means (Leds, lamps, bulb filament etcetera) so as to obtain optimized images or optimized conditions.

According to one embodiment, the synchronized manner may be a simultaneous operation of image sensors 40

According to another embodiment of the present invention, at least one of said image sensors will comprise at least one marker. Said marker will be used a signaling means to ensure the right synchronization is maintained.

According to another embodiment of the present invention, the desired areas on the patient's body are marked so as to signal at least one of the image sensors where is e.g., the desired area to focus on.

According to this embodiment, the full body photography may be taken by image sensors 40 in one shot (at the same time, or effectively in one-shot).

According to another embodiment the image sensor are operated in an interleaved manner in very short time interval between captures, so basically it will be one-shot.

According to certain needs, additional shots may be taken consecutively. According to some embodiments, the system may operate illumination components 92 for different light conditions or any other change in capturing condition. Moreover, the system may also comprise special filters array 87, using 3D component 86 like a grid or a stereo.

According to another embodiment of the present invention, at least one of said image sensors will comprise at least one marker. Said marker will be used a signaling means to ensure the right synchronization is maintained.

According to different embodiments, the image sensors 40 may be for example: CCD sensors, CMOS sensors, Tri-well linear sensors, Micro-cantilever sensors, parallel optical axis sensors, high dynamic range sensors, visible light sensors, ultraviolet (UV) light sensors, infrared (IR) sensors, and any combination thereof. According to some embodiments, each image sensor may comprise a grid of sensors.

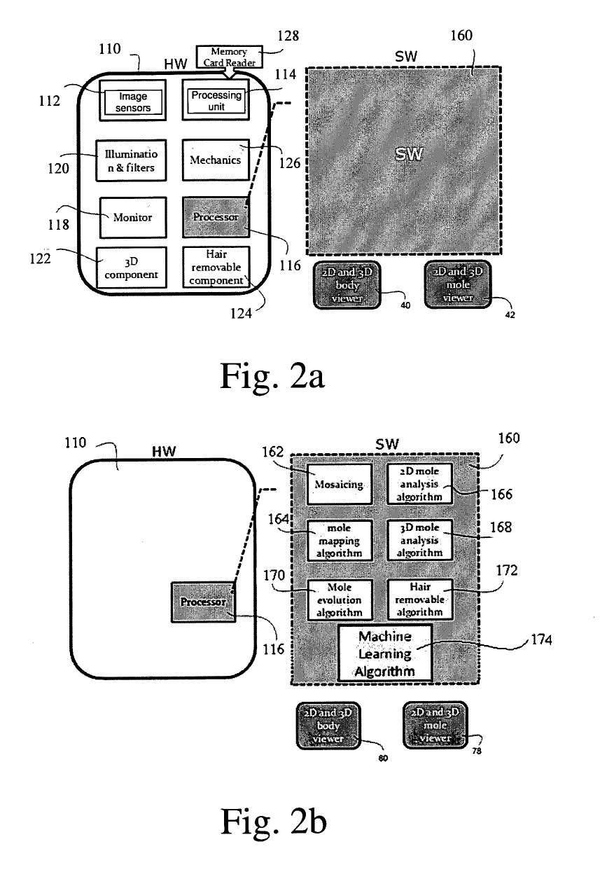

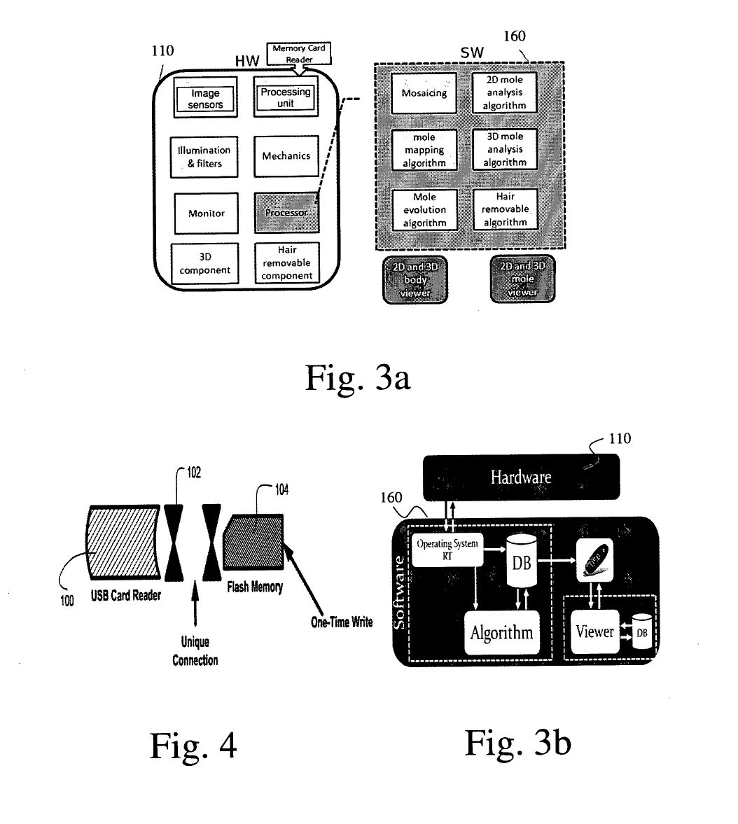

Reference is now made to FIGS. 2a-b and 3a-b, in which the system of the present invention is schematically illustrated. The system of the present invention is an integration two main components: a hardware component 110 and a software component 160. The hardware component 110 and the software component 160 are adapted to communicate with each other. For example, some hardware auxiliaries can be added to assist the software component 160, such as projecting a few markers on several critical points on the patient body, taking several consecutive images with different light conditions, etc. These hardware auxiliaries will allow the software to base its analysis on processing assumptions, which will improve dramatically the system analysis reliability. The software component 160 may output to the operator a 2D and 3D view of the patient's human body, and/or a view of a specific mole.

FIG. 2a schematically illustrates a block diagram of the hardware component 110. The hardware component 110 may comprise image sensors 112. The data from image sensors 112 is acquired by processing unit 114 operatable by processor 116. According to one embodiment, the processing unit 114 is responsible to synchronize image sensors 112 to get one-shot image capture. The hardware component 110 comprises additional components such as: a monitor 118 adapted to provide instruction to the patient and/or to provide an output to the operator; illumination components and special filters 120; 3D component 122, hair removal component 124; and the rest of the mechanics of the system 126, such as: a base and/or an image holding and controlling mechanism. The mechanics of the system 126 may comprise all the elements which may be needed to construct the system of the present invention.

The hardware component 110 may also comprise a data storage unit which may be connected to a safe memory card 128 on which the personal data may be stored. The safe memory card 128 may provide privacy of the personal data by using as special secured memory card which can be read by a special card reader only.

Reference is now made to FIG. 2b which schematically illustrates one embodiment of the software component 160 of the system of the present invention.

The software component 160 may comprise various modules adapted to analyze the set of images which is acquired by the image sensors 40 of the present invention. The modules may be for example:
(i) a mosaicing module 110 adapted to receive the set of images from the image sensors, and to construct a record of personal data associated with the skin of said human body of said patient.
(ii) a mole mapping algorithm 164 adapted to map of all moles that are spread over the whole human body and to plot them and their analysis. The suspicious moles can be marked. The mole mapping algorithm 164 may also provide a list of all the moles after numbering the same with predetermined characteristics of each of the suspected moles. The data may also be automatically written into a report. The mole mapping algorithm 164 may also communicate with a 2D analysis algorithm 166 and/or a 3D analysis algorithm 168 in which each mole may be analyzed in a 2D space and/or a 3D space, so as to provide predetermined characteristics of each of the suspected moles. Algorithms 164, 166 and 168 may also provide special parameters, plots, other information, and report. According to different embodiments, algorithms 164, 166 and 168 are adapted to detect the existence of the suspected moles and to characterize each mole according to the predetermined characteristics. Algorithms 164, 166 and 168 may also be based on image processing algorithms adapted to perform operation selected from the group consisting of: locate the borders of the suspected moles, distinguish between a suspected mole and a wound according to a pattern recognition algorithm, and any combination thereof. Algorithms 164, 166 and 168 may also store the predetermined characteristics of each of the suspected moles.
(iii) a mole evolution algorithm 170 adapted to analyze the history of each patient and to compare the predetermined characteristics of each mole. Mole evolution algorithm 170 may also provide a dermatological data which comprises the predetermined characteristics of suspected moles. The dermatological data may be associated with the evolution and the severity of melanoma of a predetermined area on the human body. Mole evolution algorithm 170 may provide the history of each suspected mole and to provide comparison and changes between the current and the previous predetermined characteristics of the suspected moles.
(iv) a hair removal algorithm 172 adapted to eliminate the influence of human hair on the collected data.

According to another embodiment, the system is a learning system. According to this embodiment, the system learns the past analysis on previous stored data and may perform the same analysis on future data.

According to another embodiment, the system is a learning system. According to this embodiment, the system learns the past analysis on previous stored data and based on the past data learnt the system is able to perform new analysis (or extra analysis) on future data.

According to some embodiments, the records of the personal data which is used by the software component of the present invention may contain: a dermatological data, scan results, set of images, a skin map, the full body photography, a 2D body model, a 3D body model, a 2D analysis, a 3D analysis, a report, or any combination thereof. According to different embodiments of the present invention, the dermatological data may be for example: suspected moles, nevus, tattoos, scars, moles, spots, wounds, and any combination thereof.

According to different embodiments, the predetermined characteristics may be selected from the group consisting of: location, coordinates of border, asymmetry measurement, asymmetry measurement, planar measurements, 3D structure, topography, height, radius, color, and any combination thereof.

According to some embodiments of the present invention, the predetermined characteristics (i.e., features) for the classification of the moles are at least one of the following:

1. 2D Spatial Features:
A. Border Irregularity Index—Irregularity index is given

$$\frac{ah}{2 π \cdot ( {a}^{2} + {b}^{2} )} \cdot \frac{{P}^{2}}{A}$$

where: a and b are the lengths of the major and minor axes of the best fit ellipse respectively.
B. Mole Asymmetry measure—is given by

$$\frac{{A}_{x}}{{A}_{z}}$$

where: Aₓ is the overlapping area of the mole after folding along its principal axes and A_{τ} is the total area of the mole.
C. Solid pigment asymmetry index—within the mole find by histogram thresholding the pigmented sites and calculate their asymmetry respective to the non-pigmented mole area.

2. 2D Color Features:
A. Variance red/green/blue:

$${Var}_{i} = \frac{{\sum }_{( x , y )} {( {i}_{( x , y )} - {i}_{skin} )}^{2}}{{A}_{t}} ; i = r , g , b$$

The summation is over the (x,y) r/g/b pixel values within a mole. i_{sk□n} is the average r/g/b value at the perimeter of the analyzed mole.
B. Relative chromaticity of red/green/blue (example of r):

$$\frac{{r}_{lesion}}{{r}_{lesion} + {g}_{lesion} {b}_{lesion}} - \frac{{r}_{skin}}{{r}_{skin} \vert {g}_{skin} \vert {b}_{skin}}$$

C. Ratio of red/green/blue:

$$\frac{{i}_{lesion}}{{i}_{skin}} ; i = r , g , b$$

D. Difference in lightness (in CIE LAB space): ΔL=Lₗₑₛᵢₒₙ*−□ₛₖᵢₙ*
E. Difference in Chroma (in CIE LAB space):

ΔC=Cₗₑₛᵢₒₙ*−Cₛₖᵢₙ*; C=\sqrt{a²+b²}
F. Difference in Color (in CIE LAB space):

ΔCol=\sqrt{(ΔL)²+(Δa)²+(Δb)²};

Δa=aₗₑₛᵢₒₙ−aₛₖᵢₙ, Δb=bₗₑₛᵢₒₙ−bₛₖᵢₙ
G. Difference in hue.

ΔH=\sqrt{(ΔCol)²−(ΔL)²−(ΔC)²}
H. Redness around the mole borders

3. 2D Structure Features

4. 3D Spatial Features
A. 3D dimensions
B. 3D irregularity
C. 3D asymmetry

5. 3D full body model
A. mole localization

Reference is now made to FIG. 4 which schematically illustrates a safe memory card 128 on which the personal data may be stored. The safe memory card 128 may provide privacy of the personal data by using as special secured memory card which can be read by a special card reader 129 only. The patient's information and full body image and analysis may be saved on safe memory card 128. Safe memory card 128 may be encrypted and may be read only by a special card reader 129 that locates at the doctor's clinic. The privacy is kept since only the doctor can read the data with this special device.

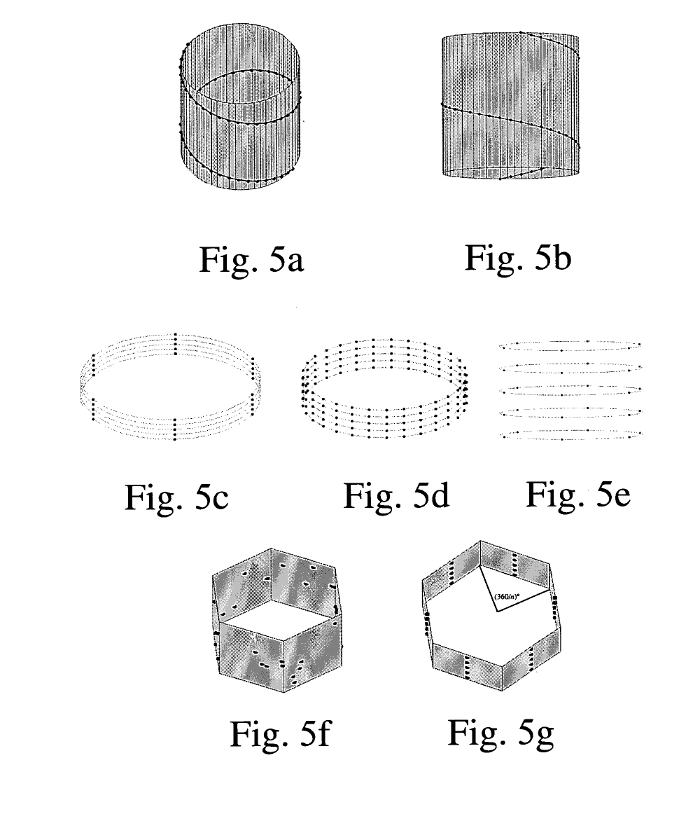

Reference is now made to FIGS. 5a-g which schematically illustrate different configuration according to which the image sensors of the present invention may be arranged. The predetermined arrangement according to which the image sensors may be arranged may be for example one of the following: homogeneous, non-homogeneous, aligned, non-aligned, spherical, cylindrical, cubic, spiral, randomly spaced, arbitrary, and any combination thereof. According to a specific embodiment, the image sensors of the present invention may be arranged in a homogeneous grid of sensors.

FIGS. 5a-b illustrate an embodiment in which the image sensors are arranged in a spiral shape.

FIGS. 5c-e illustrate an embodiment in which the image sensors are arranged in a round shape.

FIG. 5f illustrate an embodiment in which the image sensors are randomly positioned.

FIG. 5g illustrate an embodiment in which the image sensors are according to an arrangement of n arrays locatable at angle of between each other with respect to the human body or the base, each of the n arrays comprises m image sensors; n is an integer greater than 1; m is an integer greater than 1.

Each of the n arrays comprises o parallel columns of the image sensors; o is an integer greater than According to the preferred embodiment, wherein n is at least 4 and o is at least 2.

It should be pointed out that the arrays may be equally spaced or may be positioned in a non-homogeneously spacing (i.e., the distance between each pair of arrays may be varied).

Reference is now made to FIGS. 6a-b and 7a-d which schematically illustrate a 3D human body model 190, which may be part of the personal data collected by the system of the present invention. By using special image processing algorithm the 2D and 3D human body model may be generated. The processing unit of the present invention further comprises an operation unit adapted to allow an operator to perform operation selected from the group consisting of: analyze the skin map; analyze the set of images; analyze the dermatological data; determine the dermatological data, edit the dermatological data, and any combination thereof. Moreover, the operator of the system may can view 3D model 190 from every angle, zoom in and out up to his needs, request specific area mole mapping, request specific mole analysis and view (2D and 3D), request a report, etc.

FIG. 6a illustrates the set of images 180 which comprises at least 2 images of overlapping predetermined areas 182 of the human body.

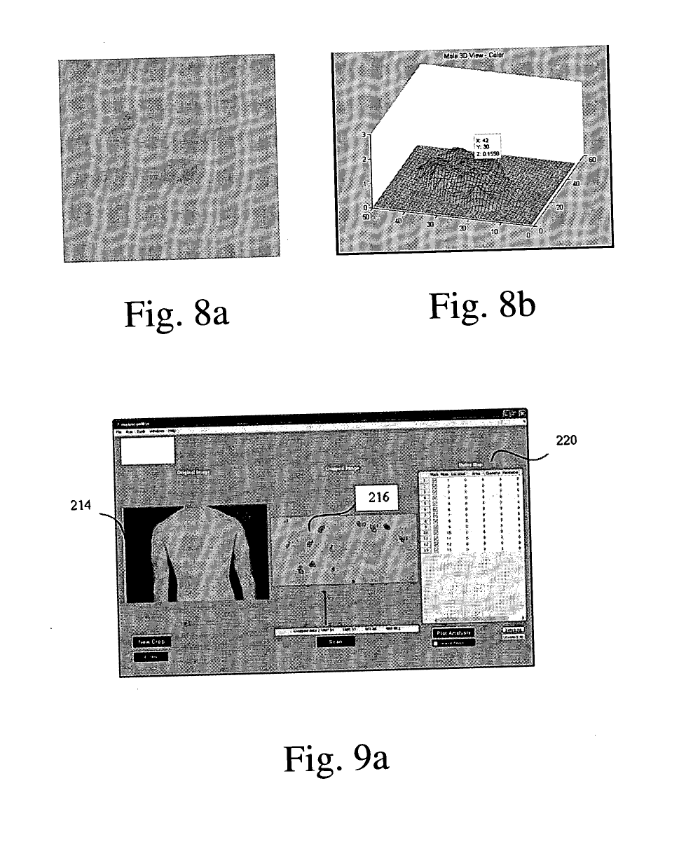

The illustrated data of FIG. 6a-b and 7a-d present a way in which an ultra-resolution image and a 3D model are generated for the analysis of moles based on the collected set of images. An example of an ultra-resolution image is presented in FIG. 8a-b. In FIG. 8a presented a 2D ultra-resolution image, and in FIG. 8b presented a 3D ultra-resolution image. FIG. 8b illustrates a 3D mole view. Very important input to the doctor's decision is the topography of the mole. Using the system special hardware and software, a 3D human body reconstruction is provided, (see FIG. 6b). The same can be plotted in a 3D viewer.

Therefore, first a set of images 180 which have an overlapping predetermined areas 182 are obtained (see FIG. 6a), and then a 3D model (reconstruction) of the human body is provided (see FIG. 6b).

The viewer contains several capabilities like giving the height in every point on the mole surface, view the mole surface from any direction, etc.

The viewer may enable a comparison between different moles, the history of the moles, the 2D images, the 3D model etcetera.

According to some embodiments, the processing unit may further comprises a feedback mechanism, the feedback mechanism comprises: (i) an analyzing unit adapted to score the dermatological data according to a predetermined scale, so that abnormal dermatological data is detected; and (ii) a regulating unit adapted to operate the processing unit in a repeated manner when the score is higher than a predetermined value.

According to another embodiment, the feedback mechanism may be adapted to control the orientation and/or the 3D position and/or the rotation of at least one of the image sensors. According to some embodiments, the predetermined scale is adapted to rank parameters selected from the group consisting of: the predetermined characteristics, quality of the images, and any combination thereof.

According to some embodiments, the processing unit is adapted to perform operations selected from the group consisting of: provide zoom-in to a predetermined area of the skin map, operate the feedback mechanism, provide a 2D plot of a predetermined area of the skin map according to at least one image of the set of images, provide a 3D plot of a predetermined area of the skin map, provide a 2D plot of a predetermined area of the skin map by performing a 2D projection on the 3D plot, mark a predetermined area of the skin map, and any combination thereof.

According to some embodiments, the processing unit is further adapted to identify the human body with a patient according to parameters selected from the group consisting of: name, height, weight, size, gender, id, password, and any combination thereof.

According to some embodiments, the system of the present invention further comprises a rotatable pod stand adapted to rotate the human body with respect to the image sensor.

According to some embodiments, the system of the present invention further comprises a body positioning sub-unit adapted to: provide instructions regarding the position of a patient with respect to the image sensors; and to stabilize the position of the patient with respect to the image sensors.

Reference is now made to FIGS. 9a-c which schematically illustrate different embodiments of the software component of the present invention.

FIG. 9a illustrates different suspected moles with the identification number of each mole, and a table with the predetermined characteristics of each mole. In this figure illustrated a software tool with outputs. Specific area of the body is plotted 214, and a mole mapping is done to this cropped area 216. The mapping can also be given as numbered objects in a table with some basic parameters 220. Suspicious moles according to some criteria and history learning can be marked specifically, for example in different color 216.

According to another embodiment, the mapping is performed to either a specific area of the body or the whole body.

FIG. 9b presents the mole evolution of the moles. After downloading the patient's historical database, the system automatically compares several images/models (2D or 3D) of the same area of the body from different dates. The software can alert on areas in which mole deforming is recognized 254, 250 or when a new mole appearance is recognized 256, 252. When no changes in moles 238, 242, 240, 246, 258, 248, no alert will be given. FIG. 9c illustrates an example of possible 2D mole viewer and its outputs. Up to the user request, specific mole is plotted 220 in several options 226, 228, 230, 232, while each option supplies different view and different information to the doctor. A list of interested parameters can be plotted in a table 224 and/or report which can help the doctor analysis and decision. The discussed mole history can also be viewed 222, comparing different periods on-line.

Each time the patient executes the procedure of the present invention, he may receive an external memory card with his data. The patient may has his history in several memory cards. When going to the physician, there are few possible options. Two of them can be: first visit, not the first visit. When the patient visits the same doctor he visited before, the doctor can load and view the patient history from his computer. But if the patient chose to visit a new doctor, a short loading procedure should be done by the doctor to load the patient history from his all secured memory cards. There is an option that the patient data will be located at some central server and the doctor can download the required data up to his needs.

It is another object of the present invention to provide a method for scanning/capturing or screening the skin of a patient's human body, comprises steps of:
a. providing a skin surface imaging system, comprises: (i) at least one base; a plurality of image sensors, connectable to the base, arranged in a predetermined arrangement; and, (iii) a processing unit communicatable with the image sensors;
b. capturing at least one image of a predetermined area of the human body via the image sensors, thereby providing a set of images;
c. collecting the set of images from the image sensors via the processing unit;
d. analyzing the set of images via the processing unit;
e. constructing via the processing unit a record of a personal data associated with the skin geometry of the human body; and,
f. outputting a dermatological data associated with the skin of the human body;

It is within the scope of the present invention that the method further comprises a step of providing the at least one of the image sensors with a joint connection to the base, thereby controlling the orientation and/or the distance of at least one of the image sensors with respect to the base.

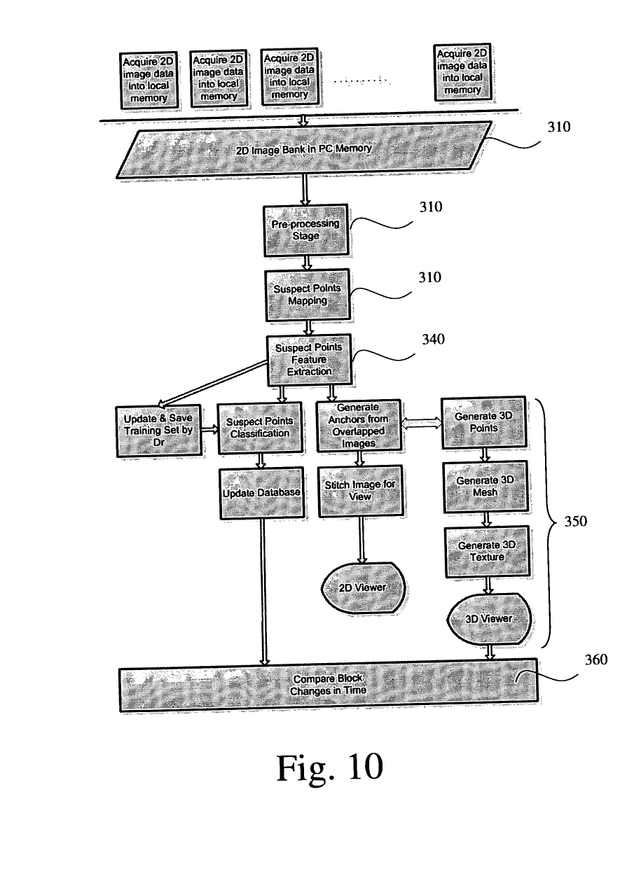

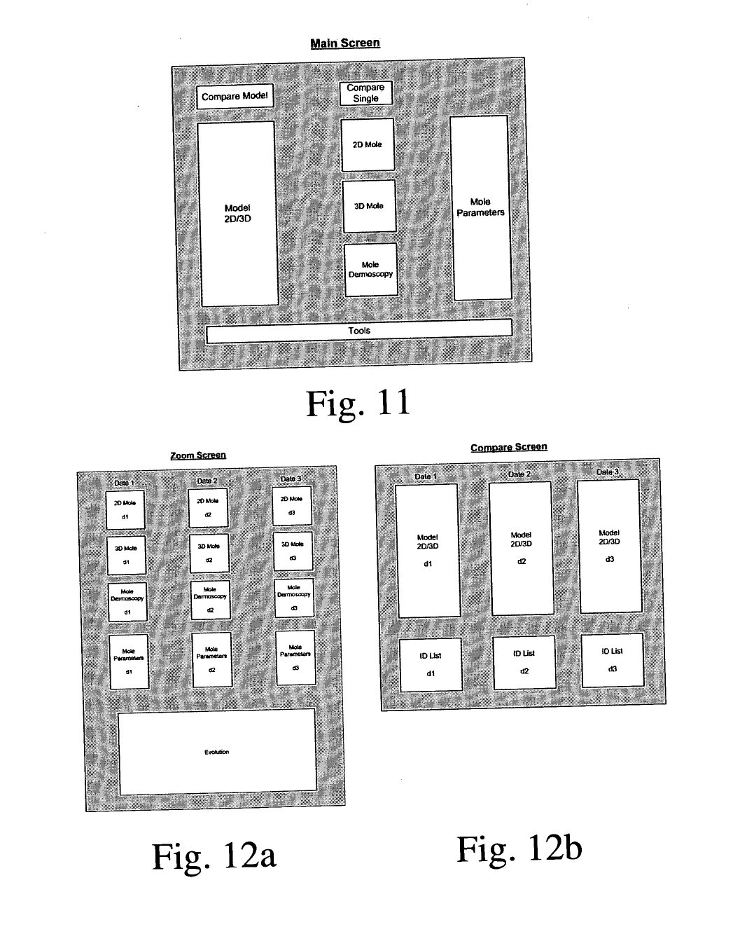

FIG. 10 schematically describes one embodiment of the method according to which the system of the present invention is operated. According to this figure, in block 310, a set of images is provided to the system via the sensor images 40. In block 320, the set of images is pre-processed, and in block 330 the suspected moles are mapped. In block 340, the predetermined characteristics of the moles are extracted via the steps of blocks 350. According to blocks 350, a 2D and a 3D analysis is performed. In block 360, the same human body analyzed in different points of time can be compared, and a result may be provided to the operator and/or the patient.

According to another embodiment of the present invention the system additionally comprises a learning module adapted to provide analysis of a current data based upon history analysis of previous data.

According to another embodiment of the present invention the system additionally comprises a learning module adapted to provide analysis of a current data based upon history analysis of previous data and/or observations (namely input from a physician).

In FIGS. 11 and 12a-b illustrated different examples of screen shots which may be presented to the operator of the system of the present invention. These screens are parts of the software component 160 described above. In FIG. 11 illustrated one embodiment of the main screen of the present invention. According to this figure, various options are provided to the operator for analyzing detected moles and comparing the same along different periods of time. In FIGS. 12a-b a zoom screen and a compare screen are illustrated.

According to another embodiment of the present invention, the system comprises a moving mechanism couple to at least one of said image sensors, adapted to move said image sensors from one potion to another within said base.

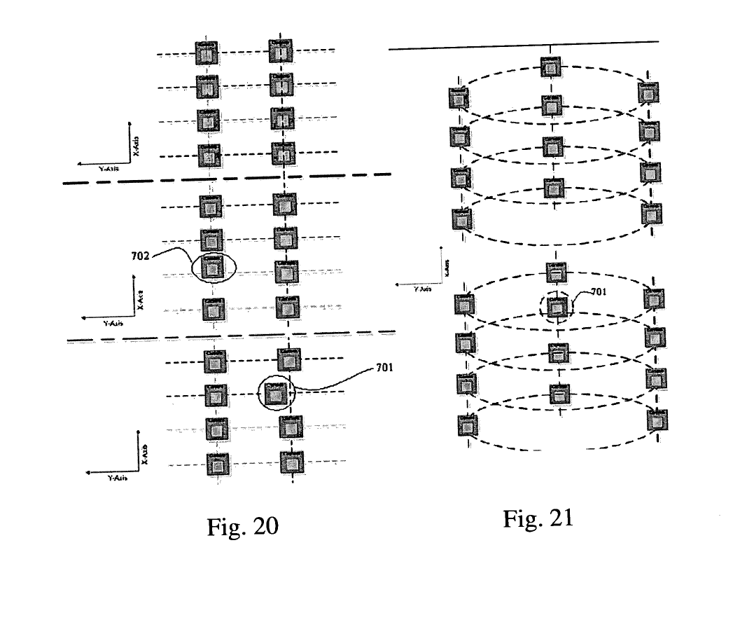

Reference is now made to FIGS. 20-22 which illustrates said embodiment.

FIG. 20 illustrates and embodiment in which image sensor 701 is relocated/shifted from it original position towards the left side (along the y-axis) and image sensor 702 is relocated/shifted from it original position upwards (along the x-axis).

FIG. 21 illustrates a base having an ellipsoidal shape. Again, as demonstrated in the previous figure, image sensor 701 is relocated/shifted from it original position upwards (along the x-axis).

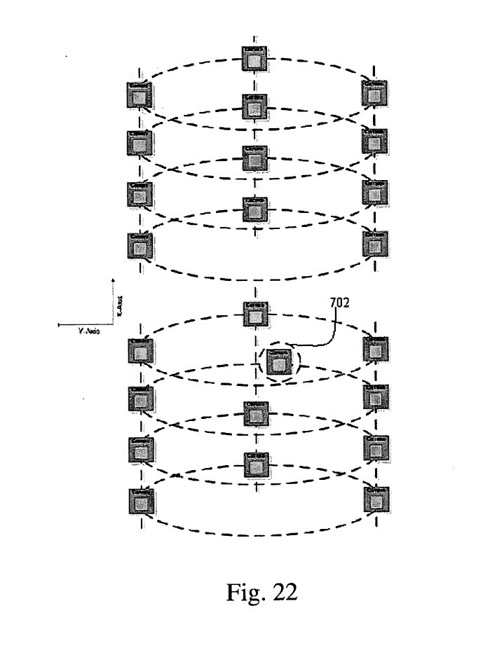

FIG. 22 illustrates a base having an ellipsoidal shape. Again, as demonstrated in the previous figure, image sensor 702 is relocated/shifted from it original position to the left side (along the y-axis).

According to another embodiment of the present invention at least one of the image sensors is adapted to rotate around said image sensor's main axis.

According to another embodiment of the present invention at least one of said image sensor comprises at least one marker.

According to another embodiment of the present invention, the desired areas on the patient's body are marked so as to signal at least one of the image sensors where is e.g., the desired area to focus on.

Hence, it is within the scope of the present invention to provide a skin surface imaging system for capturing at least one image of the skin of a patient's body, comprising:
a. at least one base;
b. a plurality of image sensors, connectable to said base, arranged in a predetermined arrangement; each of said image sensors adapted to capture at least one image of a predetermined area of said body, so that as a set of images is provided; and,
c. a processing unit communicatable with said image sensors, said processing unit comprising a program of machine-readable instructions embodied on a computer readable memory and executable by a digital data processor adapted to: (i) collect said set of images from said image sensors; (ii) analyze said set of images; (iii) construct a record of personal data associated with the skin of said body of said patient; and (iv) output a dermatological data associated with said skin of said body;
   wherein at least one of said image sensors is jointly connectable to said base by means of at least one joint, such that the orientation of said at least one of said image sensors with respect to said base is controllable and reconfigurable.

The joint can be any joint available and known in the art.

According to another embodiment, the at least one of said image sensors is jointly connectable to said base via a restricting sensor and controlling mechanism, such that said at least one image sensor is movable in at least one selected from group consisting of the sagittal plane, the coronal plane or the transverse plane, upwards, downwards, left, right or any combination thereof.

According to another embodiment, the restricting sensor is adapted to regulate the movement of said at least one image sensor.

According to another embodiment, the controlling mechanism is either electronically operatable by said processing unit or manually operatable by an operator.

According to another embodiment, the controlling mechanism is adapted to control the distance between at least one of said image sensors and said body. The distance control is especially important due to the different sizes/dimensions of patients (thin patients, thick patients et cetera).

According to another embodiment, the controlling mechanism is adapted to control the distance in said orientation between at least one of said image sensors and said body. According to this embodiment, the image sensor is maintained at a predetermined orientation and the distance between the same and the base is altered.

According to another embodiment, the controlling mechanism is adapted to control the location of at least one of said image sensors in said base. According to this embodiment the image sensor are enabled to re-position their location within the base.

According to another embodiment, the base is characterized by a main longitudinal axis, such that the controlling mechanism controls the location of at least one of said image sensors along said main longitudinal axis in said base.

According to another embodiment, the control of said distance is performed according to the dimensions of said body. According to this embodiment the system comprises image sensors (either stills camera or a video camera) which are adapted to provide information (via, e.g., image processing unit) as for the damnation of the patient.

According to another embodiment, the system additionally comprising a dedicated sensor adapted to provide information as for the dimensions of said body, such that said control of said distance is performed according to the dimensions of said body.

According to another embodiment, the said image sensors are selected from the group consisting of: visible light sensors, ultraviolet (UV) light sensors, infrared (IR) sensors, and any combination thereof.

According to another embodiment, the predetermined arrangement is characterized by n arrays locatable at angle of (360/n)° between each other with respect to said body or said base, each of said n arrays comprises m image sensors; n is an integer greater than or equals to 1; m is an integer greater than or equals to 1.

According to another embodiment, each of said n arrays comprises o parallel columns of said image sensors; o is an integer greater than or equals to 1.

According to another embodiment, n is at least 4 and o is at least 2.

According to another embodiment, the predetermined arrangement characterized by n arrays, each of said n arrays comprises m image sensors; n is an integer greater than or equals to 1; m is an integer greater than or equals to 1.

According to another embodiment, each of said n arrays comprises o parallel columns of said image sensors; o is an integer greater than or equals to 1.

According to another embodiment, each of said n arrays comprises o image sensors; wherein said o image sensors are positioned within each of said n arrays in a predetermined manner; o is an integer greater than or equals to 1.

According to another embodiment, the predetermined manner is selected from a group consisting of homogeneous, non-homogeneous, aligned, non-aligned, spherical, triangular, cylindrical, cubic, spiral, randomly spaced, arbitrary, polygon having p ribs; p is greater than 1; and any combination thereof.

According to another embodiment, the system additionally comprising means adapted to relocate said base from a first position to a second position.

According to another embodiment, the processing unit is adapted to control the on/off mode of at least one of said image sensors.

According to another embodiment, said set of images of comprises at least 2 images of overlapping predetermined areas of said body.

According to another embodiment, the predetermined arrangement is selected from the group consisting of: homogeneous, non-homogeneous, aligned, non-aligned, spherical, cylindrical, cubic, spiral, randomly spaced, arbitrary, and any combination thereof.

According to another embodiment, the orientation is an angle between at least one of said image sensors and said body or said base, said angle is in the range of about 1° to about 179°.

According to another embodiment, the dermatological data is selected from a group consisting of: suspected moles, the boundaries of suspected moles, tissue encircling said suspected moles nevus, tattoos, scars, moles, spots, wounds, and any combination thereof.

According to another embodiment, the processing unit comprises an image processing algorithm adapted to detect the existence of said suspected moles and to characterize each mole according to predetermined characteristics.

According to another embodiment, the image processing algorithm is further adapted to perform operation selected from the group consisting of: locate the borders of said suspected moles, distinguish between a suspected mole and a wound according to a pattern recognition algorithm, and any combination thereof.

According to another embodiment, the processing unit is adapted to store said predetermined characteristics of each of said suspected moles.

According to another embodiment, the predetermined characteristics are selected from the group consisting of: location, coordinates of border, asymmetry measurement, planar measurements, 2D structure, 3D structure, topography, height, radius, color, and any combination thereof.

According to another embodiment, the processing unit is adapted to provide the history of each suspected mole and to provide comparison and changes between the current predetermined characteristics of said suspected moles and at least one previous predetermined characteristics of said suspected moles.

According to another embodiment, the processing unit is adapted to detect said suspected moles by analyzing 2D and 3D images of said suspected moles.

According to another embodiment, the base is part of a structure selected from the group consisting of: a booth, a kiosk, a cabin, a private enclosure, and any combination thereof.

According to another embodiment, the processing unit is adapted to control the operation of said image sensors; said operation is selected from the orientation of at least one of said image sensors; the distance between at least one of said image sensors and said body, on/off mode of at least one of said image sensors.

According to another embodiment, the processing unit is adapted to operate said image sensors in a synchronized manner, such that a synchronized image of the skin of said body is provided.

According to another embodiment, the synchronized manner is operation of a portion of at least one of said image sensors.

Another example of synchronized operation is the operation of at least one group of image sensors, followed by the operation of a different group; e.g., (i) the operation of the odd numbered image sensors followed by the operation of the even numbered image sensors; (ii) the operation of all image sensors located in front of the patient, followed by the operation of the image sensors located in the back of the patient.

According to another embodiment, the image sensors are operated simultaneously.

According to another embodiment, the system further comprising a hair removal mechanism adapted to eliminate the influence of human hair on the data of said personal data.

According to another embodiment, the processing unit further comprises a feedback mechanism, said feedback mechanism comprises: (i) an analyzing unit adapted to score said dermatological data according to a predetermined scale, so that abnormal dermatological data is detected; and (ii) a regulating unit adapted to operate said processing unit in a repeated manner when said score is higher than a predetermined value.

According to another embodiment, the predetermined scale is adapted to rank parameters selected from the group consisting of: said predetermined characteristics, quality of said images; said quality is selected from a group consisting of color, contrast, blurred, out of focus, lightness, and any combination thereof.

According to another embodiment, the feedback mechanism further adapted to control the orientation of at least one of said image sensors, the position of said patient, the distance between at least one of said image sensors and said patient.

According to another embodiment, the system further comprising a data storage unit adapted to store said personal data on a portable safe memory card.

According to another embodiment, the personal data selected from the group consisting of: a dermatological data, scan results, set of images, a skin map, the full body photography, a 2D body model, a 3D body model, a 2D analysis, a 3D analysis, dates, patient personal information selected from a group consisting of name, height, weight, size, gender, id, password, family, family history, and any combination thereof, or any combination thereof.

According to another embodiment, the processing unit is adapted to analyze said set of images based upon previous analyzes. According to this embodiment the system is a learning system which analyzes the present data according to (i) already known data; (ii) to previous analysis or any combination thereof.

According to another embodiment, the processing unit further comprises an operation unit adapted to allow an operator to perform operation selected from the group consisting of: analyze said personal data; analyze said set of images; analyze said dermatological data; determine said dermatological data, edit said dermatological data, and any combination thereof.

According to another embodiment, the operation unit is further adapted to perform operations selected from the group consisting of: provide zoom-in to a predetermined area of a skin map, operate said feedback mechanism, maipulate said personal data, provide a 2D plot of a predetermined area of a skin map according to at least one image of said set of images, provide a 3D plot of a predetermined area of a skin map, provide a 2D plot of a predetermined area of a skin map by performing a 2D projection on said 3D plot, mark a predetermined area of a skin map, and any combination thereof.

According to another embodiment, the dermatological data is associated with the evolution and the severity of melanoma of a predetermined area on said body. According to this embodiment, the system perform an analysis of the suspected moles (by analyzing the delta in the mole characteristics, e.g., if there has been color changes et cetera); and once the analysis is performed, the system may inform the physician that the specific mole is suspicious melanoma. Furthermore, the system may indicate as for the severity of melanoma.

According to another embodiment, the processing unit is further adapted to identify said patient according to parameters selected from the group consisting of: name, height, weight, size, gender, id, password, family, family history, and any combination thereof.

According to another embodiment, the system further comprising a rotatable pod stand adapted to rotate said body with respect to said image sensor.

According to another embodiment, the system additionally comprising a body positioning sub-unit adapted to: provide instructions regarding the position of a patient with respect to said image sensors; and to stabilize the position of said patient with respect to said image sensors.

According to another embodiment, the image sensors are positioned in a homogeneous grid of sensors.

According to another embodiment, the image sensors is selected from a group consisting of stills camera, video camera or any combination thereof.

The present invention also provides an imaging system for capturing at least one image of the skin of a patient's body, comprising:
a. a base;
b. a plurality of image sensors, connectable to said base, arranged in a predetermined arrangement; each of said image sensors adapted to capture at least one image of a predetermined area of said body, so that as a set of images is provided; and,
c. a processing unit communicatable with said image sensors, said processing unit comprising a program of machine-readable instructions embodied on a computer readable memory and executable by a digital data processor adapted to: (i) collect said set of images from said image sensors; (ii) analyze said set of images; (iii) construct a skin map associated with the skin geometry of said body; and (iv) output a dermatological data associated with said skin of said body;
wherein at least one of said image sensors is connectable to said base such that the distance between at least one of said image sensors and said base or said body is controllable and alterable.

According to another embodiment, the at least one of image sensor is jointly connectable to said base via a restricting sensor and controlling mechanism, such that said at least one image sensor is movable in at least one selected from group consisting of the sagittal plane, the coronal plane or the transverse plane, upwards, downwards, left, right or any combination thereof.

According to another embodiment, the restricting sensor is adapted to regulate the movement of said at least one image sensor.

According to another embodiment, the controlling mechanism is either electronically operatable by said processing unit or manually operatable by an operator.

According to another embodiment, the at least one of said image sensors is jointly connectable to said base by means of at least one joint, such that the orientation of said at least one of said image sensors with respect to said base is controllable and reconfigurable

According to another embodiment, the controlling mechanism is adapted to control the distance in said orientation between at least one of said image sensors and said body.

According to another embodiment, the controlling mechanism is adapted to control the location of at least one of said image sensors in said base.

The imaging system as defined above, wherein said base is characterized by a main longitudinal axis; further wherein said controlling mechanism is adapted to control the location of at least one of said image sensors along said main longitudinal axis in said base.

According to another embodiment, the control of said distance is performed according to the dimensions of said body.

According to another embodiment, the system additionally comprising a sensor adapted to provide information as for the dimensions of said body, such that said control of said distance is performed according to the dimensions of said body.

According to another embodiment, the image sensors are selected from the group consisting of: visible light sensors, ultraviolet (UV) light sensors, infrared (IR) sensors, and any combination thereof.

According to another embodiment, the predetermined arrangement characterized by n arrays locatable at angle of (360/n)° between each other with respect to said body or said base, each of said n arrays comprises m image sensors; n is an integer greater than or equals to 1; m is an integer greater than or equals to 1.

According to another embodiment, each of said n arrays comprises o parallel columns of said image sensors; o is an integer greater than or equals to 1.

According to another embodiment, n is at least 4 and o is at least 2.

According to another embodiment, the predetermined arrangement characterized by n arrays, each of said n arrays comprises m image sensors; n is an integer greater than or equals to 1; m is an integer greater than or equals to 1.

According to another embodiment, each of said n arrays comprises o parallel columns of said image sensors; o is an integer greater than or equals to 1.

According to another embodiment, each of said n arrays comprises o image sensors; wherein said o image sensors are positioned within each of said n arrays in a predetermined manner; o is an integer greater than or equals to 1.

According to another embodiment, the predetermined manner is selected from a group consisting of homogeneous, non-homogeneous, aligned, non-aligned, spherical, triangular, cylindrical, cubic, spiral, randomly spaced, arbitrary, polygon having p ribs; p is greater than 1; and any combination thereof.

According to another embodiment, the system additionally comprising means adapted to relocate said base from a first position to a second position.

According to another embodiment, the processing unit is adapted to control the on/off mode of at least one of said image sensors.

According to another embodiment, said set of images of comprises at least 2 images of overlapping predetermined areas of said body.

According to another embodiment, the predetermined arrangement is selected from the group consisting of: homogeneous, non-homogeneous, aligned, non-aligned, spherical, cylindrical, cubic, spiral, randomly spaced, arbitrary, and any combination thereof.

According to another embodiment, the orientation is an angle between at least one of said image sensors and said body or said base, said angle is in the range of about 1° to about 179°.

According to another embodiment, the dermatological data is selected from a group consisting of: suspected moles, the boundaries of suspected moles, tissue encircling said suspected moles nevus, tattoos, scars, moles, spots, wounds, and any combination thereof.

According to another embodiment, the processing unit comprises an image processing algorithm adapted to detect the existence of said suspected moles and to characterize each mole according to predetermined characteristics.

According to another embodiment, the image processing algorithm is further adapted to perform operation selected from the group consisting of: locate the borders of said suspected moles, distinguish between a suspected mole and a wound according to a pattern recognition algorithm, and any combination thereof.

According to another embodiment, the processing unit is adapted to store said predetermined characteristics of each of said suspected moles.

According to another embodiment, the predetermined characteristics are selected from the group consisting of: location, coordinates of border, asymmetry measurement, planar measurements, 2D structure, 3D structure, topography, height, radius, color, and any combination thereof.

According to another embodiment, the processing unit is adapted to provide the history of each suspected mole and to provide comparison and changes between the current predetermined characteristics of said suspected moles and at least one previous predetermined characteristics of said suspected moles.

According to another embodiment, the processing unit is adapted to detect said suspected moles by analyzing 2D and 3D images of said suspected moles.

According to another embodiment, the base is part of a structure selected from the group consisting of: a booth, a kiosk, a cabin, a private enclosure, and any combination thereof.

According to another embodiment, the processing unit is adapted to control the operation of said image sensors; said operation is selected from the orientation of at least one of said image sensors; the distance between at least one of said image sensors and said body, on/off mode of at least one of said image sensors.

According to another embodiment, the processing unit is adapted to operate said image sensors in a synchronized manner, such that a synchronized image of the skin of said body is provided.

According to another embodiment, the synchronized manner is operation of a portion of at least one of said image sensors.

According to another embodiment, said synchronized manner, said at least two of said image sensors are operated simultaneously.

According to another embodiment, the system further comprising a hair removal mechanism adapted to eliminate the influence of human hair on the data of said personal data.

According to another embodiment, the processing unit further comprises a feedback mechanism, said feedback mechanism comprises: (i) an analyzing unit adapted to score said dermatological data according to a predetermined scale, so that abnormal dermatological data is detected; and (ii) a regulating unit adapted to operate said processing unit in a repeated manner when said score is higher than a predetermined value.

According to another embodiment, the predetermined scale is adapted to rank parameters selected from the group consisting of: said predetermined characteristics, quality of said images; said quality is selected from a group consisting of color, contrast, blurred, out of focus, lightness, and any combination thereof.

According to another embodiment, the feedback mechanism further adapted to control the orientation of at least one of said image sensors, the position of said patient, the distance between at least one of said image sensors and said patient.

According to another embodiment, the system further comprising a data storage unit adapted to store said personal data on a portable safe memory card.

According to another embodiment, the personal data selected from the group consisting of: a dermatological data, scan results, set of images, a skin map, the full body photography, a 2D body model, a 3D body model, a 2D analysis, a 3D analysis, dates, patient personal information selected from a group consisting of name, height, weight, size, gender, id, password, family, family history, and any combination thereof, or any combination thereof.

According to another embodiment, the processing unit is adapted to analyze said set of images based upon previous analyzes.

According to another embodiment, the processing unit further comprises an operation unit adapted to allow an operator to perform operation selected from the group consisting of: analyze said personal data; analyze said set of images; analyze said dermatological data; determine said dermatological data, edit said dermatological data, and any combination thereof.

According to another embodiment, the operation unit is further adapted to perform operations selected from the group consisting of: provide zoom-in to a predetermined area of a skin map, operate said feedback mechanism, maipulate said personal data, provide a 2D plot of a predetermined area of a skin map according to at least one image of said set of images, provide a 3D plot of a predetermined area of a skin map, provide a 2D plot of a predetermined area of a skin map by performing a 2D projection on said 3D plot, mark a predetermined area of a skin map, and any combination thereof.

According to another embodiment, the dermatological data is associated with the evolution and the severity of melanoma of a predetermined area on said body.

According to another embodiment, the processing unit is further adapted to identify said patient according to parameters selected from the group consisting of: name, height, weight, size, gender, id, password, family, family history, and any combination thereof.

According to another embodiment, the system further comprising a rotatable pod stand adapted to rotate said body with respect to said image sensor.

According to another embodiment, the system further comprising a body positioning sub-unit adapted to: provide instructions regarding the position of a patient with respect to said image sensors; and to stabilize the position of said patient with respect to said image sensors.

According to another embodiment, the image sensors are positioned in a homogeneous grid of sensors.

According to another embodiment, the image sensors is selected from a group consisting of stills camera, video camera or any combination thereof.

It is another object of the present invention to provide a booth for capturing at least one image of the skin of a patient's human body, comprising:
a. a pod stand upon which said patient is adapted to stand;
b. an envelope adapted to surround said patient;
c. a plurality of image sensors, arranged in a predetermined arrangement between said envelope and said patient; each of said image sensors adapted to capture at least one image of a predetermined area of said human body, so that as a set of images is provided;
d. a processing unit communicatable with said image sensors, said processing unit comprising a program of machine-readable instructions embodied on a computer readable memory and executable by a digital data processor adapted to: (i) collect said set of images from said image sensors; (ii) analyze said set of images; (iii) construct a skin map associated with the skin geometry of said human body; and (iv) output a dermatological data associated with said skin of said human body;
wherein at least one of said image sensors is jointly connectable to said base by means of at least one joint, such that the orientation of said at least one of said image sensors with respect to said base is controllable and reconfigurable.

According to another embodiment, at least one of said image sensors is jointly connectable to said base via a restricting sensor and controlling mechanism, such that said at least one image sensor is movable in at least one selected from group consisting of the sagittal plane, the coronal plane or the transverse plane, upwards, downwards, left, right or any combination thereof.

According to another embodiment, the restricting sensor is adapted to regulate the movement of said at least one image sensor.

According to another embodiment, the controlling mechanism is either electronically operatable by said processing unit or manually operatable by an operator.

According to another embodiment, the controlling mechanism is adapted to control the distance between at least one of said image sensors and said body.

According to another embodiment, the controlling mechanism is adapted to control the distance in said orientation between at least one of said image sensors and said body.

According to another embodiment, the controlling mechanism is adapted to control the location of at least one of said image sensors in said base.

According to another embodiment, the base is characterized by a main longitudinal axis; further wherein said controlling mechanism is adapted to control the location of at least one of said image sensors along said main longitudinal axis in said base.

According to another embodiment, the control of said distance is performed according to the dimensions of said body.

According to another embodiment, the system additionally comprising a sensor adapted to provide information as for the dimensions of said body, such that said control of said distance is performed according to the dimensions of said body.

According to another embodiment, the image sensors are selected from the group consisting of: visible light sensors, ultraviolet (UV) light sensors, infrared (IR) sensors, and any combination thereof.

According to another embodiment, the predetermined arrangement characterized by n arrays locatable at angle of (360/n)° between each other with respect to said body or said base, each of said n arrays comprises m image sensors; n is an integer greater than or equals to 1; m is an integer greater than or equals to 1.

According to another embodiment, each of said n arrays comprises o parallel columns of said image sensors; o is an integer greater than or equals to 1.

According to another embodiment, n is at least 4 and o is at least 2.

According to another embodiment, the predetermined arrangement characterized by n arrays, each of said n arrays comprises m image sensors; n is an integer greater than or equals to 1; m is an integer greater than or equals to 1.

According to another embodiment, each of said n arrays comprises o parallel columns of said image sensors; o is an integer greater than or equals to 1.

According to another embodiment, each of said n arrays comprises o image sensors; wherein said o image sensors are positioned within each of said n arrays in a predetermined manner; o is an integer greater than or equals to 1.

According to another embodiment, the predetermined manner is selected from a group consisting of homogeneous, non-homogeneous, aligned, non-aligned, spherical, triangular, cylindrical, cubic, spiral, randomly spaced, arbitrary, polygon having p ribs; p is greater than 1; and any combination thereof.

According to another embodiment, the system additionally comprising means adapted to relocate said base from a first position to a second position.

According to another embodiment, the processing unit is adapted to control the on/off mode of at least one of said image sensors.

According to another embodiment, the set of images of comprises at least 2 images of overlapping predetermined areas of said body.

According to another embodiment, the predetermined arrangement is selected from the group consisting of: homogeneous, non-homogeneous, aligned, non-aligned, spherical, cylindrical, cubic, spiral, randomly spaced, arbitrary, and any combination thereof.

According to another embodiment, the orientation is an angle between at least one of said image sensors and said body or said base, said angle is in the range of about 1° to about 179°.

According to another embodiment, the dermatological data is selected from a group consisting of: suspected moles, the boundaries of suspected moles, tissue encircling said suspected moles nevus, tattoos, scars, moles, spots, wounds, and any combination thereof.

According to another embodiment, the processing unit comprises an image processing algorithm adapted to detect the existence of said suspected moles and to characterize each mole according to predetermined characteristics.

According to another embodiment, the image processing algorithm is further adapted to perform operation selected from the group consisting of: locate the borders of said suspected moles, distinguish between a suspected mole and a wound according to a pattern recognition algorithm, and any combination thereof.

According to another embodiment, the processing unit is adapted to store said predetermined characteristics of each of said suspected moles.

According to another embodiment, the predetermined characteristics are selected from the group consisting of: location, coordinates of border, asymmetry measurement, planar measurements, 2D structure, 3D structure, topography, height, radius, color, and any combination thereof.

According to another embodiment, the processing unit is adapted to provide the history of each suspected mole and to provide comparison and changes between the current predetermined characteristics of said suspected moles and at least one previous predetermined characteristics of said suspected moles.

According to another embodiment, the processing unit is adapted to detect said suspected moles by analyzing 2D and 3D images of said suspected moles.

According to another embodiment, the base is part of a structure selected from the group consisting of: a booth, a kiosk, a cabin, a private enclosure, and any combination thereof.

According to another embodiment, the processing unit is adapted to control the operation of said image sensors; said operation is selected from the orientation of at least one of said image sensors; the distance between at least one of said image sensors and said body, on/off mode of at least one of said image sensors.

According to another embodiment, the processing unit is adapted to operate said image sensors in a synchronized manner, such that a synchronized image of the skin of said body is provided.

According to another embodiment, the synchronized manner is operation of a portion of at least one of said image sensors.

According to another embodiment, the synchronized manner, said at least two of said image sensors are operated simultaneously.

According to another embodiment, the system further comprising a hair removal mechanism adapted to eliminate the influence of human hair on the data of said personal data.

According to another embodiment, the processing unit further comprises a feedback mechanism, said feedback mechanism comprises: (i) an analyzing unit adapted to score said dermatological data according to a predetermined scale, so that abnormal dermatological data is detected; and (ii) a regulating unit adapted to operate said processing unit in a repeated manner when said score is higher than a predetermined value.

According to another embodiment, the predetermined scale is adapted to rank parameters selected from the group consisting of: said predetermined characteristics, quality of said images; said quality is selected from a group consisting of color, contrast, blurred, out of focus, lightness, and any combination thereof.

According to another embodiment, the feedback mechanism further adapted to control the orientation of at least one of said image sensors, the position of said patient, the distance between at least one of said image sensors and said patient.

According to another embodiment, the system further comprising a data storage unit adapted to store said personal data on a portable safe memory card.

According to another embodiment, the personal data selected from the group consisting of: a dermatological data, scan results, set of images, a skin map, the full body photography, a 2D body model, a 3D body model, a 2D analysis, a 3D analysis, dates, patient personal information selected from a group consisting of name, height, weight, size, gender, id, password, family, family history, and any combination thereof, or any combination thereof.

According to another embodiment, the processing unit is adapted to analyze said set of images based upon previous analyzes.

According to another embodiment, the processing unit further comprises an operation unit adapted to allow an operator to perform operation selected from the group consisting of: analyze said personal data; analyze said set of images; analyze said dermatological data; determine said dermatological data, edit said dermatological data, and any combination thereof.

According to another embodiment, the operation unit is further adapted to perform operations selected from the group consisting of: provide zoom-in to a predetermined area of a skin map, operate said feedback mechanism, maipulate said personal data, provide a 2D plot of a predetermined area of a skin map according to at least one image of said set of images, provide a 3D plot of a predetermined area of a skin map, provide a 2D plot of a predetermined area of a skin map by performing a 2D projection on said 3D plot, mark a predetermined area of a skin map, and any combination thereof.

According to another embodiment, the dermatological data is associated with the evolution and the severity of melanoma of a predetermined area on said body.

According to another embodiment, the processing unit is further adapted to identify said patient according to parameters selected from the group consisting of: name, height, weight, size, gender, id, password, family, family history, and any combination thereof.

According to another embodiment, the system further comprising a rotatable pod stand adapted to rotate said body with respect to said image sensor.

According to another embodiment, the system further comprising a body positioning sub-unit adapted to: provide instructions regarding the position of a patient with respect to said image sensors; and to stabilize the position of said patient with respect to said image sensors.

According to another embodiment, the image sensors are positioned in a homogeneous grid of sensors.

According to another embodiment, the image sensors is selected from a group consisting of stills camera, video camera or any combination thereof.

It another object of the present invention to provide a method for capturing at least one image of the skin of a patient's human body, comprising steps of:
a. providing a skin surface imaging system, comprising: (i) a base; a plurality of image sensors, connectable to said base, arranged in a predetermined arrangement; and, (iii) a processing unit communicatable with said image sensors;
b. capturing at least one image of a predetermined area of said body via said image sensors, thereby providing a set of images;
c. collecting said set of images from said image sensors via said processing unit;
d. analyzing said set of images via said processing unit;
e. constructing via said processing unit a record of a personal data associated with the skin geometry of said human body; and,
f. outputting a dermatological data associated with said skin of said human body;
wherein said method further comprises a step of providing said at least one of said image sensors with a joint connection to said base, thereby controlling the orientation of at least one of said image sensors with respect to said base.

It another object of the present invention to provide the method as defined above, further comprising step of providing a sensor holding and controlling mechanism, wherein said at least one of said image sensors is jointly connectable to said base via said sensor holding and controlling mechanism.

It another object of the present invention to provide the method as defined above, further comprising step of electrically operating said controlling mechanism by said processing unit.

It another object of the present invention to provide the method as defined above, further comprising step of manually operating said controlling mechanism by an operator.

It another object of the present invention to provide the method as defined above, further comprising a step of controlling the distance between at least one of said image sensors and said body via said holding and controlling mechanism.

It another object of the present invention to provide the method as defined above, wherein said control of said distance is performed via said controlling mechanism according to the dimensions of said human body.

It another object of the present invention to provide the method as defined above, further comprising a step of selecting said image sensors from the group consisting of: visible light sensors, ultraviolet (UV) light sensors, infrared (IR) sensors, and any combination thereof.

It another object of the present invention to provide the method as defined above, wherein said predetermined arrangement characterized by n arrays locatable at angle of (360/n)° between each other with respect to said body or said base, each of said n arrays comprises m image sensors; n is an integer greater than or equals to 1; m is an integer greater than or equals to 1.

It another object of the present invention to provide the method as defined above, wherein each of said n arrays comprises o parallel columns of said image sensors; o is an integer greater than or equals to 1.

It another object of the present invention to provide the method as defined above, wherein n is 4 and o is 2.

It another object of the present invention to provide the method as defined above, wherein said set of images of comprises images of overlapping predetermined areas of said human body.

It another object of the present invention to provide the method as defined above, further comprising a step of providing said predetermined arrangement selected from the group consisting of: homogeneous, non-homogeneous, aligned, non-aligned, spherical, cylindrical, cubic, spiral, randomly spaced, arbitrary, and any combination thereof.

It another object of the present invention to provide the method as defined above, wherein said orientation is an angle between at least one of said image sensors and said body or said base, said angle is in the range of about 1° to about 179°.

It another object of the present invention to provide the method as defined above, further comprising a step of selecting said dermatological data from a group consisting of: suspected moles, nevus, tattoos, scars, moles, spots, wounds, and any combination thereof.

It another object of the present invention to provide the method as defined above, wherein said dermatological data comprises predetermined characteristics of suspected moles; said processing unit comprises an image processing algorithm adapted to detect the existence of said suspected moles and to characterize each mole according to said predetermined characteristics.

It another object of the present invention to provide the method as defined above, further comprising a step of performing via said image processing algorithm an operation selected from the group consisting of: locate the borders of said suspected moles, distinguish between a suspected mole and a wound according to a pattern recognition algorithm, and any combination thereof.

It another object of the present invention to provide the method as defined above, further comprising a step of storing said predetermined characteristics of each of said suspected moles via said processing unit.

It another object of the present invention to provide the method as defined above, further comprising a step of selecting said predetermined characteristics are selected from the group consisting of: location, coordinates of border, asymmetry measurement, planar measurements, 3D structure, topography, height, radius, color, and any combination thereof.

It another object of the present invention to provide the method as defined above, further comprising steps of providing the history of each suspected mole via said processing unit; and providing comparison and changes between the current and the previous predetermined characteristics of said suspected moles via said processing unit.

It another object of the present invention to provide the method as defined above, further comprising a step of detecting said suspected moles by analyzing 2D and 3D images of said suspected moles via said processing unit.

It another object of the present invention to provide the method as defined above, further comprising step of providing said base as part of a structure selected from the group consisting of: a booth, a kiosk, a cabin, a private enclosure, and any combination thereof.

It another object of the present invention to provide the method as defined above, further comprising a step of controlling the operation of said image sensors via said processing unit.

It another object of the present invention to provide the method as defined above, further comprising a step of operating said image sensors via said processing unit in a synchronized manner, such that a synchronized image of the skin of said body is provided.

It another object of the present invention to provide the method as defined above, wherein in said synchronized manner, said image sensors are operated simultaneously.

It another object of the present invention to provide the method as defined above, further comprising a step of eliminating the influence of human hair on the data of said skin map via a hair removal mechanism.

It another object of the present invention to provide the method as defined above, further comprising a step of performing feedback via a feedback mechanism locatable within said processing unit, said feedback mechanism comprises: (i) an analyzing unit adapted to score said dermatological data according to a predetermined scale, so that abnormal dermatological data is detected; and (ii) a regulating unit adapted to operate said processing unit in a repeated manner when said score is higher than a predetermined value.

It another object of the present invention to provide the method as defined above, wherein said predetermined scale is adapted to rank parameters selected from the group consisting of: said predetermined characteristics, quality of said images, and any combination thereof.

It another object of the present invention to provide the method as defined above, further comprising a step of controlling the orientation of at least one of said image sensors via said feedback mechanism.

It another object of the present invention to provide the method as defined above, further comprising a step of storing said personal data on a safe memory card connectable to a data storage unit.

It another object of the present invention to provide the method as defined above, further comprising a step of selecting said personal data from the group consisting of: a dermatological data, scan results, set of images, a skin map, the full body photography, a 2D body model, a 3D body model, a 2D analysis, a 3D analysis, dates, patient personal information selected from a group consisting of name, height, weight, size, gender, id, password, family, family history, and any combination thereof, or any combination thereof.

It another object of the present invention to provide the method as defined above, further comprising a step of allowing an operator to perform via an operating unit operations selected from the group consisting of: analyzing said personal data; analyzing said set of images; analyzing said dermatological data; determining said dermatological data, editing said dermatological data, and any combination thereof.

It another object of the present invention to provide the method as defined above, further comprising a step of performing via said operating unit operations selected from the group consisting of: providing zoom-in to a predetermined area of a skin map, operating said feedback mechanism, manipulating said personal data, providing a 2D plot of a predetermined area of a skin map according to at least one image of said set of images, providing a 3D plot of a predetermined area of a skin map, providing a 2D plot of a predetermined area of a skin map by performing a 2D projection on said 3D plot, marking a predetermined area of a skin map, and any combination thereof.

It another object of the present invention to provide the method as defined above, wherein said dermatological data is associated with the evolution and the severity of melanoma of a predetermined area on said human body.

It another object of the present invention to provide the method as defined above, further comprising a step of identifying via said processing unit said patient according to parameters selected from the group consisting of: name, height, weight, size, gender, id, password, and any combination thereof.

It another object of the present invention to provide the method as defined above, further comprising a step of further rotating said human body with respect to said image sensor on a rotatable pod stand.

It another object of the present invention to provide the method as defined above, further comprising steps of: providing a body positioning sub-unit; providing instructions regarding the position of a patient with respect to said image sensors; and stabilizing the position of said patient with respect to said image sensors.

It another object of the present invention to provide the method as defined above, further comprising a step of providing said image sensors in a homogeneous grid of sensors.

It another object of the present invention to provide s method for capturing at least one image of the skin of a patient's human body, comprising steps of:
a. providing a skin surface imaging system, comprising: (i) a base; a plurality of image sensors, connectable to said base, arranged in a predetermined arrangement; and, (iii) a processing unit communicatable with said image sensors;
b. capturing at least one image of a predetermined area of said human body via said image sensors, thereby providing a set of images;
c. collecting said set of images from said image sensors via said processing unit;
d. analyzing said set of images via said processing unit;
e. constructing via said processing unit a record of a personal data associated with the skin geometry of said human body; and,
f. outputting a dermatological data associated with said skin of said human body;
wherein said method further comprises a step of providing said at least one of said image sensors connected to said base, thereby controlling the distance between at least one of said image sensors and said base or said human body.

It another object of the present invention to provide the method as defined above, further comprising step of providing a sensor holding and controlling mechanism, wherein said at least one of said image sensors is jointly connectable to said base via said sensor holding and controlling mechanism.

It another object of the present invention to provide the method as defined above, further comprising step of electrically operating said controlling mechanism by said processing unit.

It another object of the present invention to provide the method as defined above, further comprising step of manually operating said controlling mechanism by an operator.

It another object of the present invention to provide the method as defined above, further comprising a step of controlling the orientation between at least one of said image sensors and said human body via said holding and controlling mechanism.

It another object of the present invention to provide the method as defined above, wherein said control of said distance is performed according to the dimensions of said human body.

It another object of the present invention to provide the method as defined above, further comprising a step of selecting said image sensors from the group consisting of: visible light sensors, ultraviolet (UV) light sensors, infrared (IR) sensors, and any combination thereof.

It another object of the present invention to provide the method as defined above, wherein said predetermined arrangement characterized by n arrays locatable at angle of (360/n)° between each other with respect to said human body or said base, each of said n arrays comprises m image sensors; n is an integer greater than or equals to 1; m is an integer greater than or equals to 1.

It another object of the present invention to provide the method as defined above, wherein each of said n arrays comprises o parallel columns of said image sensors; o is an integer greater than or equals to 1.

It another object of the present invention to provide the method as defined above, wherein n is 4 and o is 2.

It another object of the present invention to provide the method as defined above, wherein said set of images of comprises images of overlapping predetermined areas of said human body.

It another object of the present invention to provide the method as defined above, further comprising a step of providing said predetermined arrangement selected from the group consisting of: homogeneous, non-homogeneous, aligned, non-aligned, spherical, cylindrical, cubic, spiral, randomly spaced, arbitrary, and any combination thereof.

It another object of the present invention to provide the method as defined above, wherein said orientation is an angle between at least one of said image sensors and said human body or said base, said angle is in the range of about 1° to about 179°.

It another object of the present invention to provide the method as defined above, further comprising a step of selecting said dermatological data from a group consisting of: suspected moles, nevus, tattoos, scars, moles, spots, wounds, and any combination thereof.

It another object of the present invention to provide the method as defined above, wherein said dermatological data comprises predetermined characteristics of suspected moles; said processing unit comprises an image processing algorithm adapted to detect the existence of said suspected moles and to characterize each mole according to said predetermined characteristics.

It another object of the present invention to provide the method as defined above, further comprising a step of performing via said image processing algorithm an operation selected from the group consisting of: locate the borders of said suspected moles, distinguish between a suspected mole and a wound according to a pattern recognition algorithm, and any combination thereof.

It another object of the present invention to provide the method as defined above, further comprising a step of storing said predetermined characteristics of each of said suspected moles via said processing unit.

It another object of the present invention to provide the method as defined above, further comprising a step of selecting said predetermined characteristics are selected from the group consisting of: location, coordinates of border, asymmetry measurement, planar measurements, 3D structure, topography, height, radius, color, and any combination thereof.

It another object of the present invention to provide the method as defined above, further comprising steps of providing the history of each suspected mole via said processing unit; and providing comparison and changes between the current and the previous predetermined characteristics of said suspected moles via said processing unit.

It another object of the present invention to provide the method as defined above, further comprising a step of detecting said suspected moles by analyzing 2D and 3D images of said suspected moles via said processing unit.

It another object of the present invention to provide the method as defined above, further comprising step of providing said base as part of a structure selected from the group consisting of: a booth, a kiosk, a cabin, a private enclosure, and any combination thereof.

It another object of the present invention to provide the method as defined above, further comprising a step of controlling the operation of said image sensors via said processing unit.

It another object of the present invention to provide the method as defined above, further comprising a step of operating said image sensors via said processing unit in a synchronized manner, such that a synchronized image of the skin of said human body is provided.

It another object of the present invention to provide the method as defined above, wherein in said synchronized manner, said image sensors are operated simultaneously.

It another object of the present invention to provide the method as defined above, further comprising a step of eliminating the influence of human hair on the data of said skin map via a hair removal mechanism.

It another object of the present invention to provide the method as defined above, further comprising a step of performing feedback via a feedback mechanism locatable within said processing unit, said feedback mechanism comprises: (i) an analyzing unit adapted to score said dermatological data according to a predetermined scale, so that abnormal dermatological data is detected; and (ii) a regulating unit adapted to operate said processing unit in a repeated manner when said score is higher than a predetermined value.

It another object of the present invention to provide the method as defined above, wherein said predetermined scale is adapted to rank parameters selected from the group consisting of: said predetermined characteristics, quality of said images, and any combination thereof.

It another object of the present invention to provide the method as defined above, further comprising a step of controlling the orientation of at least one of said image sensors via said feedback mechanism.

It another object of the present invention to provide the method as defined above, further comprising a step of storing said personal data on a safe memory card connectable to a data storage unit.

It another object of the present invention to provide the method as defined above, further comprising a step of selecting said personal data from the group consisting of: a dermatological data, scan results, set of images, a skin map, the full body photography, a 2D body model, a 3D body model, a 2D analysis, a 3D analysis, dates, patient personal information selected from a group consisting of name, height, weight, size, gender, id, password, family, family history, and any combination thereof, or any combination thereof.

It another object of the present invention to provide the method as defined above, further comprising a step of allowing an operator to perform via an operating unit operations selected from the group consisting of: analyzing said personal data; analyzing said set of images; analyzing said dermatological data; determining said dermatological data, editing said dermatological data, and any combination thereof.

It another object of the present invention to provide the method as defined above, further comprising a step of performing via said operating unit operations selected from the group consisting of: providing zoom-in to a predetermined area of a skin map, operating said feedback mechanism, manipulating said personal data, providing a 2D plot of a predetermined area of a skin map according to at least one image of said set of images, providing a 3D plot of a predetermined area of a skin map, providing a 2D plot of a predetermined area of a skin map by performing a 2D projection on said 3D plot, marking a predetermined area of a skin map, and any combination thereof.

It another object of the present invention to provide the method as defined above, wherein said dermatological data is associated with the evolution and the severity of melanoma of a predetermined area on said human body.

It another object of the present invention to provide the method as defined above, further comprising a step of identifying via said processing unit said patient according to parameters selected from the group consisting of: name, height, weight, size, gender, id, password, and any combination thereof.

It another object of the present invention to provide the method as defined above, further comprising a step of further rotating said human body with respect to said image sensor on a rotatable pod stand.

It another object of the present invention to provide the method as defined above, further comprising steps of: providing a body positioning sub-unit; providing instructions regarding the position of a patient with respect to said image sensors; and stabilizing the position of said patient with respect to said image sensors.

It another object of the present invention to provide the method as defined above, further comprising a step of providing said image sensors in a homogeneous grid of sensors.

It another object of the present invention to provide a method for capturing at least one image of the skin of a patient's human body, comprising steps of:
a. providing a booth, comprising: (i) a pod stand upon which said patient is adapted to stand; an envelope adapted to surround said patient; a plurality of image sensors, arranged in a predetermined arrangement between said envelope and said patient; and, (iii) a processing unit communicatable with said image sensors;
b. capturing at least one image of a predetermined area of said human body via said image sensors, thereby providing a set of images;
c. collecting said set of images from said image sensors via said processing unit;
d. analyzing said set of images via said processing unit;
e. constructing via said processing unit a record of a personal data associated with the skin geometry of said human body; and,
f. outputting a dermatological data associated with said skin of said human body;
wherein said method further comprises a step of providing said at least one of said image sensors with a joint connection to said envelope, thereby controlling the orientation of at least one of said image sensors with respect to said envelope.

It another object of the present invention to provide the method as defined above, further comprising step of providing a sensor holding and controlling mechanism, wherein said at least one of said image sensors is jointly connectable to said envelope via said sensor holding and controlling mechanism.

It another object of the present invention to provide the method as defined above, further comprising step of electrically operating said controlling mechanism by said processing unit.

It another object of the present invention to provide the method as defined above, further comprising step of manually operating said controlling mechanism by an operator.

It another object of the present invention to provide the method as defined above, further comprising a step of controlling the orientation between at least one of said image sensors and said human body via said holding and controlling mechanism.

It another object of the present invention to provide the method as defined above, wherein said control of said distance is performed according to the dimensions of said human body.

It another object of the present invention to provide the method as defined above, further comprising a step of selecting said image sensors from the group consisting of: visible light sensors, ultraviolet (UV) light sensors, infrared (IR) sensors, and any combination thereof.

It another object of the present invention to provide the method as defined above, wherein said predetermined arrangement characterized by n arrays locatable at angle of (360/n)° between each other with respect to said human body or said envelope, each of said n arrays comprises m image sensors; n is an integer greater than or equals to 1; m is an integer greater than or equals to 1.

It another object of the present invention to provide the method as defined above, wherein each of said n arrays comprises o parallel columns of said image sensors; o is an integer greater than or equals to 1.

It another object of the present invention to provide the method as defined above, wherein n is at least 4 and o is at least 2.

It another object of the present invention to provide the method as defined above, wherein said set of images of comprises images of overlapping predetermined areas of said human body.

It another object of the present invention to provide the method as defined above, further comprising a step of providing said predetermined arrangement selected from the group consisting of: homogeneous, non-homogeneous, aligned, non-aligned, spherical, cylindrical, cubic, spiral, randomly spaced, arbitrary, and any combination thereof.

It another object of the present invention to provide the method as defined above, wherein said orientation is an angle between at least one of said image sensors and said human body or said envelope, said angle is in the range of about 1° to about 179°.

It another object of the present invention to provide the method as defined above, further comprising a step of selecting said dermatological data from a group consisting of: suspected moles, nevus, tattoos, scars, moles, spots, wounds, and any combination thereof.

It another object of the present invention to provide the method as defined above, wherein said dermatological data comprises predetermined characteristics of suspected moles; said processing unit comprises an image processing algorithm adapted to detect the existence of said suspected moles and to characterize each mole according to said predetermined characteristics.

It another object of the present invention to provide the method as defined above, further comprising a step of performing via said image processing algorithm an operation selected from the group consisting of: locate the borders of said suspected moles, distinguish between a suspected mole and a wound according to a pattern recognition algorithm, and any combination thereof.

It another object of the present invention to provide the method as defined above, further comprising a step of storing said predetermined characteristics of each of said suspected moles via said processing unit.

It another object of the present invention to provide the method as defined above, further comprising a step of selecting said predetermined characteristics are selected from the group consisting of: location, coordinates of border, asymmetry measurement, planar measurements, 3D structure, topography, height, radius, color, and any combination thereof.

It another object of the present invention to provide the method as defined above, further comprising steps of providing the history of each suspected mole via said processing unit; and providing comparison and changes between the current and the previous predetermined characteristics of said suspected moles via said processing unit.

It another object of the present invention to provide the method as defined above, further comprising a step of detecting said suspected moles by analyzing 2D and 3D images of said suspected moles via said processing unit.

It another object of the present invention to provide the method as defined above, further comprising step of providing said envelope as part of a structure selected from the group consisting of: a booth, a kiosk, a cabin, a private enclosure, and any combination thereof.

It another object of the present invention to provide the method as defined above, further comprising a step of controlling the operation of said image sensors via said processing unit.

It another object of the present invention to provide the method as defined above, further comprising a step of operating said image sensors via said processing unit in a synchronized manner, such that a synchronized image of the skin of said human body is provided.

It another object of the present invention to provide the method as defined above, wherein in said synchronized manner, said image sensors are operated simultaneously.

It another object of the present invention to provide the method as defined above, further comprising a step of eliminating the influence of human hair on the data of said skin map via a hair removal mechanism.

It another object of the present invention to provide the method as defined above, further comprising a step of performing feedback via a feedback mechanism locatable within said processing unit, said feedback mechanism comprises: (i) an analyzing unit adapted to score said dermatological data according to a predetermined scale, so that abnormal dermatological data is detected; and (ii) a regulating unit adapted to operate said processing unit in a repeated manner when said score is higher than a predetermined value.

It another object of the present invention to provide the method as defined above, wherein said predetermined scale is adapted to rank parameters selected from the group consisting of: said predetermined characteristics, quality of said images, and any combination thereof.

It another object of the present invention to provide the method as defined above, further comprising a step of controlling the orientation of at least one of said image sensors via said feedback mechanism.

It another object of the present invention to provide the method as defined above, further comprising a step of storing said personal data on a safe memory card connectable to a data storage unit.

It another object of the present invention to provide the method as defined above, further comprising a step of selecting said personal data from the group consisting of: a dermatological data, scan results, set of images, a skin map, the full body photography, a 2D body model, a 3D body model, a 2D analysis, a 3D analysis, dates, patient personal information selected from a group consisting of name, height, weight, size, gender, id, password, family, family history, and any combination thereof, or any combination thereof.

It another object of the present invention to provide the method as defined above, further comprising a step of allowing an operator to perform via an operating unit operations selected from the group consisting of: analyzing said personal data; analyzing said set of images; analyzing said dermatological data; determining said dermatological data, editing said dermatological data, and any combination thereof.

It another object of the present invention to provide the method as defined above, further comprising a step of performing via said operating unit operations selected from the group consisting of: providing zoom-in to a predetermined area of a skin map, operating said feedback mechanism, manipulating said personal data, providing a 2D plot of a predetermined area of a skin map according to at least one image of said set of images, providing a 3D plot of a predetermined area of a skin map, providing a 2D plot of a predetermined area of a skin map by performing a 2D projection on said 3D plot, marking a predetermined area of a skin map, and any combination thereof.

It another object of the present invention to provide the method as defined above, wherein said dermatological data is associated with the evolution and the severity of melanoma of a predetermined area on said human body.

It another object of the present invention to provide the method as defined above, further comprising a step of identifying via said processing unit said patient according to parameters selected from the group consisting of: name, height, weight, size, gender, id, password, and any combination thereof.

It another object of the present invention to provide the method as defined above, further comprising a step of further rotating said human body with respect to said image sensor on a rotatable pod stand.

It another object of the present invention to provide the method as defined above, further comprising steps of: providing a body positioning sub-unit; providing instructions regarding the position of a patient with respect to said image sensors; and stabilizing the position of said patient with respect to said image sensors.

It another object of the present invention to provide the method as defined above, further comprising a step of providing said image sensors in a homogeneous grid of sensors.

It another object of the present invention to provide an imaging system for capturing at least one image of the skin of a patient's body, comprising:
a. at least one base;
b. a plurality of first image sensors, connectable to said base, arranged in a predetermined arrangement; each of said image sensors adapted to capture at least one image of a predetermined area of said body, so that as a set of images is provided; and,
c. a processing unit communicatable with said image sensors, said processing unit comprising a program of machine-readable instructions embodied on a computer readable memory and executable by a digital data processor adapted to: (i) collect said set of images from said image sensors; (ii) analyze said set of images; (iii) construct a record of personal data associated with the skin of said body of said patient; and (iv) output a dermatological data associated with said skin of said body;
d. at least q second image sensors; at least one of said q second image sensors adapted to capture at least one image of a predetermined area of said body; each of said q image sensors is connected to said base by means of (i) k consecutive arm sections; (ii) at least k−1 joints coupling each two of said k consecutive arm sections together; such that the position of said at least q second image sensors is alterable; q is greater than or equals to 1; k is greater than or equals to 1.

In this embodiment at least one ‘smart image sensor’ is provided. The smart image sensor is provided with a robotic arm which enables the same to reach different spots/area of the patient's body.

The robotic arm is comprise several arm interconnected to each other via couplers/joints which enable the same to rotate along the main axis (see for example FIGS. 19a-19c).

According to another embodiment, the system additionally comprising a second processing unit communicatable with at least one of said q second image sensors; said second processing unit comprising a program of machine-readable instructions embodied on a computer readable memory and executable by a digital data processor adapted to: (i) collect said at least one image from said second image sensors; (ii) analyze said at least one image; (iii) output a data associated with said skin of said body or said image.

In this embodiment the second processing unit generally image process the images received from the ‘smart image sensor’. Such a processing is less time consuming. The image processing is adapted to provide information whether the image obtained is in good quality (in terms of color, contrast, lightning etc.) and whether the focus is correct, the positioning of the image sensor is the optimized position etc.

According to another embodiment, the system adapted for performing both Total Body Photography and Total Body Dermoscopy

According to another embodiment, the position of said q second image sensors is alterable in at least one orientation selected from a group consisting of the sagittal plane, the coronal plane or the transverse plane, upwards, downwards, left, right, the distance between at least one of said second image sensors and said body, or any combination thereof.

According to another embodiment, the at least one of first or second image sensors is jointly connectable to said base by means of at least one joint, such that the orientation of said at least one of said first or second image sensors with respect to said base is controllable and reconfigurable

According to another embodiment, the at least one of said first or second image sensors is jointly connectable to said base via a restricting sensor and controlling mechanism, such that said at least one image sensor is movable in at least one selected from a group consisting of the sagittal plane, the coronal plane or the transverse plane, upwards, downwards, left, right or any combination thereof.

According to another embodiment, the restricting sensor is adapted to regulate the movement of said at least one first or second image sensor.

According to another embodiment, the controlling mechanism is either electronically operatable by said processing unit or manually operatable by an operator.

According to another embodiment, the controlling mechanism is adapted to control the distance between at least one of said first or second image sensors and said body.

According to another embodiment, the controlling mechanism is adapted to control the distance in said orientation between at least one of said first or second image sensors and said body.

According to another embodiment, the controlling mechanism is adapted to control the location of at least one of said first or second image sensors in said base.

According to another embodiment, the base is characterized by a main longitudinal axis; further wherein said controlling mechanism is adapted to control the location of at least one of said first or second image sensors along said main longitudinal axis in said base.

According to another embodiment, the control of said distance is performed according to the dimensions of said body.

According to another embodiment, the system additionally comprising a sensor adapted to provide information as for the dimensions of said body, such that said control of said distance is performed according to the dimensions of said body.

According to another embodiment, the first or second image sensors are selected from the group consisting of: visible light sensors, ultraviolet (UV) light sensors, infrared (IR) sensors, and any combination thereof.

According to another embodiment, the predetermined arrangement characterized by n arrays locatable at angle of (360/n)° between each other with respect to said body or said base, each of said n arrays comprises m first image sensors; n is an integer greater than or equals to 1; m is an integer greater than or equals to 1.

According to another embodiment, each of said n arrays comprises o parallel columns of said first image sensors; o is an integer greater than or equals to 1.

According to another embodiment, n is at least 4 and o is at least 2.

According to another embodiment, the predetermined arrangement characterized by n arrays, each of said n arrays comprises m first image sensors; n is an integer greater than or equals to 1; m is an integer greater than or equals to 1.

According to another embodiment, each of said n arrays comprises o parallel columns of said first image sensors; o is an integer greater than or equals to 1.

According to another embodiment, each of said n arrays comprises o first image sensors; wherein said o first image sensors are positioned within each of said n arrays in a predetermined manner; o is an integer greater than or equals to 1.

According to another embodiment, the predetermined manner is selected from a group consisting of homogeneous, non-homogeneous, aligned, non-aligned, spherical, triangular, cylindrical, cubic, spiral, randomly spaced, arbitrary, polygon having p ribs; p is greater than 1; and any combination thereof.

According to another embodiment, the system additionally comprising means adapted to relocate said base from a first position to a second position.

According to another embodiment, the processing unit or said second processing unit is adapted to control the on/off mode of at least one of said first or second image sensors.

According to another embodiment, the set of images of comprises at least 2 images of overlapping predetermined areas of said body.

According to another embodiment, the predetermined arrangement is selected from the group consisting of: homogeneous, non-homogeneous, aligned, non-aligned, spherical, cylindrical, cubic, spiral, randomly spaced, arbitrary, and any combination thereof.

According to another embodiment, the orientation is an angle between at least one of said first image sensors and said body or said base, said angle is in the range of about 1° to about 179°.

According to another embodiment, the dermatological data is selected from a group consisting of: suspected moles, the boundaries of suspected moles, tissue encircling said suspected moles nevus, tattoos, scars, moles, spots, wounds, and any combination thereof.

According to another embodiment, the processing unit or said second processing unit comprises an image processing algorithm adapted to detect the existence of said suspected moles and to characterize each mole according to predetermined characteristics.

According to another embodiment, the image processing algorithm is further adapted to perform operation selected from the group consisting of: locate the borders of said suspected moles, distinguish between a suspected mole and a wound according to a pattern recognition algorithm, and any combination thereof.

According to another embodiment, the processing unit or said second processing unit is adapted to store said predetermined characteristics of each of said suspected moles.

According to another embodiment, the predetermined characteristics are selected from the group consisting of: location, coordinates of border, asymmetry measurement, planar measurements, 2D structure, 3D structure, topography, height, radius, color, and any combination thereof.

According to another embodiment, the processing unit or second processing unit is adapted to provide the history of each suspected mole and to provide comparison and changes between the current predetermined characteristics of said suspected moles and at least one previous predetermined characteristics of said suspected moles.

According to another embodiment, the processing unit or said second processing unit is adapted to detect said suspected moles by analyzing 2D and 3D images of said suspected moles.

According to another embodiment, the base is part of a structure selected from the group consisting of: a booth, a kiosk, a cabin, a private enclosure, and any combination thereof.

According to another embodiment, the processing unit or said second processing unit is adapted to control the operation of said first or second image sensors; said operation is selected from the orientation of at least one of said first or second image sensors; the distance between at least one of said first or second image sensors and said body, on/off mode of at least one of said first or second image sensors.

According to another embodiment, the processing unit or said second processing unit is adapted to operate said first or second image sensors in a synchronized manner, such that a synchronized image of the skin of said body is provided.

According to another embodiment, the synchronized manner is operation of a portion of at least one of said image sensors.

According to another embodiment, at least two of said first or second image sensors are operated simultaneously.

According to another embodiment, the system further comprising a hair removal mechanism adapted to eliminate the influence of human hair on the data of said personal data.

According to another embodiment, the processing unit or said second processing unit further comprises a feedback mechanism, said feedback mechanism comprises: (i) an analyzing unit adapted to score said dermatological data according to a predetermined scale, so that abnormal dermatological data is detected; and (ii) a regulating unit adapted to operate said processing unit or said second processing unit in a repeated manner when said score is higher than a predetermined value.

According to another embodiment, the predetermined scale is adapted to rank parameters selected from the group consisting of: said predetermined characteristics, quality of said images; said quality is selected from a group consisting of color, contrast, blurred, out of focus, lightness, and any combination thereof.

According to another embodiment, the feedback mechanism further adapted to control the orientation of at least one of said first or second image sensors, the position of said patient, the distance between at least one of said first or second image sensors and said patient.

According to another embodiment, the system further comprising a data storage unit adapted to store said personal data on a portable safe memory card.

According to another embodiment, the personal data selected from the group consisting of: a dermatological data, scan results, set of images, a skin map, the full body photography, a 2D body model, a 3D body model, a 2D analysis, a 3D analysis, dates, patient personal information selected from a group consisting of name, height, weight, size, gender, id, password, family, family history, and any combination thereof, or any combination thereof.

According to another embodiment, the processing unit or said second processing unit is adapted to analyze said set of images based upon previous analyzes.

According to another embodiment, the processing unit or said second processing unit further comprises an operation unit adapted to allow an operator to perform operation selected from the group consisting of: analyze said personal data; analyze said set of images; analyze said dermatological data; determine said dermatological data, edit said dermatological data, and any combination thereof.

According to another embodiment, the operation unit is further adapted to perform operations selected from the group consisting of: provide zoom-in to a predetermined area of a skin map, operate said feedback mechanism, maipulate said personal data, provide a 2D plot of a predetermined area of a skin map according to at least one image of said set of images, provide a 3D plot of a predetermined area of a skin map, provide a 2D plot of a predetermined area of a skin map by performing a 2D projection on said 3D plot, mark a predetermined area of a skin map, and any combination thereof.

According to another embodiment, the dermatological data is associated with the evolution and the severity of melanoma of a predetermined area on said body.

According to another embodiment, the processing unit or said second processing unit is further adapted to identify a patient according to parameters selected from the group consisting of: name, height, weight, size, gender, id, password, family, family history, and any combination thereof.

According to another embodiment, the system further comprising a rotatable pod stand adapted to rotate said body with respect to said first or second image sensor.

According to another embodiment, the system further comprising a body positioning sub-unit adapted to: provide instructions regarding the position of a patient with respect to said first or second image sensors; and to stabilize the position of said patient with respect to said first or second image sensors.

According to another embodiment, the first image sensors are positioned in a homogeneous grid of sensors.

According to another embodiment, the dermatological data is used from detecting melanoma, for esthetics use, cosmetics use or any combination thereof.

In the foregoing description, embodiments of the invention, including preferred embodiments, have been presented for the purpose of illustration and description. They are not intended to be exhaustive or to limit the invention to the precise form disclosed. Obvious modifications or variations are possible in light of the above teachings. The embodiments were chosen and described to provide the best illustration of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

1. A skin surface imaging system for capturing at least one image of the skin of a patient's body, comprising:
a. at least one base;
b. a plurality of image sensors, connectable to said base, arranged in a predetermined arrangement; each of said image sensors adapted to capture at least one image of a predetermined area of said body, so that as a set of images is provided; and,
c. a processing unit communicatable with said image sensors, said processing unit comprising a program of machine-readable instructions embodied on a computer readable memory and executable by a digital data processor adapted to: (i) collect said set of images from said image sensors; (ii) analyze said set of images; (iii) construct a record of personal data associated with the skin of said body of said patient; and (iv) output a dermatological data associated with said skin of said body;
wherein at least one of said image sensors is jointly connectable to said base by means of at least one joint, such that the orientation of said at least one of said image sensors with respect to said base is controllable and reconfigurable.

2. The skin surface imaging system according to claim 1, wherein said at least one of said image sensors is jointly connectable to said base via a restricting sensor and controlling mechanism, such that said at least one image sensor is movable in at least one selected from group consisting of the sagittal plane, the coronal plane or the transverse plane, upwards, downwards, left, right or any combination thereof.

3. The skin surface imaging system according to claim 2, wherein said restricting sensor is adapted to regulate the movement of said at least one image sensor.

4. The skin surface imaging system according to claim 2, wherein said controlling mechanism is either electronically operatable by said processing unit or manually operatable by an operator.

5. The skin surface imaging system according to claim 2, wherein said controlling mechanism is adapted to control the distance between at least one of said image sensors and said body.

6. The skin surface imaging system according to claim 1, wherein said controlling mechanism is adapted to control the distance in said orientation between at least one of said image sensors and said body.

7. The skin surface imaging system according to claim 1, additionally comprising a moving mechanism couple to at least one of said image sensors, adapted to move said image sensors from one potion to another within said base.

8. The skin surface imaging system according to claim 1, wherein said controlling mechanism is adapted to control the location of at least one of said image sensors in said base.

9. The skin surface imaging system according to claim 1, wherein said base is characterized by a main longitudinal axis; further wherein said controlling mechanism is adapted to control the location of at least one of said image sensors along said main longitudinal axis in said base.

10. The skin surface imaging system according to claim 5, wherein said control of said distance is performed according to the dimensions of said body.

11. The skin surface imaging system according to claim 5, additionally comprising a sensor adapted to provide information as for the dimensions of said body, such that said control of said distance is performed according to the dimensions of said body.

12. The skin surface imaging system according to claim 1, wherein said image sensors are selected from the group consisting of: visible light sensors, ultraviolet (UV) light sensors, infrared (IR) sensors, and any combination thereof.

13. The skin surface imaging system according to claim 1, wherein said predetermined arrangement characterized by n arrays locatable at angle of (360/n)° between each other with respect to said body or said base, each of said n arrays comprises m image sensors; n is an integer greater than or equals to 1; m is an integer greater than or equals to 1.

14. The skin surface imaging system according to claim 13, wherein each of said n arrays comprises o parallel columns of said image sensors; o is an integer greater than or equals to 1.

15. The skin surface imaging system according to claim 13, wherein n is at least 4 and o is at least 2.

16. The skin surface imaging system according to claim 1, wherein said predetermined arrangement characterized by n arrays, each of said n arrays comprises m image sensors; n is an integer greater than or equals to 1; m is an integer greater than or equals to 1.

17. The skin surface imaging system according to claim 16, wherein each of said n arrays comprises o parallel columns of said image sensors; o is an integer greater than or equals to 1.

18. The skin surface imaging system according to claim 16 or 13 wherein each of said n arrays comprises o image sensors; wherein said o image sensors are positioned within each of said n arrays in a predetermined manner; o is an integer greater than or equals to 1.

19. The skin surface imaging system according to claim 18, wherein said predetermined manner is selected from a group consisting of homogeneous, non-homogeneous, aligned, non-aligned, spherical, triangular, cylindrical, cubic, spiral, randomly spaced, arbitrary, polygon having p ribs; p is greater than 1; and any combination thereof.

20. The skin surface imaging system according to claim 1, additionally comprising means adapted to relocate said base from a first position to a second position.

21. The skin surface imaging system according to claim 1, wherein said processing unit is adapted to control the on/off mode of at least one of said image sensors.

22. The skin surface imaging system according to claim 1, wherein said set of images of comprises at least 2 images of overlapping predetermined areas of said body.

23. The skin surface imaging system according to claim 1, wherein said predetermined arrangement is selected from the group consisting of: homogeneous, non-homogeneous, aligned, non-aligned, spherical, cylindrical, cubic, spiral, randomly spaced, arbitrary, and any combination thereof.

24. The skin surface imaging system according to claim 1, wherein said orientation is an angle between at least one of said image sensors and said body or said base, said angle is in the range of about 1° to about 179°.

25. The skin surface imaging system according to claim 1, wherein said dermatological data is selected from a group consisting of: suspected moles, the boundaries of suspected moles, tissue encircling said suspected moles nevus, tattoos, scars, moles, spots, wounds, and any combination thereof.

26. The skin surface imaging system according to claim 1, wherein said processing unit comprises an image processing algorithm adapted to detect the existence of said suspected moles and to characterize each mole according to predetermined characteristics.

27. The skin surface imaging system according to claim 26, wherein said image processing algorithm is further adapted to perform operation selected from the group consisting of: locate the borders of said suspected moles, distinguish between a suspected mole and a wound according to a pattern recognition algorithm, and any combination thereof.

28. The skin surface imaging system according to claim 26, wherein said processing unit is adapted to store said predetermined characteristics of each of said suspected moles.

29. The skin surface imaging system according to claim 26, wherein said predetermined characteristics are selected from the group consisting of: location, coordinates of border, asymmetry measurement, planar measurements, 2D structure, 3D structure, topography, height, radius, color, and any combination thereof.

30. The skin surface imaging system according to claim 26, wherein said processing unit is adapted to provide the history of each suspected mole and to provide comparison and changes between the current predetermined characteristics of said suspected moles and at least one previous predetermined characteristics of said suspected moles.

31. The skin surface imaging system according to claim 26, wherein said processing unit is adapted to detect said suspected moles by analyzing 2D and 3D images of said suspected moles.

32. The skin surface imaging system according to claim 1, wherein said base is part of a structure selected from the group consisting of: a booth, a kiosk, a cabin, a private enclosure, and any combination thereof.

33. The skin surface imaging system according to claim 1, wherein said processing unit is adapted to control the operation of said image sensors; said operation is selected from the orientation of at least one of said image sensors; the distance between at least one of said image sensors and said body, on/off mode of at least one of said image sensors.

34. The skin surface imaging system according to claim 1, wherein said processing unit is adapted to operate said image sensors in a synchronized manner, such that a synchronized image of the skin of said body is provided.

35. The skin surface imaging system according to claim 34, wherein said synchronized manner is operation of a portion of at least one of said image sensors.

36. The skin surface imaging system according to claim 34, wherein in said synchronized manner, said at least two of said image sensors are operated simultaneously.

37. The skin surface imaging system according to claim 1, additionally comprising lightning means selected from a group consisting of LEDs, lamps, bulb filament or any combination thereof.

38. The skin surface imaging system according to claim 37, adapted to synchronies the operation of at least one of said image sensor and said lightning means.

39. The skin surface imaging system according to claim 1, further comprising a hair removal mechanism adapted to eliminate the influence of human hair on the data of said personal data.

40. The skin surface imaging system according to claim 1, wherein said processing unit further comprises a feedback mechanism, said feedback mechanism comprises: (i) an analyzing unit adapted to score said dermatological data according to a predetermined scale, so that abnormal dermatological data is detected; and (ii) a regulating unit adapted to operate said processing unit in a repeated manner when said score is higher than a predetermined value.

41. The skin surface imaging system according to claim 26 or claim 39, wherein said predetermined scale is adapted to rank parameters selected from the group consisting of: said predetermined characteristics, quality of said images; said quality is selected from a group consisting of color, contrast, blurred, out of focus, lightness, and any combination thereof.

42. The skin surface imaging system according to claim 39, wherein said feedback mechanism further adapted to control the orientation or the 3D position of at least one of said image sensors, the position of said patient, the distance between at least one of said image sensors and said patient.

43. The skin surface imaging system according to claim 1, further comprising a data storage unit adapted to store said personal data on a portable safe memory card.

44. The skin surface imaging system according to claim 1, wherein said personal data selected from the group consisting of: a dermatological data, scan results, set of images, a skin map, the full body photography, a 2D body model, a 3D body model, a 2D analysis, a 3D analysis, dates, patient personal information selected from a group consisting of name, height, weight, size, gender, id, password, family, family history, and any combination thereof, or any combination thereof.

45. The skin surface imaging system according to claim 1, wherein said processing unit is adapted to analyze said set of images based upon previous analyzes.

46. The skin surface imaging system according to claim 1, wherein said processing unit further comprises an operation unit adapted to allow an operator to perform operation selected from the group consisting of: analyze said personal data; analyze said set of images; analyze said dermatological data; determine said dermatological data, edit said dermatological data, and any combination thereof.

47. The skin surface imaging system according to claim 39, wherein said operation unit is further adapted to perform operations selected from the group consisting of: provide zoom-in to a predetermined area of a skin map, operate said feedback mechanism, manipulate said personal data, provide a 2D plot of a predetermined area of a skin map according to at least one image of said set of images, provide a 3D plot of a predetermined area of a skin map, provide a 2D plot of a predetermined area of a skin map by performing a 2D projection on said 3D plot, mark a predetermined area of a skin map, and any combination thereof.

48. The skin surface imaging system according to claim 1, wherein said dermatological data is associated with the evolution and the severity of melanoma of a predetermined area on said body.

49. The skin surface imaging system according to claim 1, wherein said processing unit is further adapted to identify said patient according to parameters selected from the group consisting of: name, height, weight, size, gender, id, password, family, family history, and any combination thereof.

50. The skin surface imaging system according to claim 1, further comprising a rotatable pod stand adapted to rotate said body with respect to said image sensor.

51. The skin surface imaging system according to claim 1, further comprising a body positioning sub-unit adapted to: provide instructions regarding the position of a patient with respect to said image sensors; and to stabilize the position of said patient with respect to said image sensors.

52. The skin surface imaging system according to claim 1, wherein said image sensors are positioned in a homogeneous grid of sensors.

53. The skin surface imaging system according to claim 1, wherein said image sensors is selected from a group consisting of stills camera, video camera or any combination thereof.

54. The skin surface imaging system according to claim 1, wherein said dermatological data is used from detecting melanoma, for esthetics use, cosmetics use or any combination thereof.

55. The skin surface imaging system according to claim 1, wherein at least one of said image sensor comprises at least one marker.

56. The skin surface imaging system according to claim 1, wherein at least one of said image sensor is adapted to rotate around said image sensor's main axis.

57. An imaging system for capturing at least one image of the skin of a patient's body, comprising:
a. at least one base;
b. a plurality of image sensors, connectable to said base, arranged in a predetermined arrangement; each of said image sensors adapted to capture at least one image of a predetermined area of said body, so that as a set of images is provided; and,
c. a processing unit communicatable with said image sensors, said processing unit comprising a program of machine-readable instructions embodied on a computer readable memory and executable by a digital data processor adapted to: (i) collect said set of images from said image sensors; (ii) analyze said set of images; (iii) construct a skin map associated with the skin geometry of said body; and (iv) output a dermatological data associated with said skin of said body;
wherein at least one of said image sensors is connectable to said base such that the distance between at least one of said image sensors and said base or said body is controllable and alterable.

58. The imaging system according to claim 57, wherein said at least one of said image sensors is jointly connectable to said base via a restricting sensor and controlling mechanism, such that said at least one image sensor is movable in at least one selected from group consisting of the sagittal plane, the coronal plane or the transverse plane, upwards, downwards, left, right or any combination thereof.

59. The imaging system according to claim 58, wherein said restricting sensor is adapted to regulate the movement of said at least one image sensor.

60. The imaging system according to claim 58, wherein said controlling mechanism is either electronically operatable by said processing unit or manually operatable by an operator.

61. The imaging system according to claim 57 wherein at least one of said image sensors is jointly connectable to said base by means of at least one joint, such that the orientation of said at least one of said image sensors with respect to said base is controllable and reconfigurable

62. The imaging system according to claim 58, wherein said controlling mechanism is adapted to control the distance in said orientation between at least one of said image sensors and said body.

63. The imaging system according to claim 58, wherein said controlling mechanism is adapted to control the location of at least one of said image sensors in said base.

64. The imaging system according to claim 57, wherein said base is characterized by a main longitudinal axis; further wherein said controlling mechanism is adapted to control the location of at least one of said image sensors along said main longitudinal axis in said base.

65. The imaging system according to claim 64, wherein said control of said distance is performed according to the dimensions of said body.

66. The imaging system according to claim 64, additionally comprising a sensor adapted to provide information as for the dimensions of said body, such that said control of said distance is performed according to the dimensions of said body.

67. The imaging system according to claim 57, wherein said image sensors are selected from the group consisting of: visible light sensors, ultraviolet (UV) light sensors, infrared (IR) sensors, and any combination thereof.

68. The imaging system according to claim 57, wherein said predetermined arrangement characterized by n arrays locatable at angle of (360/n)° between each other with respect to said body or said base, each of said n arrays comprises m image sensors; n is an integer greater than or equals to 1; m is an integer greater than or equals to 1.

69. The imaging system according to claim 68, wherein each of said n arrays comprises o parallel columns of said image sensors; o is an integer greater than or equals to 1.

70. The imaging system according to claim 68, wherein n is at least 4 and o is at least 2.

71. The imaging system according to claim 57, wherein said predetermined arrangement characterized by n arrays, each of said n arrays comprises m image sensors; n is an integer greater than or equals to 1; m is an integer greater than or equals to 1.

72. The imaging system according to claim 68, wherein each of said n arrays comprises o parallel columns of said image sensors; o is an integer greater than or equals to 1.

73. The imaging system according to claim 68 or 71 wherein each of said n arrays comprises o image sensors; wherein said o image sensors are positioned within each of said n arrays in a predetermined manner; o is an integer greater than or equals to 1.

74. The imaging system according to claim 73, wherein said predetermined manner is selected from a group consisting of homogeneous, non-homogeneous, aligned, non-aligned, spherical, triangular, cylindrical, cubic, spiral, randomly spaced, arbitrary, polygon having p ribs; p is greater than 1; and any combination thereof.

75. The imaging system according to claim 57, additionally comprising means adapted to relocate said base from a first position to a second position.

76. The imaging system according to claim 57, wherein said processing unit is adapted to control the on/off mode of at least one of said image sensors.

77. The imaging system according to claim 57, wherein said set of images of comprises at least 2 images of overlapping predetermined areas of said body.

78. The imaging system according to claim 57, wherein said predetermined arrangement is selected from the group consisting of: homogeneous, non-homogeneous, aligned, non-aligned, spherical, cylindrical, cubic, spiral, randomly spaced, arbitrary, and any combination thereof.

79. The imaging system according to claim 57, wherein said orientation is an angle between at least one of said image sensors and said body or said base, said angle is in the range of about 1° to about 179°.

80. The imaging system according to claim 57, wherein said dermatological data is selected from a group consisting of: suspected moles, the boundaries of suspected moles, tissue encircling said suspected moles nevus, tattoos, scars, moles, spots, wounds, and any combination thereof.

81. The imaging system according to claim 57, wherein said processing unit comprises an image processing algorithm adapted to detect the existence of said suspected moles and to characterize each mole according to predetermined characteristics.

82. The imaging system according to claim 81, wherein said image processing algorithm is further adapted to perform operation selected from the group consisting of: locate the borders of said suspected moles, distinguish between a suspected mole and a wound according to a pattern recognition algorithm, and any combination thereof.

83. The imaging system according to claim 57, wherein said processing unit is adapted to store said predetermined characteristics of each of said suspected moles.

84. The imaging system according to claim 57, wherein said predetermined characteristics are selected from the group consisting of: location, coordinates of border, asymmetry measurement, planar measurements, 2D structure, 3D structure, topography, height, radius, color, and any combination thereof.

85. The imaging system according to claim 83, wherein said processing unit is adapted to provide the history of each suspected mole and to provide comparison and changes between the current predetermined characteristics of said suspected moles and at least one previous predetermined characteristics of said suspected moles.

86. The imaging system according to claim 83, wherein said processing unit is adapted to detect said suspected moles by analyzing 2D and 3D images of said suspected moles.

87. The imaging system according to claim 57, wherein said base is part of a structure selected from the group consisting of: a booth, a kiosk, a cabin, a private enclosure, and any combination thereof.

88. The imaging system according to claim 57, wherein said processing unit is adapted to control the operation of said image sensors; said operation is selected from the orientation of at least one of said image sensors; the distance between at least one of said image sensors and said body, on/off mode of at least one of said image sensors.

89. The imaging system according to claim 57, wherein said processing unit is adapted to operate said image sensors in a synchronized manner, such that a synchronized image of the skin of said body is provided.

90. The imaging system according to claim 89, wherein said synchronized manner is operation of a portion of at least one of said image sensors.

91. The imaging system according to claim 89, wherein in said synchronized manner, said at least two of said image sensors are operated simultaneously.

92. The imaging system according to claim 57, further comprising a hair removal mechanism adapted to eliminate the influence of human hair on the data of said personal data.

93. The imaging system according to claim 57, wherein said processing unit further comprises a feedback mechanism, said feedback mechanism comprises: (i) an analyzing unit adapted to score said dermatological data according to a predetermined scale, so that abnormal dermatological data is detected; and (ii) a regulating unit adapted to operate said processing unit in a repeated manner when said score is higher than a predetermined value.

94. The imaging system according to claim 93, wherein said predetermined scale is adapted to rank parameters selected from the group consisting of: said predetermined characteristics, quality of said images; said quality is selected from a group consisting of color, contrast, blurred, out of focus, lightness, and any combination thereof.

95. The imaging system according to claim 93, wherein said feedback mechanism further adapted to control the orientation or the 3D position of at least one of said image sensors, the position of said patient, the distance between at least one of said image sensors and said patient.

96. The imaging system according to claim 57, further comprising a data storage unit adapted to store said personal data on a portable safe memory card.

97. The imaging system according to claim 57, wherein said personal data selected from the group consisting of: a dermatological data, scan results, set of images, a skin map, the full body photography, a 2D body model, a 3D body model, a 2D analysis, a 3D analysis, dates, patient personal information selected from a group consisting of name, height, weight, size, gender, id, password, family, family history, and any combination thereof or any combination thereof.

98. The imaging system according to claim 57, wherein said processing unit is adapted to analyze said set of images based upon previous analyzes.

99. The imaging system according to claim 57, wherein said processing unit further comprises an operation unit adapted to allow an operator to perform operation selected from the group consisting of: analyze said personal data; analyze said set of images; analyze said dermatological data; determine said dermatological data, edit said dermatological data, and any combination thereof.

100. The imaging system according to claim 99, wherein said operation unit is further adapted to perform operations selected from the group consisting of: provide zoom-in to a predetermined area of a skin map, operate said feedback mechanism, maipulate said personal data, provide a 2D plot of a predetermined area of a skin map according to at least one image of said set of images, provide a 3D plot of a predetermined area of a skin map, provide a 2D plot of a predetermined area of a skin map by performing a 2D projection on said 3D plot, mark a predetermined area of a skin map, and any combination thereof.

101. The imaging system according to claim 57, wherein said dermatological data is associated with the evolution and the severity of melanoma of a predetermined area on said body.

102. The imaging system according to claim 57, wherein said processing unit is further adapted to identify said patient according to parameters selected from the group consisting of: name, height, weight, size, gender, id, password, family, family history, and any combination thereof.

103. The imaging system according to claim 57, further comprising a rotatable pod stand adapted to rotate said body with respect to said image sensor.

104. The imaging system according to claim 57, further comprising a body positioning sub-unit adapted to: provide instructions regarding the position of a patient with respect to said image sensors; and to stabilize the position of said patient with respect to said image sensors.

105. The imaging system according to claim 57, wherein said image sensors are positioned in a homogeneous grid of sensors.

106. The skin surface imaging system according to claim 57, wherein said image sensors is selected from a group consisting of stills camera, video camera or any combination thereof.

107. The skin surface imaging system according to claim 57, additionally comprising a moving mechanism couple to at least one of said image sensors, adapted to move said image sensors from one potion to another within said base.

108. The skin surface imaging system according to claim 57 additionally comprising lightning means selected from a group consisting of LEDs, lamps, bulb filament or any combination thereof.

109. The skin surface imaging system according to claim 108, adapted to synchronies the operation of at least one of said image sensor and said lightning means.

110. The skin surface imaging system according to claim 57, wherein said dermatological data is used from detecting melanoma, for esthetics use, cosmetics use or any combination thereof.

111. The skin surface imaging system according to claim 57, wherein at least one of said image sensor comprises at least one marker.

112. The skin surface imaging system according to claim 57, wherein at least one of said image sensor is adapted to rotate around said image sensor's main axis.

113. A booth for capturing at least one image of the skin of a patient's human body, comprising:
a. a pod stand upon which said patient is adapted to stand;
b. an envelope adapted to surround said patient;
c. a plurality of image sensors, arranged in a predetermined arrangement between said envelope and said patient; each of said image sensors adapted to capture at least one image of a predetermined area of said human body, so that as a set of images is provided;
d. a processing unit communicatable with said image sensors, said processing unit comprising a program of machine-readable instructions embodied on a computer readable memory and executable by a digital data processor adapted to: (i) collect said set of images from said image sensors; (ii) analyze said set of images; (iii) construct a skin map associated with the skin geometry of said human body; and (iv) output a dermatological data associated with said skin of said human body;
wherein at least one of said image sensors is jointly connectable to said base by means of at least one joint, such that the orientation of said at least one of said image sensors with respect to said base is controllable and reconfigurable.

114. The booth according to claim 113, wherein said at least one of said image sensors is jointly connectable to said base via a restricting sensor and controlling mechanism, such that said at least one image sensor is movable in at least one selected from group consisting of the sagittal plane, the coronal plane or the transverse plane, upwards, downwards, left, right or any combination thereof.

115. The booth according to claim 114, wherein said restricting sensor is adapted to regulate the movement of said at least one image sensor.

116. The booth according to claim 114, wherein said controlling mechanism is either electronically operatable by said processing unit or manually operatable by an operator.

117. The booth according to claim 114, wherein said controlling mechanism is adapted to control the distance between at least one of said image sensors and said body.

118. The booth according to claim 113, wherein said controlling mechanism is adapted to control the distance in said orientation between at least one of said image sensors and said body.

119. The booth according to claim 113, wherein said controlling mechanism is adapted to control the location of at least one of said image sensors in said base.

120. The booth according to claim 113, wherein said base is characterized by a main longitudinal axis; further wherein said controlling mechanism is adapted to control the location of at least one of said image sensors along said main longitudinal axis in said base.

121. The booth according to claim 117, wherein said control of said distance is performed according to the dimensions of said body.

122. The booth according to claim 117, additionally comprising a sensor adapted to provide information as for the dimensions of said body, such that said control of said distance is performed according to the dimensions of said body.

123. The booth according to claim 113, wherein said image sensors are selected from the group consisting of: visible light sensors, ultraviolet (UV) light sensors, infrared (IR) sensors, and any combination thereof.

124. The booth according to claim 113, wherein said predetermined arrangement characterized by n arrays locatable at angle of (360/n)° between each other with respect to said body or said base, each of said n arrays comprises m image sensors; n is an integer greater than or equals to 1; m is an integer greater than or equals to 1.

125. The booth according to claim 124, wherein each of said n arrays comprises o parallel columns of said image sensors; o is an integer greater than or equals to 1.

126. The booth according to claim 125, wherein n is at least 4 and o is at least 2.

127. The booth according to claim 113, wherein said predetermined arrangement characterized by n arrays, each of said n arrays comprises m image sensors; n is an integer greater than or equals to 1; m is an integer greater than or equals to 1.

128. The booth according to claim 127, wherein each of said n arrays comprises o parallel columns of said image sensors; o is an integer greater than or equals to 1.

129. The booth according to claim 127, wherein each of said n arrays comprises o image sensors; wherein said o image sensors are positioned within each of said n arrays in a predetermined manner; o is an integer greater than or equals to 1.

130. The booth according to claim 129, wherein said predetermined manner is selected from a group consisting of homogeneous, non-homogeneous, aligned, non-aligned, spherical, triangular, cylindrical, cubic, spiral, randomly spaced, arbitrary, polygon having p ribs; p is greater than 1; and any combination thereof.

131. The booth according to claim 113, additionally comprising means adapted to relocate said base from a first position to a second position.

132. The booth according to claim 113, wherein said processing unit is adapted to control the on/off mode of at least one of said image sensors.

133. The booth according to claim 113, wherein said set of images of comprises at least 2 images of overlapping predetermined areas of said body.

134. The booth according to claim 113, wherein said predetermined arrangement is selected from the group consisting of: homogeneous, non-homogeneous, aligned, non-aligned, spherical, cylindrical, cubic, spiral, randomly spaced, arbitrary, and any combination thereof.

135. The booth according to claim 113, wherein said orientation is an angle between at least one of said image sensors and said body or said base, said angle is in the range of about 1° to about 179°.

136. The booth according to claim 113, wherein said dermatological data is selected from a group consisting of: suspected moles, the boundaries of suspected moles, tissue encircling said suspected moles nevus, tattoos, scars, moles, spots, wounds, and any combination thereof.

137. The booth according to claim 113, wherein said processing unit comprises an image processing algorithm adapted to detect the existence of said suspected moles and to characterize each mole according to predetermined characteristics.

138. The booth according to claim 137, wherein said image processing algorithm is further adapted to perform operation selected from the group consisting of: locate the borders of said suspected moles, distinguish between a suspected mole and a wound according to a pattern recognition algorithm, and any combination thereof.

139. The booth according to claim 137, wherein said processing unit is adapted to store said predetermined characteristics of each of said suspected moles.

140. The booth according to claim 137, wherein said predetermined characteristics are selected from the group consisting of: location, coordinates of border, asymmetry measurement, planar measurements, 2D structure, 3D structure, topography, height, radius, color, and any combination thereof.

141. The booth according to claim 137, wherein said processing unit is adapted to provide the history of each suspected mole and to provide comparison and changes between the current predetermined characteristics of said suspected moles and at least one previous predetermined characteristics of said suspected moles.

142. The booth according to claim 137, wherein said processing unit is adapted to detect said suspected moles by analyzing 2D and 3D images of said suspected moles.

143. The booth according to claim 113, wherein said base is part of a structure selected from the group consisting of: a booth, a kiosk, a cabin, a private enclosure, and any combination thereof.

144. The booth according to claim 113, wherein said processing unit is adapted to control the operation of said image sensors; said operation is selected from the orientation of at least one of said image sensors; the distance between at least one of said image sensors and said body, on/off mode of at least one of said image sensors.

145. The booth according to claim 113, wherein said processing unit is adapted to operate said image sensors in a synchronized manner, such that a synchronized image of the skin of said body is provided.

146. The booth according to claim 145, wherein said synchronized manner is operation of a portion of at least one of said image sensors.

147. The booth according to claim 146, wherein in said synchronized manner, said at least two of said image sensors are operated simultaneously.

148. The booth according to claim 113, further comprising a hair removal mechanism adapted to eliminate the influence of human hair on the data of said personal data.

149. The booth according to claim 113, wherein said processing unit further comprises a feedback mechanism, said feedback mechanism comprises: (i) an analyzing unit adapted to score said dermatological data according to a predetermined scale, so that abnormal dermatological data is detected; and (ii) a regulating unit adapted to operate said processing unit in a repeated manner when said score is higher than a predetermined value.

150. The booth according to claim 149, wherein said predetermined scale is adapted to rank parameters selected from the group consisting of: said predetermined characteristics, quality of said images; said quality is selected from a group consisting of color, contrast, blurred, out of focus, lightness, and any combination thereof.

151. The booth according to claim 149, wherein said feedback mechanism further adapted to control the orientation or the 3D position of at least one of said image sensors, the position of said patient, the distance between at least one of said image sensors and said patient.

152. The booth according to claim 113, further comprising a data storage unit adapted to store said personal data on a portable safe memory card.

153. The booth according to claim 113, wherein said personal data selected from the group consisting of: a dermatological data, scan results, set of images, a skin map, the full body photography, a 2D body model, a 3D body model, a 2D analysis, a 3D analysis, dates, patient personal information selected from a group consisting of name, height, weight, size, gender, id, password, family, family history, and any combination thereof or any combination thereof.

154. The booth according to claim 113, wherein said processing unit is adapted to analyze said set of images based upon previous analyzes.

155. The booth according to claim 113, wherein said processing unit further comprises an operation unit adapted to allow an operator to perform operation selected from the group consisting of: analyze said personal data; analyze said set of images; analyze said dermatological data; determine said dermatological data, edit said dermatological data, and any combination thereof.

156. The booth according to claim 145, wherein said operation unit is further adapted to perform operations selected from the group consisting of: provide zoom-in to a predetermined area of a skin map, operate said feedback mechanism, maipulate said personal data, provide a 2D plot of a predetermined area of a skin map according to at least one image of said set of images, provide a 3D plot of a predetermined area of a skin map, provide a 2D plot of a predetermined area of a skin map by performing a 2D projection on said 3D plot, mark a predetermined area of a skin map, and any combination thereof.

157. The booth according to claim 113, wherein said dermatological data is associated with the evolution and the severity of melanoma of a predetermined area on said body.

158. The booth according to claim 113, wherein said processing unit is further adapted to identify said patient according to parameters selected from the group consisting of: name, height, weight, size, gender, id, password, family, family history, and any combination thereof.

159. The booth according to claim 113, further comprising a rotatable pod stand adapted to rotate said body with respect to said image sensor.

160. The booth according to claim 113, further comprising a body positioning sub-unit adapted to: provide instructions regarding the position of a patient with respect to said image sensors; and to stabilize the position of said patient with respect to said image sensors.

161. The booth according to claim 113, wherein said image sensors are positioned in a homogeneous grid of sensors.

162. The booth according to claim 113, wherein said image sensors is selected from a group consisting of stills camera, video camera or any combination thereof.

163. The booth according to claim 113, additionally comprising a moving mechanism couple to at least one of said image sensors, adapted to move said image sensors from one potion to another within said base.

164. The booth according to claim 113, additionally comprising lightning means selected from a group consisting of LEDs, lamps, bulb filament or any combination thereof.

165. The booth according to claim 164, adapted to synchronies the operation of at least one of said image sensor and said lightning means.

166. The booth according to claim 113, wherein said dermatological data is used from detecting melanoma, for esthetics use, cosmetics use or any combination thereof.

167. The booth according to claim 113, wherein at least one of said image sensor comprises at least one marker.

168. The booth according to claim 113, wherein at least one of said image sensor is adapted to rotate around said image sensor's main axis.

169. A method for capturing at least one image of the skin of a patient's human body, comprising steps of:
a. providing a skin surface imaging system, comprising: (i) at least one base; a plurality of image sensors, connectable to said base, arranged in a predetermined arrangement; and, (iii) a processing unit communicatable with said image sensors;
b. capturing at least one image of a predetermined area of said body via said image sensors, thereby providing a set of images;
c. collecting said set of images from said image sensors via said processing unit;
d. analyzing said set of images via said processing unit;
e. constructing via said processing unit a record of a personal data associated with the skin geometry of said human body; and,
f. outputting a dermatological data associated with said skin of said human body;
wherein said method further comprises a step of providing said at least one of said image sensors with a joint connection to said base, thereby controlling the orientation of at least one of said image sensors with respect to said base.

170. The method for capturing at least one image of the skin according to claim 169, further comprising step of providing a sensor holding and controlling mechanism, wherein said at least one of said image sensors is jointly connectable to said base via said sensor holding and controlling mechanism.

171. The method for capturing at least one image of the skin according to claim 170, further comprising step of electrically operating said controlling mechanism by said processing unit.

172. The method for capturing at least one image of the skin according to claim 170, further comprising step of manually operating said controlling mechanism by an operator.

173. The method for capturing at least one image of the skin according to claim 170, further comprising a step of controlling the distance between at least one of said image sensors and said body via said holding and controlling mechanism.

174. The method for capturing at least one image of the skin according to claim 173, wherein said control of said distance is performed via said controlling mechanism according to the dimensions of said human body.

175. The method for capturing at least one image of the skin according to claim 169, further comprising a step of selecting said image sensors from the group consisting of: visible light sensors, ultraviolet (UV) light sensors, infrared (IR) sensors, and any combination thereof.

176. The method for capturing at least one image of the skin according to claim 169, wherein said predetermined arrangement characterized by n arrays locatable at angle of (360/n)° between each other with respect to said body or said base, each of said n arrays comprises m image sensors; n is an integer greater than or equals to 1; m is an integer greater than or equals to 1.

177. The method for capturing at least one image of the skin according to claim 176, wherein each of said n arrays comprises o parallel columns of said image sensors; o is an integer greater than or equals to 1.

178. The method for capturing at least one image of the skin according to claim 176, wherein n is 4 and o is 2.

179. The method for capturing at least one image of the skin according to claim 169, wherein said set of images of comprises images of overlapping predetermined areas of said human body.

180. The method for capturing at least one image of the skin according to claim 169, further comprising a step of providing said predetermined arrangement selected from the group consisting of: homogeneous, non-homogeneous, aligned, non-aligned, spherical, cylindrical, cubic, spiral, randomly spaced, arbitrary, and any combination thereof.

181. The method for capturing at least one image of the skin according to claim 169, wherein said orientation is an angle between at least one of said image sensors and said body or said base, said angle is in the range of about 1° to about 179°.

182. The method for capturing at least one image of the skin according to claim 169, further comprising a step of selecting said dermatological data from a group consisting of: suspected moles, nevus, tattoos, scars, moles, spots, wounds, and any combination thereof.

183. The method for capturing at least one image of the skin according to claim 169, wherein said dermatological data comprises predetermined characteristics of suspected moles; said processing unit comprises an image processing algorithm adapted to detect the existence of said suspected moles and to characterize each mole according to said predetermined characteristics.

184. The method for capturing at least one image of the skin according to claim 183, further comprising a step of performing via said image processing algorithm an operation selected from the group consisting of: locate the borders of said suspected moles, distinguish between a suspected mole and a wound according to a pattern recognition algorithm, and any combination thereof.

185. The method for capturing at least one image of the skin according to claim 183, further comprising a step of storing said predetermined characteristics of each of said suspected moles via said processing unit.

186. The method for capturing at least one image of the skin according to claim 183, further comprising a step of selecting said predetermined characteristics are selected from the group consisting of: location, coordinates of border, asymmetry measurement, planar measurements, 3D structure, topography, height, radius, color, and any combination thereof.

187. The method for capturing at least one image of the skin according to claim 183, further comprising steps of providing the history of each suspected mole via said processing unit; and providing comparison and changes between the current and the previous predetermined characteristics of said suspected moles via said processing unit.

188. The method for capturing at least one image of the skin according to claim 183, further comprising a step of detecting said suspected moles by analyzing 2D and 3D images of said suspected moles via said processing unit.

189. The method for capturing at least one image of the skin according to claim 169, further comprising step of providing said base as part of a structure selected from the group consisting of: a booth, a kiosk, a cabin, a private enclosure, and any combination thereof.

190. The method for capturing at least one image of the skin according to claim 169, further comprising a step of controlling the operation of said image sensors via said processing unit.

191. The method for capturing at least one image of the skin according to claim 169, further comprising a step of operating said image sensors via said processing unit in a synchronized manner, such that a synchronized image of the skin of said body is provided.

192. The method for capturing at least one image of the skin according to claim 191, wherein in said synchronized manner, said image sensors are operated simultaneously.

193. The method for capturing at least one image of the skin according to claim 169, further comprising a step of eliminating the influence of human hair on the data of said skin map via a hair removal mechanism.

194. The method for capturing at least one image of the skin according to claim 169, further comprising a step of performing feedback via a feedback mechanism locatable within said processing unit, said feedback mechanism comprises: (i) an analyzing unit adapted to score said dermatological data according to a predetermined scale, so that abnormal dermatological data is detected; and (ii) a regulating unit adapted to operate said processing unit in a repeated manner when said score is higher than a predetermined value.

195. The method for capturing at least one image of the skin according to claim 194, wherein said predetermined scale is adapted to rank parameters selected from the group consisting of: said predetermined characteristics, quality of said images, and any combination thereof.

196. The method for capturing at least one image of the skin according to claim 194, further comprising a step of controlling the orientation of at least one of said image sensors via said feedback mechanism.

197. The method for capturing at least one image of the skin according to claim 169, further comprising a step of storing said personal data on a safe memory card connectable to a data storage unit.

198. The method for capturing at least one image of the skin according to claim 169, further comprising a step of selecting said personal data from the group consisting of: a dermatological data, scan results, set of images, a skin map, the full body photography, a 2D body model, a 3D body model, a 2D analysis, a 3D analysis, dates, patient personal information selected from a group consisting of name, height, weight, size, gender, id, password, family, family history, and any combination thereof or any combination thereof.

199. The method for capturing at least one image of the skin according to claim 169, further comprising a step of allowing an operator to perform via an operating unit operations selected from the group consisting of: analyzing said personal data; analyzing said set of images; analyzing said dermatological data; determining said dermatological data, editing said dermatological data, and any combination thereof.

200. The method for capturing at least one image of the skin according to claim 194 or claim 199, further comprising a step of performing via said operating unit operations selected from the group consisting of: providing zoom-in to a predetermined area of a skin map, operating said feedback mechanism, manipulating said personal data, providing a 2D plot of a predetermined area of a skin map according to at least one image of said set of images, providing a 3D plot of a predetermined area of a skin map, providing a 2D plot of a predetermined area of a skin map by performing a 2D projection on said 3D plot, marking a predetermined area of a skin map, and any combination thereof.

201. The method for capturing at least one image of the skin according to claim 169, wherein said dermatological data is associated with the evolution and the severity of melanoma of a predetermined area on said human body.

202. The method for capturing at least one image of the skin according to claim 169, further comprising a step of identifying via said processing unit said patient according to parameters selected from the group consisting of: name, height, weight, size, gender, id, password, and any combination thereof.

203. The method for capturing at least one image of the skin according to claim 169, further comprising a step of further rotating said human body with respect to said image sensor on a rotatable pod stand.

204. The method for capturing at least one image of the skin according to claim 169, further comprising steps of: providing a body positioning sub-unit; providing instructions regarding the position of a patient with respect to said image sensors; and stabilizing the position of said patient with respect to said image sensors.

205. The method for capturing at least one image of the skin according to claim 169, further comprising a step of providing said image sensors in a homogeneous grid of sensors.

206. A method for capturing at least one image of the skin of a patient's human body, comprising steps of:
a. providing a skin surface imaging system, comprising: (i) at least one base; a plurality of image sensors, connectable to said base, arranged in a predetermined arrangement; and, (iii) a processing unit communicatable with said image sensors;
b. capturing at least one image of a predetermined area of said human body via said image sensors, thereby providing a set of images;
c. collecting said set of images from said image sensors via said processing unit;
d. analyzing said set of images via said processing unit;
e. constructing via said processing unit a record of a personal data associated with the skin geometry of said human body; and,
f. outputting a dermatological data associated with said skin of said human body;
wherein said method further comprises a step of providing said at least one of said image sensors connected to said base, thereby controlling the distance between at least one of said image sensors and said base or said human body.

207. The method for capturing at least one image of the skin according to claim 206, further comprising step of providing a sensor holding and controlling mechanism, wherein said at least one of said image sensors is jointly connectable to said base via said sensor holding and controlling mechanism.

208. The method for capturing at least one image of the skin according to claim 207, further comprising step of electrically operating said controlling mechanism by said processing unit.

209. The method for capturing at least one image of the skin according to claim 207, further comprising step of manually operating said controlling mechanism by an operator.

210. The method for capturing at least one image of the skin according to claim 207, further comprising a step of controlling the orientation between at least one of said image sensors and said human body via said holding and controlling mechanism.

211. The method for capturing at least one image of the skin according to claim 210, wherein said control of said distance is performed according to the dimensions of said human body.

212. The method for capturing at least one image of the skin according to claim 206, further comprising a step of selecting said image sensors from the group consisting of: visible light sensors, ultraviolet (UV) light sensors, infrared (IR) sensors, and any combination thereof.

213. The method for capturing at least one image of the skin according to claim 206, wherein said predetermined arrangement characterized by n arrays locatable at angle of (360/n)° between each other with respect to said human body or said base, each of said n arrays comprises m image sensors; n is an integer greater than or equals to 1; m is an integer greater than or equals to 1.

214. The method for capturing at least one image of the skin according to claim 213, wherein each of said n arrays comprises o parallel columns of said image sensors; o is an integer greater than or equals to 1.

215. The method for capturing at least one image of the skin according to claim 213, wherein n is 4 and o is 2.

216. The method for capturing at least one image of the skin according to claim 206, wherein said set of images of comprises images of overlapping predetermined areas of said human body.

217. The method for capturing at least one image of the skin according to claim 206, further comprising a step of providing said predetermined arrangement selected from the group consisting of: homogeneous, non-homogeneous, aligned, non-aligned, spherical, cylindrical, cubic, spiral, randomly spaced, arbitrary, and any combination thereof.

218. The method for capturing at least one image of the skin according to claim 206, wherein said orientation is an angle between at least one of said image sensors and said human body or said base, said angle is in the range of about 1° to about 179°.

219. The method for capturing at least one image of the skin according to claim 206, further comprising a step of selecting said dermatological data from a group consisting of: suspected moles, nevus, tattoos, scars, moles, spots, wounds, and any combination thereof.

220. The method for capturing at least one image of the skin according to claim 206, wherein said dermatological data comprises predetermined characteristics of suspected moles; said processing unit comprises an image processing algorithm adapted to detect the existence of said suspected moles and to characterize each mole according to said predetermined characteristics.

221. The method for capturing at least one image of the skin according to claim 220, further comprising a step of performing via said image processing algorithm an operation selected from the group consisting of: locate the borders of said suspected moles, distinguish between a suspected mole and a wound according to a pattern recognition algorithm, and any combination thereof.

222. The method for capturing at least one image of the skin according to claim 220, further comprising a step of storing said predetermined characteristics of each of said suspected moles via said processing unit.

223. The method for capturing at least one image of the skin according to claim 220, further comprising a step of selecting said predetermined characteristics are selected from the group consisting of: location, coordinates of border, asymmetry measurement, planar measurements, 3D structure, topography, height, radius, color, and any combination thereof.

224. The method for capturing at least one image of the skin according to claim 220, further comprising steps of providing the history of each suspected mole via said processing unit; and providing comparison and changes between the current and the previous predetermined characteristics of said suspected moles via said processing unit.

225. The method for capturing at least one image of the skin according to claim 220, further comprising a step of detecting said suspected moles by analyzing 2D and 3D images of said suspected moles via said processing unit.

226. The method for capturing at least one image of the skin according to claim 206, further comprising step of providing said base as part of a structure selected from the group consisting of: a booth, a kiosk, a cabin, a private enclosure, and any combination thereof.

227. The method for capturing at least one image of the skin according to claim 206, further comprising a step of controlling the operation of said image sensors via said processing unit.

228. The method for capturing at least one image of the skin according to claim 188, further comprising a step of operating said image sensors via said processing unit in a synchronized manner, such that a synchronized image of the skin of said human body is provided.

229. The method for capturing at least one image of the skin according to claim 228, wherein in said synchronized manner, said image sensors are operated simultaneously.

230. The method for capturing at least one image of the skin according to claim 206, further comprising a step of eliminating the influence of human hair on the data of said skin map via a hair removal mechanism.

231. The method for capturing at least one image of the skin according to claim 206, further comprising a step of performing feedback via a feedback mechanism locatable within said processing unit, said feedback mechanism comprises: (i) an analyzing unit adapted to score said dermatological data according to a predetermined scale, so that abnormal dermatological data is detected; and (ii) a regulating unit adapted to operate said processing unit in a repeated manner when said score is higher than a predetermined value.

232. The method for capturing at least one image of the skin according to claim 220 or claim 228, wherein said predetermined scale is adapted to rank parameters selected from the group consisting of: said predetermined characteristics, quality of said images, and any combination thereof.

233. The method for capturing at least one image of the skin according to claim 231, further comprising a step of controlling the orientation of at least one of said image sensors via said feedback mechanism.

234. The method for capturing at least one image of the skin according to claim 206, further comprising a step of storing said personal data on a safe memory card connectable to a data storage unit.

235. The method for capturing at least one image of the skin according to claim 206, further comprising a step of selecting said personal data from the group consisting of: a dermatological data, scan results, set of images, a skin map, the full body photography, a 2D body model, a 3D body model, a 2D analysis, a 3D analysis, dates, patient personal information selected from a group consisting of name, height, weight, size, gender, id, password, family, family history, and any combination thereof, or any combination thereof.

236. The method for capturing at least one image of the skin according to claim 206, further comprising a step of allowing an operator to perform via an operating unit operations selected from the group consisting of: analyzing said personal data; analyzing said set of images; analyzing said dermatological data; determining said dermatological data, editing said dermatological data, and any combination thereof.

237. The method for capturing at least one image of the skin according to claim 236, further comprising a step of performing via said operating unit operations selected from the group consisting of: providing zoom-in to a predetermined area of a skin map, operating said feedback mechanism, manipulating said personal data, providing a 2D plot of a predetermined area of a skin map according to at least one image of said set of images, providing a 3D plot of a predetermined area of a skin map, providing a 2D plot of a predetermined area of a skin map by performing a 2D projection on said 3D plot, marking a predetermined area of a skin map, and any combination thereof.

238. The method for capturing at least one image of the skin according to claim 206, wherein said dermatological data is associated with the evolution and the severity of melanoma of a predetermined area on said human body.

239. The method for capturing at least one image of the skin according to claim 206, further comprising a step of identifying via said processing unit said patient according to parameters selected from the group consisting of: name, height, weight, size, gender, id, password, and any combination thereof.

240. The method for capturing at least one image of the skin according to claim 188, further comprising a step of further rotating said human body with respect to said image sensor on a rotatable pod stand.

241. The method for capturing at least one image of the skin according to claim 206, further comprising steps of: providing a body positioning sub-unit; providing instructions regarding the position of a patient with respect to said image sensors; and stabilizing the position of said patient with respect to said image sensors.

242. The method for capturing at least one image of the skin according to claim 206, further comprising a step of providing said image sensors in a homogeneous grid of sensors.

243. A method for capturing at least one image of the skin of a patient's human body, comprising steps of:
a. providing a booth, comprising: (i) a pod stand upon which said patient is adapted to stand; an envelope adapted to surround said patient; a plurality of image sensors, arranged in a predetermined arrangement between said envelope and said patient; and, (iii) a processing unit communicatable with said image sensors;
b. capturing at least one image of a predetermined area of said human body via said image sensors, thereby providing a set of images;
c. collecting said set of images from said image sensors via said processing unit;
d. analyzing said set of images via said processing unit;
e. constructing via said processing unit a record of a personal data associated with the skin geometry of said human body; and,
f. outputting a dermatological data associated with said skin of said human body;
wherein said method further comprises a step of providing said at least one of said image sensors with a joint connection to said envelope, thereby controlling the orientation of at least one of said image sensors with respect to said envelope.

244. The method for capturing at least one image of the skin according to claim 243, further comprising step of providing a sensor holding and controlling mechanism, wherein said at least one of said image sensors is jointly connectable to said envelope via said sensor holding and controlling mechanism.

245. The method for capturing at least one image of the skin according to claim 244, further comprising step of electrically operating said controlling mechanism by said processing unit.

246. The method for capturing at least one image of the skin according to claim 244, further comprising step of manually operating said controlling mechanism by an operator.

247. The method for capturing at least one image of the skin according to claim 244, further comprising a step of controlling the orientation between at least one of said image sensors and said human body via said holding and controlling mechanism.

248. The method for capturing at least one image of the skin according to claim 247, wherein said control of said distance is performed according to the dimensions of said human body.

249. The method for capturing at least one image of the skin according to claim 243, further comprising a step of selecting said image sensors from the group consisting of: visible light sensors, ultraviolet (UV) light sensors, infrared (IR) sensors, and any combination thereof.

250. The method for capturing at least one image of the skin according to claim 243, wherein said predetermined arrangement characterized by n arrays locatable at angle of (360/n)° between each other with respect to said human body or said envelope, each of said n arrays comprises m image sensors; n is an integer greater than or equals to 1; m is an integer greater than or equals to 1.

251. The method for capturing at least one image of the skin according to claim 250, wherein each of said n arrays comprises o parallel columns of said image sensors; o is an integer greater than or equals to 1.

252. The method for capturing at least one image of the skin according to claim 250, wherein n is 4 and o is 2.

253. The method for capturing at least one image of the skin according to claim 243, wherein said set of images of comprises images of overlapping predetermined areas of said human body.

254. The method for capturing at least one image of the skin according to claim 243, further comprising a step of providing said predetermined arrangement selected from the group consisting of: homogeneous, non-homogeneous, aligned, non-aligned, spherical, cylindrical, cubic, spiral, randomly spaced, arbitrary, and any combination thereof.

255. The method for capturing at least one image of the skin according to claim 243, wherein said orientation is an angle between at least one of said image sensors and said human body or said envelope, said angle is in the range of about 1° to about 179°.

256. The method for capturing at least one image of the skin according to claim 243, further comprising a step of selecting said dermatological data from a group consisting of: suspected moles, nevus, tattoos, scars, moles, spots, wounds, and any combination thereof.

257. The method for capturing at least one image of the skin according to claim 243, wherein said dermatological data comprises predetermined characteristics of suspected moles; said processing unit comprises an image processing algorithm adapted to detect the existence of said suspected moles and to characterize each mole according to said predetermined characteristics.

258. The method for capturing at least one image of the skin according to claim 257, further comprising a step of performing via said image processing algorithm an operation selected from the group consisting of: locate the borders of said suspected moles, distinguish between a suspected mole and a wound according to a pattern recognition algorithm, and any combination thereof.

259. The method for capturing at least one image of the skin according to claim 257, further comprising a step of storing said predetermined characteristics of each of said suspected moles via said processing unit.

260. The method for capturing at least one image of the skin according to claim 257, further comprising a step of selecting said predetermined characteristics are selected from the group consisting of: location, coordinates of border, asymmetry measurement, planar measurements, 3D structure, topography, height, radius, color, and any combination thereof.

261. The method for capturing at least one image of the skin according to claim 257, further comprising steps of providing the history of each suspected mole via said processing unit; and providing comparison and changes between the current and the previous predetermined characteristics of said suspected moles via said processing unit.

262. The method for capturing at least one image of the skin according to claim 257, further comprising a step of detecting said suspected moles by analyzing 2D and 3D images of said suspected moles via said processing unit.

263. The method for capturing at least one image of the skin according to claim 243, further comprising step of providing said envelope as part of a structure selected from the group consisting of: a booth, a kiosk, a cabin, a private enclosure, and any combination thereof.

264. The method for capturing at least one image of the skin according to claim 243, further comprising a step of controlling the operation of said image sensors via said processing unit.

265. The method for capturing at least one image of the skin according to claim 243, further comprising a step of operating said image sensors via said processing unit in a synchronized manner, such that a synchronized image of the skin of said human body is provided.

266. The method for capturing at least one image of the skin according to claim 265, wherein in said synchronized manner, said image sensors are operated simultaneously.

267. The method for capturing at least one image of the skin according to claim 243, further comprising a step of eliminating the influence of human hair on the data of said skin map via a hair removal mechanism.

268. The method for capturing at least one image of the skin according to claim 243, further comprising a step of performing feedback via a feedback mechanism locatable within said processing unit, said feedback mechanism comprises: (i) an analyzing unit adapted to score said dermatological data according to a predetermined scale, so that abnormal dermatological data is detected; and (ii) a regulating unit adapted to operate said processing unit in a repeated manner when said score is higher than a predetermined value.

269. The method for capturing at least one image of the skin according to claim 268, wherein said predetermined scale is adapted to rank parameters selected from the group consisting of: said predetermined characteristics, quality of said images, and any combination thereof.

270. The method for capturing at least one image of the skin according to claim 243, further comprising a step of controlling the orientation of at least one of said image sensors via said feedback mechanism.

271. The method for capturing at least one image of the skin according to claim 243, further comprising a step of storing said personal data on a safe memory card connectable to a data storage unit.

272. The method for capturing at least one image of the skin according to claim 243, further comprising a step of selecting said personal data from the group consisting of: a dermatological data, scan results, set of images, a skin map, the full body photography, a 2D body model, a 3D body model, a 2D analysis, a 3D analysis, dates, patient personal information selected from a group consisting of name, height, weight, size, gender, id, password, family, family history, and any combination thereof or any combination thereof.

273. The method for capturing at least one image of the skin according to claim 243, further comprising a step of allowing an operator to perform via an operating unit operations selected from the group consisting of: analyzing said personal data; analyzing said set of images; analyzing said dermatological data; determining said dermatological data, editing said dermatological data, and any combination thereof.

274. The method for capturing at least one image of the skin according to claim 273, further comprising a step of performing via said operating unit operations selected from the group consisting of: providing zoom-in to a predetermined area of a skin map, operating said feedback mechanism, manipulating said personal data, providing a 2D plot of a predetermined area of a skin map according to at least one image of said set of images, providing a 3D plot of a predetermined area of a skin map, providing a 2D plot of a predetermined area of a skin map by performing a 2D projection on said 3D plot, marking a predetermined area of a skin map, and any combination thereof.

275. The method for capturing at least one image of the skin according to claim 243, wherein said dermatological data is associated with the evolution and the severity of melanoma of a predetermined area on said human body.

276. The method for capturing at least one image of the skin according to claim 243, further comprising a step of identifying via said processing unit said patient according to parameters selected from the group consisting of: name, height, weight, size, gender, id, password, and any combination thereof.

277. The method for capturing at least one image of the skin according to claim 243, further comprising a step of further rotating said human body with respect to said image sensor on a rotatable pod stand.

278. The method for capturing at least one image of the skin according to claim 243, further comprising steps of: providing a body positioning sub-unit; providing instructions regarding the position of a patient with respect to said image sensors; and stabilizing the position of said patient with respect to said image sensors.

279. The method for capturing at least one image of the skin according to claim 243, further comprising a step of providing said image sensors in a homogeneous grid of sensors.

280. An imaging system for capturing at least one image of the skin of a patient's body, comprising:
a. at least one base;
b. a plurality of first image sensors, connectable to said base, arranged in a predetermined arrangement; each of said image sensors adapted to capture at least one image of a predetermined area of said body, so that as a set of images is provided; and,
c. a processing unit communicatable with said image sensors, said processing unit comprising a program of machine-readable instructions embodied on a computer readable memory and executable by a digital data processor adapted to: (i) collect said set of images from said image sensors; (ii) analyze said set of images; (iii) construct a record of personal data associated with the skin of said body of said patient; and (iv) output a dermatological data associated with said skin of said body;
d. at least q second image sensors; at least one of said q second image sensors adapted to capture at least one image of a predetermined area of said body; each of said q image sensors is connected to said base by means of (i) k consecutive arm sections; (ii) at least k−1 joints coupling each two of said k consecutive arm sections together; such that the position of said at least q second image sensors is alterable; q is greater than or equals to 1; k is greater than or equals to 1.

281. The imaging system according to claim 280, additionally comprising a second processing unit communicatable with at least one of said q second image sensors; said second processing unit comprising a program of machine-readable instructions embodied on a computer readable memory and executable by a digital data processor adapted to: (i) collect said at least one image from said second image sensors; (ii) analyze said at least one image; (iii) output a data associated with said skin of said body or said image.

282. The imaging system according to claim 280 or 281, adapted for performing both Total Body Photography and Total Body Dermoscopy

283. The imaging system according to claim 280, wherein said position of said q second image sensors is alterable in at least one orientation selected from a group consisting of the sagittal plane, the coronal plane or the transverse plane, upwards, downwards, left, right, the distance between at least one of said second image sensors and said body, or any combination thereof.

284. The imaging system according to claim 280, wherein at least one of first or second image sensors is jointly connectable to said base by means of at least one joint, such that the orientation of said at least one of said first or second image sensors with respect to said base is controllable and reconfigurable

285. The imaging system according to claim 280, wherein said at least one of said first or second image sensors is jointly connectable to said base via a restricting sensor and controlling mechanism, such that said at least one image sensor is movable in at least one selected from a group consisting of the sagittal plane, the coronal plane or the transverse plane, upwards, downwards, left, right or any combination thereof.

286. The imaging system according to claim 285, wherein said restricting sensor is adapted to regulate the movement of said at least one first or second image sensor.

287. The imaging system according to claim 285, wherein said controlling mechanism is either electronically operatable by said processing unit or manually operatable by an operator.

288. The imaging system according to claim 285, wherein said controlling mechanism is adapted to control the distance between at least one of said first or second image sensors and said body.

289. The imaging system according to claim 285, wherein said controlling mechanism is adapted to control the distance in said orientation between at least one of said first or second image sensors and said body.

290. The imaging system according to claim 285, wherein said controlling mechanism is adapted to control the location of at least one of said first or second image sensors in said base.

291. The imaging system according to claim 280, wherein said base is characterized by a main longitudinal axis; further wherein said controlling mechanism is adapted to control the location of at least one of said first or second image sensors along said main longitudinal axis in said base.

292. The imaging system according to claim 288, wherein said control of said distance is performed according to the dimensions of said body.

293. The imaging system according to claim 288, additionally comprising a sensor adapted to provide information as for the dimensions of said body, such that said control of said distance is performed according to the dimensions of said body.

294. The imaging system according to claim 280, wherein said first or second image sensors are selected from the group consisting of: visible light sensors, ultraviolet (UV) light sensors, infrared (IR) sensors, and any combination thereof.

295. The imaging system according to claim 280, wherein said predetermined arrangement characterized by n arrays locatable at angle of (360/n)° between each other with respect to said body or said base, each of said n arrays comprises m first image sensors; n is an integer greater than or equals to 1; m is an integer greater than or equals to 1.

296. The imaging system according to claim 295, wherein each of said n arrays comprises o parallel columns of said first image sensors; o is an integer greater than or equals to 1.

297. The imaging system according to claim 295, wherein n is at least 4 and o is at least 2.

298. The imaging system according to claim 280, wherein said predetermined arrangement characterized by n arrays, each of said n arrays comprises m first image sensors; n is an integer greater than or equals to 1; m is an integer greater than or equals to 1.

299. The imaging system according to claim 295, wherein each of said n arrays comprises o parallel columns of said first image sensors; o is an integer greater than or equals to 1.

300. The imaging system according to claim 295, wherein each of said n arrays comprises o first image sensors; wherein said o first image sensors are positioned within each of said n arrays in a predetermined manner; o is an integer greater than or equals to 1.

301. The imaging system according to claim 300, wherein said predetermined manner is selected from a group consisting of homogeneous, non-homogeneous, aligned, non-aligned, spherical, triangular, cylindrical, cubic, spiral, randomly spaced, arbitrary, polygon having p ribs; p is greater than 1; and any combination thereof.

302. The imaging system according to claim 280, additionally comprising means adapted to relocate said base from a first position to a second position.

303. The imaging system according to claim 280, wherein said processing unit or said second processing unit is adapted to control the on/off mode of at least one of said first or second image sensors.

304. The imaging system according to claim 280, wherein said set of images of comprises at least 2 images of overlapping predetermined areas of said body.

305. The imaging system according to claim 280, wherein said predetermined arrangement is selected from the group consisting of: homogeneous, non-homogeneous, aligned, non-aligned, spherical, cylindrical, cubic, spiral, randomly spaced, arbitrary, and any combination thereof.

306. The imaging system according to claim 280, wherein said orientation is an angle between at least one of said first image sensors and said body or said base, said angle is in the range of about 1° to about 179°.

307. The imaging system according to claim 280, wherein said dermatological data is selected from a group consisting of: suspected moles, the boundaries of suspected moles, tissue encircling said suspected moles nevus, tattoos, scars, moles, spots, wounds, and any combination thereof.

308. The imaging system according to claim 280, wherein said processing unit or said second processing unit comprises an image processing algorithm adapted to detect the existence of said suspected moles and to characterize each mole according to predetermined characteristics.

309. The imaging system according to claim 308, wherein said image processing algorithm is further adapted to perform operation selected from the group consisting of: locate the borders of said suspected moles, distinguish between a suspected mole and a wound according to a pattern recognition algorithm, and any combination thereof.

310. The imaging system according to claim 280, wherein said processing unit or said second processing unit is adapted to store said predetermined characteristics of each of said suspected moles.

311. The imaging system according to claim 310, wherein said predetermined characteristics are selected from the group consisting of: location, coordinates of border, asymmetry measurement, planar measurements, 2D structure, 3D structure, topography, height, radius, color, and any combination thereof.

312. The imaging system according to claim 310, wherein said processing unit or second processing unit is adapted to provide the history of each suspected mole and to provide comparison and changes between the current predetermined characteristics of said suspected moles and at least one previous predetermined characteristics of said suspected moles.

313. The imaging system according to claim 310, wherein said processing unit or said second processing unit is adapted to detect said suspected moles by analyzing 2D and 3D images of said suspected moles.

314. The imaging system according to claim 280, wherein said base is part of a structure selected from the group consisting of: a booth, a kiosk, a cabin, a private enclosure, and any combination thereof.

315. The imaging system according to claim 280, wherein said processing unit or said second processing unit is adapted to control the operation of said first or second image sensors; said operation is selected from the orientation of at least one of said first or second image sensors; the distance between at least one of said first or second image sensors and said body, on/off mode of at least one of said first or second image sensors.

316. The imaging system according to claim 280, wherein said processing unit or said second processing unit is adapted to operate said first or second image sensors in a synchronized manner, such that a synchronized image of the skin of said body is provided.

317. The imaging system according to claim 316, wherein said synchronized manner is operation of a portion of at least one of said image sensors.

318. The imaging system according to claim 316, wherein in said synchronized manner, said at least two of said first or second image sensors are operated simultaneously.

319. The imaging system according to claim 280, further comprising a hair removal mechanism adapted to eliminate the influence of human hair on the data of said personal data.

320. The imaging system according to claim 280, wherein said processing unit or said second processing unit further comprises a feedback mechanism, said feedback mechanism comprises: (i) an analyzing unit adapted to score said dermatological data according to a predetermined scale, so that abnormal dermatological data is detected; and (ii) a regulating unit adapted to operate said processing unit or said second processing unit in a repeated manner when said score is higher than a predetermined value.

321. The imaging system according to claim 320, wherein said predetermined scale is adapted to rank parameters selected from the group consisting of: said predetermined characteristics, quality of said images; said quality is selected from a group consisting of color, contrast, blurred, out of focus, lightness, and any combination thereof.

322. The imaging system according to claim 320, wherein said feedback mechanism further adapted to control the orientation or 3D the position of at least one of said first or second image sensors, the position of said patient, the distance between at least one of said first or second image sensors and said patient.

323. The imaging system according to claim 280, further comprising a data storage unit adapted to store said personal data on a portable safe memory card.

324. The imaging system according to claim 280, wherein said personal data selected from the group consisting of: a dermatological data, scan results, set of images, a skin map, the full body photography, a 2D body model, a 3D body model, a 2D analysis, a 3D analysis, dates, patient personal information selected from a group consisting of name, height, weight, size, gender, id, password, family, family history, and any combination thereof or any combination thereof.

325. The imaging system according to claim 280, wherein said processing unit or said second processing unit is adapted to analyze said set of images based upon previous analyzes.

326. The imaging system according to claim 280, wherein said processing unit or said second processing unit further comprises an operation unit adapted to allow an operator to perform operation selected from the group consisting of: analyze said personal data; analyze said set of images; analyze said dermatological data; determine said dermatological data, edit said dermatological data, and any combination thereof.

327. The imaging system according to claim 280, wherein said operation unit is further adapted to perform operations selected from the group consisting of: provide zoom-in to a predetermined area of a skin map, operate said feedback mechanism, maipulate said personal data, provide a 2D plot of a predetermined area of a skin map according to at least one image of said set of images, provide a 3D plot of a predetermined area of a skin map, provide a 2D plot of a predetermined area of a skin map by performing a 2D projection on said 3D plot, mark a predetermined area of a skin map, and any combination thereof.

328. The imaging system according to claim 280, wherein said dermatological data is associated with the evolution and the severity of melanoma of a predetermined area on said body.

329. The imaging system according to claim 280, wherein said processing unit or said second processing unit is further adapted to identify a patient according to parameters selected from the group consisting of: name, height, weight, size, gender, id, password, family, family history, and any combination thereof.

330. The imaging system according to claim 280, further comprising a rotatable pod stand adapted to rotate said body with respect to said first or second image sensor.

331. The imaging system according to claim 280, further comprising a body positioning sub-unit adapted to: provide instructions regarding the position of a patient with respect to said first or second image sensors; and to stabilize the position of said patient with respect to said first or second image sensors.

332. The imaging system according to claim 280, wherein said first image sensors are positioned in a homogeneous grid of sensors.

333. The imaging system according to claim 280, additionally comprising a moving mechanism couple to at least one of said image sensors, adapted to move said image sensors from one potion to another within said base.

334. The imaging system according to claim 333, additionally comprising lightning means selected from a group consisting of LEDs, lamps, bulb filament or any combination thereof.

335. The imaging system according to claim 280, adapted to synchronies the operation of at least one of said image sensor and said lightning means.

336. The imaging system according to claim 280, wherein said dermatological data is used from detecting melanoma, for esthetics use, cosmetics use or any combination thereof.

337. The imaging system according to claim 280, wherein at least one of said image sensor comprises at least one marker.

338. The imaging system according to claim 280, wherein at least one of said image sensor is adapted to rotate around said image sensor's main axis.
